(19) United States
(12) Patent Application Publication
(10) Pub. No.: US 2012/0119992 A1
(43) Pub. Date: May 17, 2012

(54) INPUT SYSTEM, INFORMATION PROCESSING APPARATUS, INFORMATION PROCESSING PROGRAM, AND SPECIFIED POSITION CALCULATION METHOD

(75) Inventors: Kenichi NISHIDA, Kyoto-shi (JP); Yoshikazu Yamashita, Kyoto-shi (JP); Takayuki Shimamura, Kyoto-shi (JP)

(73) Assignee: NINTENDO CO., LTD., Kyoto (JP)

(21) Appl. No.: 13/268,176

(22) Filed: Oct. 7, 2011

(30) Foreign Application Priority Data
Nov. 17, 2010 (JP) 2010-256909

(51) Int. Cl. G06F 3/033

(52) U.S. Cl. 345/158

(57) ABSTRACT

An example input system calculates a specified position on a screen of a display device, the position being specified by an operating device. The input system includes an attitude calculation section, an identification section, and a specified position calculation section. The attitude calculation section calculates an attitude of the operating device. The identification section identifies one of a plurality of display devices toward which the operating device is directed, based on the attitude of the operating device. The specified position calculation section calculates a specified position in accordance with the attitude of the operating device as a position on a screen of the display device identified by the identification section.

### CROSS REFERENCE TO RELATED APPLICATION

The disclosure of Japanese Patent Application No. 2010-256909, filed Nov. 17, 2010, is incorporated herein by reference.

### FIELD

This application describes an input system allowing a position on a screen of a display device to be specified by an operating device, and also describes an information processing apparatus, an information processing program, and a specified position calculation method which are used in the input system.

### BACKGROUND AND SUMMARY

Conventionally, there are input systems allowing users to specify a position on a screen of a display device by pointing an operating device at the screen. For example, there is a technology of calculating the attitude of an operating device from a sensing result provided by a gyroscope or suchlike and further calculating a position on a screen based on the calculated attitude. This allows the user to specify any position on the screen by changing the attitude of the operating device.

Such a conventional input system as to allow a position on a screen to be specified by an operating device includes only one display device, and therefore, the user manipulates the operating device while simply holding it within a predetermined range of directions so as to be directed toward the display device. That is, in such a conventional input system, the operating device itself can be used and directed in any desired direction, but when performing an operation to specify a position on the screen, the operating device is used and directed only within a limited range of directions.

(1) An example input system described in the present specification calculates a specified position on a screen of a display device, the position being specified by an operating device. The input system includes an attitude calculation section, an identification section, and a first specified position calculation section. The attitude calculation section calculates an attitude of the operating device. The identification section identifies one of a plurality of display devices toward which the operating device is directed, based on the attitude of the operating device. The first specified position calculation section calculates a specified position in accordance with the attitude of the operating device as a position on a screen of the display device identified by the identification section.

The “display device” is a concept encompassing any display device capable of displaying an image, in addition to a terminal device and a television in an example embodiment to be described later.

The “operating device” may be any device whose attitude can be adjusted by the user. The operating device may include a sensor for calculating the attitude as in a controller 5 to be described later, or may not include such a sensor. Note that in the case where the operating device does not include the sensor, for example, the input system may pick up an image of the operating device and may calculate the attitude of the operating device based on the picked up image.

The “specified position” is intended to mean a position on the screen of the display device, which is specified by a predetermined axis of the operating device. However, while the specified position is calculated so as to change in accordance with the attitude of the operating device, it does not always strictly represent a position where the predetermined axis and the screen cross.

The “input system” is a concept encompassing any information processing system using a specified position as an input, in addition to a game system as described in the example embodiment to be described later.

The “attitude calculation section” may employ any calculation method so long as the attitude of the operating device can be calculated.

The “identification section” identifies a display device as “the display device toward which the operating device is directed” when the predetermined axis of the operating device is directed toward the position of the display device or any position within a predetermined range around the display device. Note that the “identification section” identifies one of a plurality of display devices toward which the operating device is directed, but no display device might be identified depending on the attitude of the operating device.

The “first specified position calculation section” may employ any calculation method so long as the specified position can be calculated in accordance with the attitude of the operating device.

According to the above configuration (1), one of the display devices toward which the operating device is directed can be identified based on the attitude of the operating device. In addition, a specified position in accordance with the attitude of the operating device is calculated as a position on the screen of the identified display device. As a result, it is possible to determine which display device the operating device is directed toward, and calculate a specified position as a position on the screen of the display device toward which the operating device is directed. Thus, the present example embodiment makes it possible to perform pointing operations on a plurality of display devices using the operating device, and allow the operating device to be used and oriented in a wider range of directions.

(2) The operating device may include an inertial sensor. In this case, the attitude calculation section calculates the attitude of the operating device based on an output from the inertial sensor.

The “inertial sensor” may be any sensor allowing an attitude to be calculated based on an output from that sensor, and examples of the sensor include a gyroscope and an acceleration sensor.

According to the above configuration (2), by using an output from the inertial sensor, the attitude of the operating device can be calculated with accuracy. In addition, by using an output from the inertial sensor, the attitude of the operating device can be calculated in a broad area (which is not limited to, for example, an area within which the operating device can pick up an image of the marker section).

(3) The input system may further comprise a reference attitude storage section for storing a reference attitude for each display device, the reference attitude representing an attitude of the operating device being directed toward the display device. In this case, the identification section identifies the display device toward which the operating device is directed, based on the attitude calculated by the attitude calculation section and the reference attitudes.

The “reference attitude storage section” may be any storage means (e.g., memory) accessible by the input system.

The wording “(the identification section) identifies the display device based on the attitude calculated by the attitude calculation section and the reference attitudes” is intended to encompass, for example, identifying a display device corresponding to one of the reference attitudes that is closest to the attitude calculated by the attitude calculation section, and identifying a display device corresponding to one of the reference attitudes that is different from the attitude calculated by the attitude calculation section only to a predetermined extent.

According to the above configuration (3), by using the current attitude calculated by the attitude calculation section and the reference attitudes, it is possible to readily and precisely determine which display device the operating device is directed toward.

(4) The input system may further comprise a reference setting section for, when the operating device is in a predetermined state, setting the attitude of the operating device in the reference attitude storage section as a reference attitude.

The “predetermined state” is intended to mean, for example, a state where the user has performed a predetermined operation (specified in (5) below), a state where an image pickup section of the operating device has picked up an image of the marker section corresponding to the display device (specified in (7) below), or a state where the specified position lies within a predetermined area on the screen of the display device (specified in (8) below).

According to the above configuration (4), the user brings the operating device into a predetermined state, thereby setting the attitude of the operating device in the predetermined state as a reference attitude. Thus, even when the positional relationship between the display devices changes, the reference attitude can be set appropriately, which makes it possible to precisely determine which display device the operating device is directed toward.

(5) The operating device may include an image pickup section. In this case, the input system further comprises marker sections each being provided for a corresponding one of the display devices. When the image pickup section has picked up an image of one of the marker sections, the reference setting section sets the attitude of the operating device as a reference attitude for the display device corresponding to that marker section.

According the above configuration (5), the attitude of the operating device is set as a reference attitude, provided that the image pickup section of the operating device has picked up an image of a marker section. Accordingly, by arranging the marker section at an appropriate position (e.g., by arranging the marker section around the display device), it can be precisely determined whether the operating device is directed toward the display device (the marker section) or not, making it possible to set the reference attitude with precision.

(6) The input system may further comprise a second specified position calculation section and a predetermined image display control section. The second specified position calculation section calculates the specified position based on a position of the marker section in the image picked up by the image pickup section. The predetermined image display control section displays a predetermined image at the specified position calculated by the second specified position calculation section. The reference setting section sets as the reference attitude the attitude of the operating device calculated by the attitude calculation section when the predetermined image is displayed.

According to the above configuration (6), the reference attitude can be set when a predetermined image is displayed at the specified position calculated by the second specified position calculation section. Accordingly, when the reference attitude is set, the user can confirm the attitude of the operating device by viewing the predetermined image, thereby determining whether the operating device is directed toward the display device or not. Thus, the user can readily perform the operation of setting the reference attitude.

(7) The operating device may include an operating section operable by a user. In this case, the reference setting section sets as the reference attitude the attitude of the operating device when a predetermined operation is performed on the operating section.

The “operating section” may be a set of buttons or sticks or may be a touch panel, a touch pad, or the like.

According to the above configuration (7), when the user performs a predetermined operation, the attitude of the operating device is set as a reference attitude. Accordingly, the attitude for which the user actually feels the operating device is directed toward the display device is set as the reference attitude, and therefore the player can set an attitude that allows easy manipulation of the operating device as the reference attitude, so that pointing operations can be performed more readily.

(8) When the specified position calculated by the second specified position calculation section lies within a predetermined area on the screen of the display device, the reference setting section may set the attitude of the operating device as the reference attitude for the display device.

The “predetermined area” is intended to mean an area including the center of a screen in the example embodiment to be described later, but the area can be determined arbitrarily so long as it is on the screen of the display device.

According to the above configuration (8), the reference attitude is set when the operating device is directed toward the display device such that the specified position lies within a predetermined area. Accordingly, the player can set the reference attitude simply by directing the operating device toward the display device, and therefore the setting operation can be readily performed. In addition, the attitude of the operating device actually being directed toward the screen of the display device is set as the reference attitude, making it possible to set the reference attitude with precision.

(9) The marker sections may include light-emitting members. In this case, the input system further comprises a lighting control section. The lighting control section only lights up the marker section corresponding to a first one of the display devices when the reference setting section sets the reference attitude for the first display device, or only lights up the marker section corresponding to a second one of the display devices when the reference setting section sets the reference attitude for the second display device.

According to the above configuration (9), by lighting up the marker section corresponding to the display device for which the reference attitude is set while keeping the other marker section unlit, it is possible to prevent the image pickup section from erroneously sensing the marker section corresponding to the other display device. Thus, the reference attitude can be set with higher precision.

(10) The attitude calculation section may calculate the attitude of the operating device based on the position of the marker section in the image picked up by the image pickup section.

According to the above configuration (10), by using the position of the marker section in the pickup image, it is possible to calculate the attitude of the operating device with precision.

(11) The input system may further comprise an information processing apparatus, one of the display devices that is transportable, and one of the marker sections that is capable of emitting infrared light and corresponds to the other predetermined display device provided independently of the transportable display device.

The information processing apparatus includes a first image generation section, a second image generation section, an image compression section, a data transmission section, and an image output section. The first image generation section sequentially generates first images based on a predetermined information process. The second image generation section sequentially generates second images based on a predetermined information process. The image compression section generates compressed image data by sequentially compressing the second images. The data transmission section sequentially transmits the compressed image data to the transportable display device in a wireless manner. The image output section sequentially outputs the first images to the predetermined display device.

The transportable display device includes an infrared emission section, an image reception section, an image decompression section, and a display section. The infrared emission section is capable of emitting infrared light and functions as the marker section for the transportable display device. The image reception section sequentially receives the compressed image data from the information processing apparatus.

The image decompression section sequentially decompresses the compressed image data to obtain the second images. The display section sequentially displays the second images obtained by decompression.

The “information processing apparatus” may be a game information processing apparatus such as a game apparatus in the example embodiment to be described later, or may be a multipurpose information processing apparatus such as a general personal computer.

The term “transportable” is intended to mean a size that allows the user to hold and move the device or arbitrarily change the position of the device.

The “predetermined display device” may be any device, such as the television 2 in the example embodiment to be described later, which is provided independently of the transportable display device, so long as it is capable of displaying the first images generated by the information processing apparatus. For example, the external display device may be formed integrally with the information processing apparatus (within a single housing).

According to the above configuration (11), since the input system includes the transportable display device, the user can arbitrarily change the positional relationship between the display devices by changing the position of the transportable display device. In addition, according to the above configuration (11), even in the environment where there is only one stationary display device (e.g., a television), if there is another display device which is available and of a transportable type, it is possible to realize an input system allowing pointing operations on a plurality of display devices. Moreover, according to the above configuration (11), the second images are compressed and transmitted from the information processing apparatus to the transportable display device, and therefore can be wirelessly transmitted at high speed.

(12) The first specified position calculation section may calculate the specified position in accordance with an amount and a direction of change in a current attitude with respect to the reference attitude for the display device toward which the operating device is directed.

The “current attitude” is intended to mean the current attitude of the operating device that is calculated by the attitude calculation section.

According to the above configuration (12), the user can adjust the direction of change of the specified position in the same direction as the change in the attitude of the operating device, and can also adjust the amount of change of the specified position in the same amount of change in the attitude of the operating device, making it possible to readily and intuitively adjust the specified position.

(13) The input system may further comprise a direction image display control section for displaying a direction image at least on the display device unidentified by the identification section, the direction image representing a direction in which the operating device is oriented.

The “direction image display control section” displays a direction image on a display device other than a display device identified by the identification section, and may also display a direction image on the display device identified by the identification section in a prescribed case (e.g., where the operating device is not determined to be directed toward any display device or where a specified position representing a position outside the screen of the display device is calculated).

According to the above configuration (13), a direction image is displayed on the display device unidentified by the identification section, i.e., the display device toward which the operating device is not directed. Accordingly, for example, in the case where the user mistakenly views the display device toward which the operating device is not directed, it is possible to recognize by the direction image that the user is viewing the wrong display device. Thus, the user can perform a pointing operation without losing sight of the position (direction) specified by the operating device.

(14) An example game system described in the present specification comprises an input system as described in (1) to (13) above, and a game process section for performing a game process using a specified position calculated by the first specified position calculation section as an input.

According to the above configuration (14), it is possible to provide a game to be played by performing pointing operations on a plurality of display devices.

(15) The game system may further comprise a reference attitude storage section and a reference setting section. The reference attitude storage section stores a reference attitude for each display device, the reference attitude representing an attitude of the operating device being directed toward the display device. When the operating device is in a predetermined state, the reference setting section sets the attitude of the operating device in the reference attitude storage section as the reference attitude. In this case, the identification section identifies the display device toward which the operating device is directed, based on the attitude calculated by the attitude calculation section and the reference attitudes. The game process section performs the game process differently in accordance with a difference between the reference attitudes.

The wording “the game process (which is performed) differently in accordance with a difference between the reference attitudes” is intended to mean a game process in which the display, content, difficulty, etc., of the game change in accordance with the difference between the reference attitudes, e.g., the number of points to be scored may change in accordance with the difference or virtual cameras may be set in accordance with the reference attitudes (the positional relationship between the virtual cameras may change in accordance with the difference).

According to the above configuration (15), the difference between the reference attitudes, i.e., the positional relationship between the display devices, is reflected in the game process. Thus, it is possible to provide a novel and highly enjoyable game in which the content of the game changes in accordance with the positional relationship between the display devices.

(16) The game process section may include a first game image display control section, a selection section, an object movement section, and a second game image display control section. The first game image display control section causes a predetermined one of the display devices to display an image of a game space. Upon a user's predetermined instruction, the selection section selects a game object displayed at the specified position calculated by the first specified position calculation section. The object movement section moves the selected game object simultaneously with movement of the specified position. When the identification section identifies another display device with the game object being kept selected, the second game image display control section displays the game object at a specified position on a screen of that display device.

According to the above configuration (16), when the predetermined instruction is provided, a game object to be displayed on a predetermined display device is selected, and thereafter, when the operating device is directed toward another display device, the game object is displayed on that display device. Accordingly, the user (player) simply provides a predetermined instruction by directing the operating device to a display device and thereafter directs the operating device to another display device, so that the game object can be moved from one display device to another. Thus, the user can readily perform an intuitive operation to move a game object displayed on a display device to another display device.

Also, the present specification discloses an information processing apparatus including elements (excluding the marker section, the image pickup section, and the operating section) of the input system or the game system as described in (1) to (16) above. Moreover, the present specification also discloses a game program for causing the computer of the information processing apparatus to function as means equivalent to the elements as described above. Furthermore, the present specification also discloses a specified position calculation method to be performed by the input system or the game system as described in (1) to (16) above.

In the system, the information processing apparatus, the information processing program, and the specified position calculation method as mentioned above, one of a plurality of display devices toward which the operating device is directed is identified based on the attitude of the operating device, and a specified position is calculated as a position on the screen of the identified display device. In this manner, the specified position can be calculated as a position on the screen of the display device toward which the operating device is directed, making it possible to perform pointing operations toward a wider range of directions.

These and other objects, features, aspects and advantages will become more apparent from the following detailed description when taken in conjunction with the accompanying drawings.

### BRIEF DESCRIPTION OF THE DRAWINGS

FIG. 1 is an external view of an example non-limiting game system;

FIG. 2 is a block diagram illustrating an internal configuration of an example non-limiting game apparatus;

FIG. 3 is a perspective view illustrating an external configuration of an example non-limiting controller;

FIG. 4 is another perspective view illustrating an external configuration of the example non-limiting controller;

FIG. 5 is a diagram illustrating an internal configuration of the example non-limiting controller;

FIG. 6 is another diagram illustrating an internal configuration of the example non-limiting controller;

FIG. 7 is a block diagram illustrating a configuration of the example non-limiting controller;

FIG. 8 is a diagram illustrating an external configuration of an example non-limiting terminal device;

FIG. 9 is a diagram illustrating the example non-limiting terminal device being held by the user;

FIG. 10 is a block diagram illustrating an internal configuration of the example non-limiting terminal device;

FIG. 11 is a diagram illustrating example non-limiting pointing operations in an example embodiment;

FIG. 12 is a diagram illustrating example images for use in setting a first reference attitude;

FIG. 13 is a diagram illustrating example game images in the example embodiment;

FIG. 14 is a diagram illustrating various types of example non-limiting data for use in a game process;

FIG. 15 is a main flowchart showing a flow of an example game process to be performed by a game apparatus 3;

FIG. 16 is a flowchart illustrating a detailed flow of an example game control process (step S3) shown in FIG. 15;

FIG. 17 is a flowchart illustrating a detailed flow of an example first reference setting process (step S12) shown in FIG. 16;

FIG. 18 is a flowchart illustrating a detailed flow of an example attitude calculation process (step S22) shown in FIG. 17;

FIG. 19 is a flowchart illustrating a detailed flow of an example second reference setting process (step S14) shown in FIG. 16;

FIG. 20 is a flowchart illustrating a detailed flow of an example position calculation process (step S15) shown in FIG. 16;

FIG. 21 is a diagram illustrating example Z-axis vectors of a current attitude and reference attitudes;

FIG. 22 is a diagram illustrating an example method for calculating a projection position;

FIG. 23 is a diagram illustrating an example method for calculating a specified position;

FIG. 24 is a flowchart illustrating a detailed flow of an example object control process (step S16) shown in FIG. 16;

FIG. 25 is a flowchart illustrating a detailed flow of an example television game image generation process (step S4) shown in FIG. 15;

FIG. 26 is a flowchart illustrating a detailed flow of an example terminal game image generation process (step S5) shown in FIG. 15; and

FIG. 27 is a flowchart illustrating a detailed flow of an example first reference setting process in a variant of the example embodiment.

### DETAILED DESCRIPTION OF NON-LIMITING EXAMPLE EMBODIMENTS

### 1. Overall Configuration of the Game System

An example game system 1 according to an example embodiment will now be described with reference to the drawings.

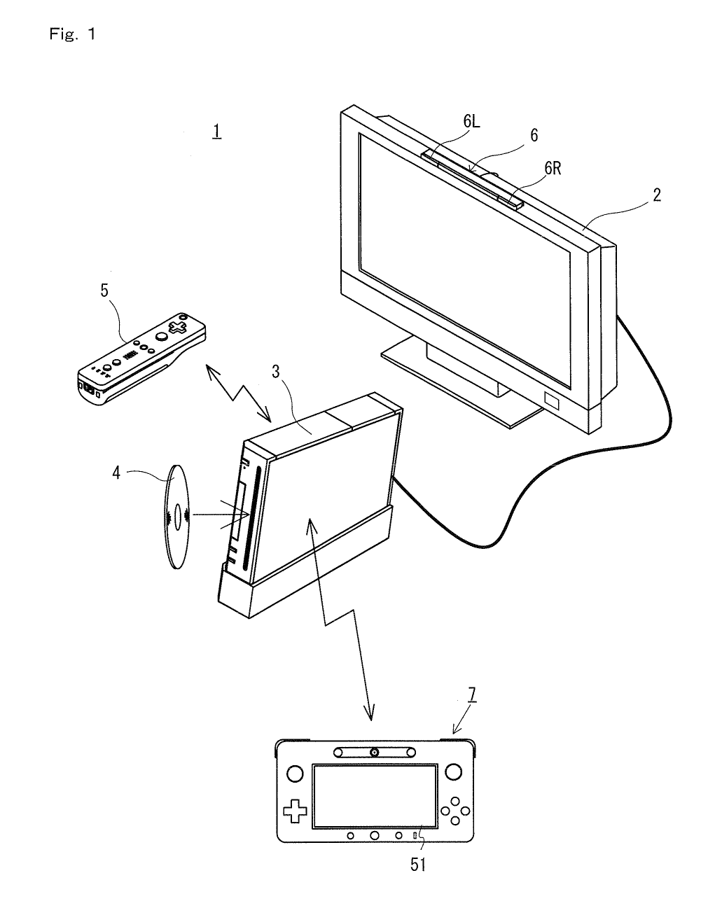

FIG. 1 is an external view of the game system 1. In FIG. 1, the game system 1 includes a stationary display device (hereinafter referred to as a “television”) 2 such as a television receiver, a stationary game apparatus 3, an optical disc 4, a controller 5, a marker device 6, and a terminal device 7. In the game system 1, the game apparatus 3 performs game processes based on game operations performed using the controller 5, and game images acquired through the game processes are displayed on the television 2 and/or the terminal device 7.

In the game apparatus 3, the optical disc 4 typifying an information storage medium used for the game apparatus 3 in a replaceable manner is removably inserted. An information processing program (a game program, for example) to be executed by the game apparatus 3 is stored in the optical disc 4. The game apparatus 3 has, on the front surface thereof, an insertion opening for the optical disc 4. The game apparatus 3 reads and executes the information processing program stored on the optical disc 4 which is inserted into the insertion opening, to perform the game process.

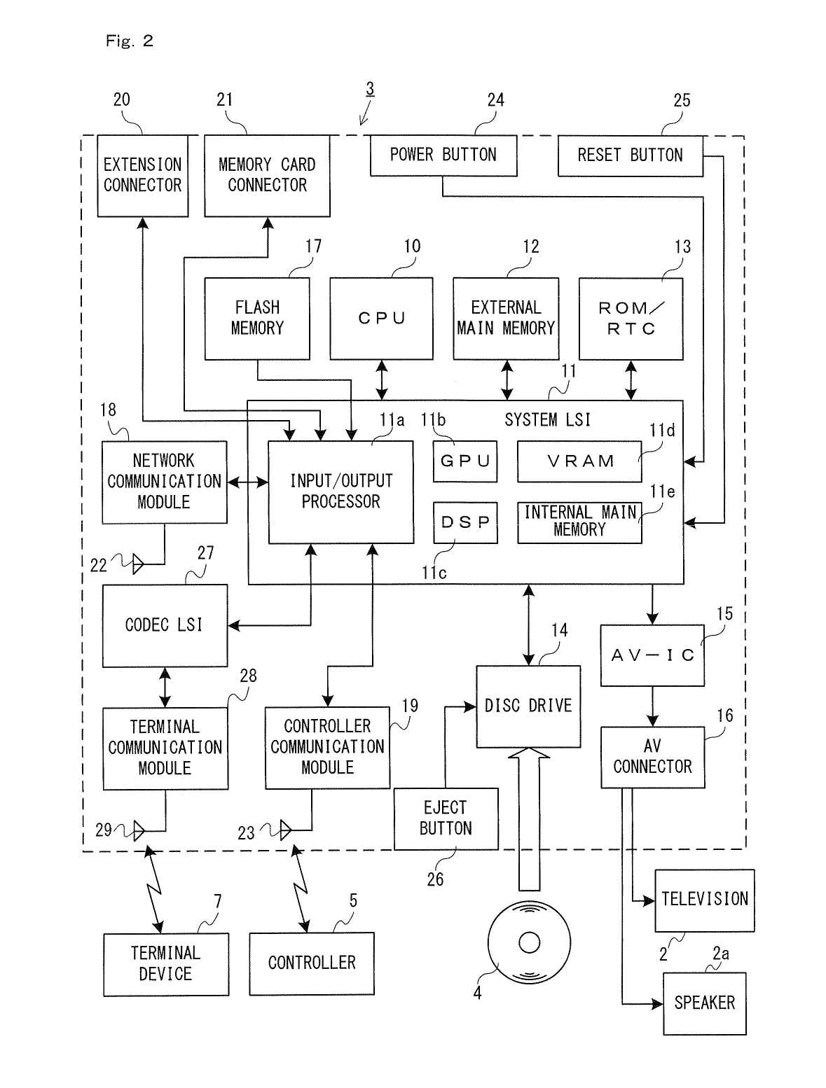

The television 2 is connected to the game apparatus 3 by a connecting cord. Game images acquired as a result of the game processes performed by the game apparatus 3 are displayed on the television 2. The television 2 includes a speaker 2a (see FIG. 2), and the speaker 2a outputs game sounds acquired as a result of the game process. In alternative example embodiments, the game apparatus 3 and the stationary display device may be an integral unit. Also, the communication between the game apparatus 3 and the television 2 may be wireless communication.

The marker device 6 is provided along the periphery of the screen (on the upper side of the screen in FIG. 1) of the television 2. The user (player) can perform game operations by moving the controller 5, the details of which will be described later, and the marker device 6 is used by the game apparatus 3 for calculating the movement, position, attitude, etc., of the controller 5. The marker device 6 includes two markers 6R and 6L on opposite ends thereof. Specifically, the marker 6R (as well as the marker 6L) includes one or more infrared LEDs (Light Emitting Diodes), and emits an infrared light in a forward direction from the television 2. The marker device 6 is connected to the game apparatus 3, and the game apparatus 3 is able to control the lighting of each infrared LED of the marker device 6. Note that the marker device 6 is of a transportable type so that the user can install the marker device 6 in any desired position. While FIG. 1 shows an example embodiment in which the marker device 6 is arranged on top of the television 2, the position and the direction of arranging the marker device 6 are not limited to this particular arrangement.

The controller 5 provides the game apparatus 3 with operation data representing the content of operations performed on the controller itself. The controller 5 and the game apparatus 3 can wirelessly communicate with each other. In the present example embodiment, the wireless communication between the controller 5 and the game apparatus 3 uses, for example, Bluetooth (Registered Trademark) technology. In other example embodiments, the controller 5 and the game apparatus 3 may be connected by a wired connection. Furthermore, in the present example embodiment, the game system 1 includes only one controller 5, but the game apparatus 3 is capable of communicating with a plurality of controllers, so that by using a predetermined number of controllers at the same time, a plurality of people can play the game. The configuration of the controller 5 will be described in detail later.

The terminal device 7 is of a size that can be held by the user, so that the user can hold and move the terminal device 7 or can place the terminal device 7 in any desired position. As will be described in detail later, the terminal device 7 includes a liquid crystal display (LCD) 51, and input means (e.g., a touch panel 52 and a gyroscope 64 to be described later). The terminal device 7 can communicate with the game apparatus 3 wirelessly (or wired). The terminal device 7 receives data for images generated by the game apparatus 3 (e.g., game images) from the game apparatus 3, and displays the images on the LCD 51. Note that in the present example embodiment, the LCD is used as the display of the terminal device 7, but the terminal device 7 may include any other display device, e.g., a display device utilizing electro luminescence (EL). Furthermore, the terminal device 7 transmits operation data representing the content of operations performed thereon to the game apparatus 3.

### 2. Internal Configuration of the Game Apparatus 3

An internal configuration of the game apparatus 3 will be described with reference to FIG. 2. FIG. 2 is a block diagram illustrating an internal configuration of the game apparatus 3. The game apparatus 3 includes a CPU (Central Processing Unit) 10, a system LSI 11, external main memory 12, a ROM/RTC 13, a disc drive 14, and an AV-IC 15.

The CPU 10 performs game processes by executing a game program stored, for example, on the optical disc 4, and functions as a game processor. The CPU 10 is connected to the system LSI 11. The external main memory 12, the ROM/RTC 13, the disc drive 14, and the AV-IC 15, as well as the CPU 10, are connected to the system LSI 11. The system LSI 11 performs processes for controlling data transmission between the respective components connected thereto, generating images to be displayed, acquiring data from an external device(s), and the like. The internal configuration of the system LSI 11 will be described below. The external main memory 12 is of a volatile type and stores a program such as a game program read from the optical disc 4, a game program read from flash memory 17, and various data. The external main memory 12 is used as a work area and a buffer area for the CPU 10. The ROM/RTC 13 includes a ROM (a so-called boot ROM) incorporating a boot program for the game apparatus 3, and a clock circuit (RTC: Real Time Clock) for counting time. The disc drive 14 reads program data, texture data, and the like from the optical disc 4, and writes the read data into internal main memory 11e (to be described below) or the external main memory 12.

The system LSI 11 includes an input/output processor (I/O processor) 11a, a GPU (Graphics Processor Unit) 11b, a DSP (Digital Signal Processor) 11c, VRAM (Video RAM) 11d, and the internal main memory 11e. Although not shown in the figures, these components 11a to 11e are connected with each other through an internal bus.

The GPU 11b, acting as a part of a rendering mechanism, generates images in accordance with graphics commands (rendering commands) from the CPU 10. The VRAM 11d stores data (data such as polygon data and texture data) to be used by the GPU 11b to execute the graphics commands. When images are generated, the GPU 11b generates image data using data stored in the VRAM 11d. Note that in the present example embodiment, the game apparatus 3 generates both game images to be displayed on the television 2 and game images to be displayed on the terminal device 7. Hereinafter, the game images to be displayed on the television 2 are referred to as the “television game images” and the game images to be displayed on the terminal device 7 are referred to as the “terminal game images”.

The DSP 11c, functioning as an audio processor, generates sound data using sound data and sound waveform (e.g., tone quality) data stored in one or both of the internal main memory 11e and the external main memory 12. Note that in the present example embodiment, game sounds to be generated are classified into two types as in the case of the game images, one being outputted from the speaker of the television 2, the other being outputted from speakers of the terminal device 7. Hereinafter, in some cases, the game sounds to be outputted from the television 2 are referred to as “television game sounds”, and the game sounds to be outputted from the terminal device 7 are referred to as “terminal game sounds”.

Among the images and sounds generated by the game apparatus 3 as described above, both image data and sound data to be outputted from the television 2 are read out by the AV-IC 15. The AV-IC 15 outputs the read-out image data to the television 2 via an AV connector 16, and outputs the read-out sound data to the speaker 2a provided in the television 2. Thus, images are displayed on the television 2, and sounds are outputted from the speaker 2a.

Furthermore, among the images and sounds generated by the game apparatus 3, both image data and sound data to be outputted by the terminal device 7 are transmitted to the terminal device 7 by the input/output processor 11a, etc. The data transmission to the terminal device 7 by the input/output processor 11a, etc., will be described later.

The input/output processor 11a exchanges data with components connected thereto, and downloads data from an external device(s). The input/output processor 11a is connected to the flash memory 17, a network communication module 18, a controller communication module 19, an expansion connector 20, a memory card connector 21, and a codec LSI 27. Furthermore, an antenna 22 is connected to the network communication module 18. An antenna 23 is connected to the controller communication module 19. The codec LSI 27 is connected to a terminal communication module 28, and an antenna 29 is connected to the terminal communication module 28.

The game apparatus 3 is capable of connecting to a network such as the Internet to communicate with external information processing apparatuses (e.g., other game apparatuses and various servers). Specifically, the input/output processor 11a can be connected to a network such as the Internet via the network communication module 18 and the antenna 22 to communicate with external information processing apparatuses connected to the network. The input/output processor 11a regularly accesses the flash memory 17, and detects the presence or absence of any data which needs to be transmitted to the network, and when detected, transmits the data to the network via the network communication module 18 and the antenna 22. Further, the input/output processor 11a receives data transmitted from the external information processing apparatuses and data downloaded from a download server via the network, the antenna 22 and the network communication module 18, and stores the received data in the flash memory 17. The CPU 10 executes a game program so as to read data stored in the flash memory 17 and use the data, as appropriate, in the game program. The flash memory 17 may store game save data (e.g., game result data or unfinished game data) of a game played using the game apparatus 3 in addition to data exchanged between the game apparatus 3 and the external information processing apparatuses. Moreover, the flash memory 17 may have a game program stored therein.

Furthermore, the game apparatus 3 is capable of receiving operation data from the controller 5. Specifically, the input/output processor 11a receives operation data transmitted from the controller 5 via the antenna 23 and the controller communication module 19, and stores it (temporarily) in a buffer area of the internal main memory 11e or the external main memory 12.

Furthermore, the game apparatus 3 is capable of exchanging data, for images, sound, etc., with the terminal device 7. When transmitting game images (terminal game images) to the terminal device 7, the input/output processor 11a outputs game image data generated by the GPU 11b to the codec LSI 27. The codec LSI 27 performs a predetermined compression process on the image data from the input/output processor 11a. The terminal communication module 28 wirelessly communicates with the terminal device 7. Accordingly, the image data compressed by the codec LSI 27 is transmitted by the terminal communication module 28 to the terminal device 7 via the antenna 29. In the present example embodiment, the image data transmitted from the game apparatus 3 to the terminal device 7 is image data used in a game, and the playability of a game can be adversely influenced if there is a delay in the images displayed in the game. Therefore, delay may be avoided as much as possible in transmitting image data from the game apparatus 3 to the terminal device 7. Therefore, in the present example embodiment, the codec LSI 27 compresses image data using a compression technique with high efficiency such as the H.264 standard, for example. Other compression techniques may be used, and image data may be transmitted uncompressed if the communication speed is sufficient. The terminal communication module 28 is, for example, a Wi-Fi certified communication module, and may perform wireless communication at high speed with the terminal device 7 using a MIMO (Multiple Input Multiple Output) technique employed in the IEEE 802.11n standard, for example, or may use other communication schemes.

Furthermore, in addition to the image data, the game apparatus 3 also transmits sound data to the terminal device 7. Specifically, the input/output processor 11a outputs sound data generated by the DSP 11c to the terminal communication module 28 via the codec LSI 27. The codec LSI 27 performs a compression process on the sound data as it does on the image data. Any method can be employed for compressing the sound data, and such a method may use a high compression rate but may cause less sound degradation. Also, in another example embodiment, the sound data may be transmitted without compression. The terminal communication module 28 transmits compressed image and sound data to the terminal device 7 via the antenna 29.

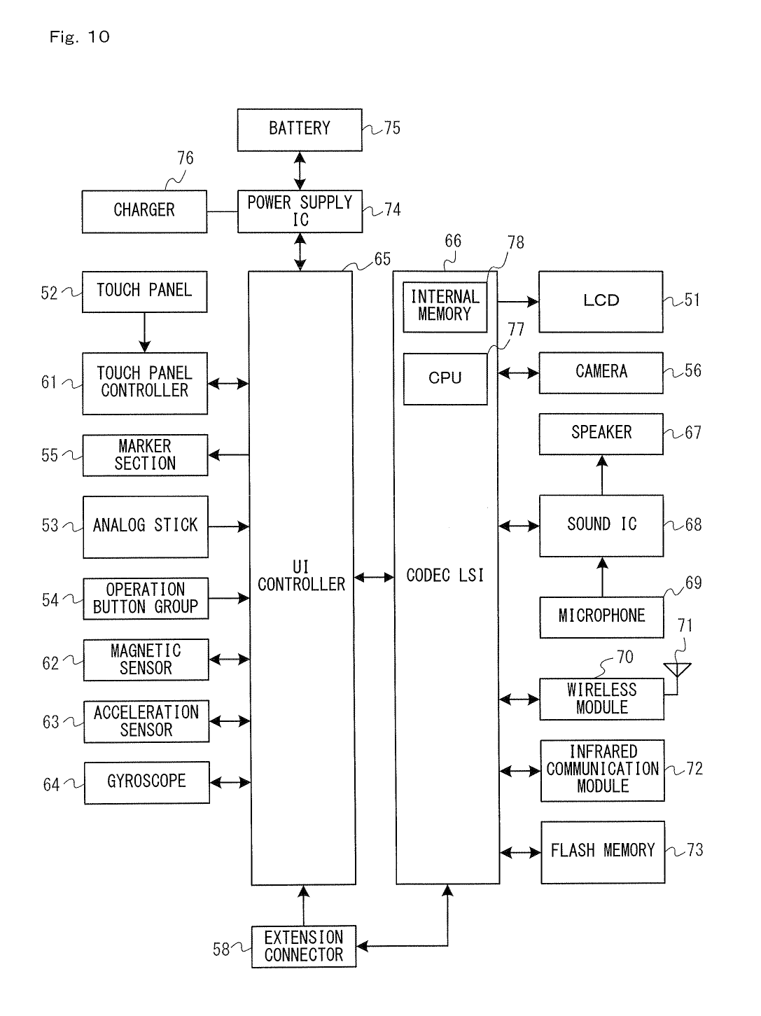

Furthermore, in addition to the image and sound data, the game apparatus 3 transmits various control data to the terminal device 7 where appropriate. The control data is data representing an instruction to control a component included in the terminal device 7, e.g., an instruction to control lighting of a marker section (a marker section 55 shown in FIG. 10) or an instruction to control shooting by a camera (a camera 56 shown in FIG. 10). The input/output processor 11a transmits the control data to the terminal device 7 in accordance with an instruction from the CPU 10. Note that in the present example embodiment, the codec LSI 27 does not perform a compression process on the control data, but in another example embodiment, a compression process may be performed. Note that the data to be transmitted from the game apparatus 3 to the terminal device 7 may or may not be coded depending on the situation.

Furthermore, the game apparatus 3 is capable of receiving various data from the terminal device 7. As will be described in detail later, in the present example embodiment, the terminal device 7 transmits operation data, image data, and sound data. The data transmitted by the terminal device 7 is received by the terminal communication module 28 via the antenna 29. Here, the image data and the sound data from the terminal device 7 have been subjected to the same compression process as performed on the image data and the sound data from the game apparatus 3 to the terminal device 7. Accordingly, the image data and the sound data are transferred from the terminal communication module 28 to the codec LSI 27, and subjected to a decompression process by the codec LSI 27 before output to the input/output processor 11a. On the other hand, the operation data from the terminal device 7 is smaller in size than the image data or the sound data and therefore is not always subjected to a compression process. Moreover, the operation data may or may not be coded depending on the situation. Accordingly, after being received by the terminal communication module 28, the operation data is outputted to the input/output processor 11a via the codec LSI 27. The input/output processor 11a stores the data received from the terminal device 7 (temporarily) in a buffer area of the internal main memory 11e or the external main memory 12.

Furthermore, the game apparatus 3 can be connected to other devices or external storage media. Specifically, the input/output processor 11a is connected to the expansion connector 20 and the memory card connector 21. The expansion connector 20 is a connector for an interface, such as a USB or SCSI interface. The expansion connector 20 can receive a medium such as an external storage medium, a peripheral device such as another controller, or a wired communication connector which enables communication with a network in place of the network communication module 18. The memory card connector 21 is a connector for connecting thereto an external storage medium such as a memory card (which may be of a proprietary or standard format, such as SD, miniSD, microSD, Compact Flash, etc.). For example, the input/output processor 11a can access an external storage medium via the expansion connector 20 or the memory card connector 21 to store data in the external storage medium or read data from the external storage medium.

The game apparatus 3 includes a power button 24, a reset button 25, and an eject button 26. The power button 24 and the reset button 25 are connected to the system LSI 11. When the power button 24 is on, power is supplied from an external power source to the components of the game apparatus 3 via an AC adaptor (not shown). When the reset button 25 is pressed, the system LSI 11 reboots a boot program of the game apparatus 3. The eject button 26 is connected to the disc drive 14. When the eject button 26 is pressed, the optical disc 4 is ejected from the disc drive 14.

In other example embodiments, some of the components of the game apparatus 3 may be provided as extension devices separate from the game apparatus 3. In this case, an extension device may be connected to the game apparatus 3 via the expansion connector 20, for example. Specifically, an extension device may include components as described above, e.g., a codec LSI 27, a terminal communication module 28, and an antenna 29, and can be attached to/detached from the expansion connector 20. Thus, by connecting the extension device to a game apparatus which does not include the above components, the game apparatus can communicate with the terminal device 7.

### 3. Configuration of the Controller 5

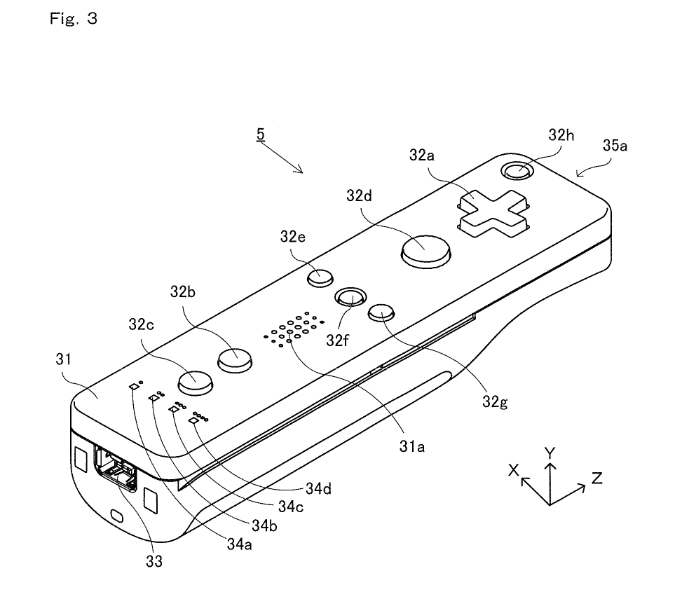

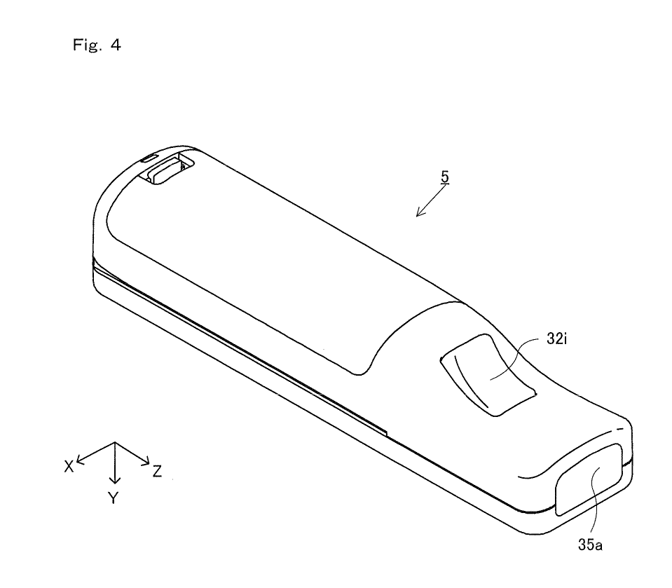

Next, with reference to FIGS. 3 to 7, the controller 5 will be described. FIG. 3 is a perspective view illustrating an external configuration of the controller 5. FIG. 4 is a perspective view illustrating an external configuration of the controller 5. The perspective view of FIG. 3 shows the controller 5 as viewed from the top rear side thereof, and the perspective view of FIG. 4 shows the controller 5 as viewed from the bottom front side thereof.

As shown in FIG. 3 and FIG. 4, the controller 5 has a housing 31 formed by, for example, plastic molding. The housing 31 has a generally parallelepiped shape extending in a longitudinal direction from front to rear (Z-axis direction shown in FIG. 3), and as a whole is sized to be held by one hand of an adult or even a child. The user can perform game operations by pressing buttons provided on the controller 5, and moving the controller 5 to change the position and the attitude (tilt) thereof.

The housing 31 has a plurality of operation buttons. As shown in FIG. 3, on the top surface of the housing 31, a cross button 32a, a first button 32b, a second button 32c, an A button 32d, a minus button 32e, a home button 32f, a plus button 32g, and a power button 32h are provided. In the present example embodiment, the top surface of the housing 31 on which the buttons 32a to 32h are provided may be referred to as a “button surface”. On the other hand, as shown in FIG. 4, a recessed portion is formed on the bottom surface of the housing 31, and a B button 32i is provided on a rear slope surface of the recessed portion. The operation buttons 32a to 32i are appropriately assigned their respective functions in accordance with the information processing program executed by the game apparatus 3. Further, the power button 32h is intended to remotely turn ON/OFF the game apparatus 3. The home button 32f and the power button 32h each have the top surface thereof recessed below the top surface of the housing 31. Therefore, the home button 32f and the power button 32h are prevented from being inadvertently pressed by the user.

On the rear surface of the housing 31, the connector 33 is provided. The connector 33 is used for connecting the controller 5 to another device (e.g., another sensor unit or controller). Both sides of the connector 33 on the rear surface of the housing 31 have a fastening hole 33a for preventing easy inadvertent disengagement of another device as described above.

In the rear-side portion of the top surface of the housing 31, a plurality (four in FIG. 3) of LEDs 34a, 34b, 34c, and 34d are provided. The controller 5 is assigned a controller type (number) so as to be distinguishable from another controller. The LEDs 34a, 34b, 34c, and 34d are each used for informing the user of the controller type which is currently being set for the controller 5 being used, and for informing the user of remaining battery power of the controller 5, for example. Specifically, when a game operation is performed using the controller 5, one of the LEDs 34a, 34b, 34c, and 34d corresponding to the controller type is lit up.

The controller 5 has an imaging information calculation section 35 (FIG. 6), and a light incident surface 35a through which a light is incident on the imaging information calculation section 35 is provided on the front surface of the housing 31, as shown in FIG. 4. The light incident surface 35a is made of a material transmitting therethrough at least infrared light outputted from the markers 6R and 6L.

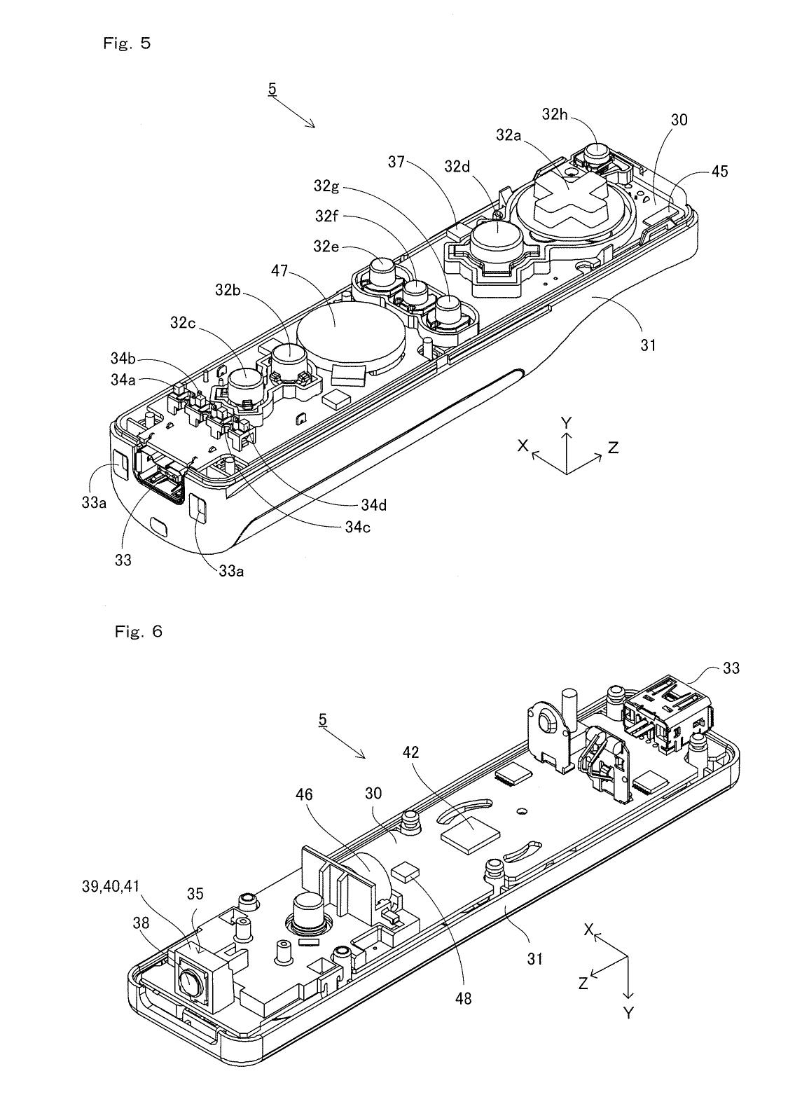

On the top surface of the housing 31, sound holes 31a for externally outputting a sound from a speaker 47 (shown in FIG. 5) incorporated in the controller 5 is provided between the first button 32b and the home button 32f.

Next, with reference to FIGS. 5 and 6, an internal configuration of the controller 5 will be described. FIG. 5 and FIG. 6 are diagrams illustrating the internal configuration of the controller 5. FIG. 5 is a perspective view illustrating a state where an upper casing (a part of the housing 31) of the controller 5 is removed. FIG. 6 is a perspective view illustrating a state where a lower casing (a part of the housing 31) of the controller 5 is removed. The perspective view of FIG. 6 shows a substrate 30 of FIG. 5 as viewed from the reverse side.

As shown in FIG. 5, the substrate 30 is fixed inside the housing 31, and on a top main surface of the substrate 30, the operation buttons 32a to 32h, the LEDs 34a, 34b, 34c, and 34d, an acceleration sensor 37, an antenna 45, the speaker 47, and the like are provided. These elements are connected to a microcomputer 42 (see FIG. 6) via lines (not shown) formed on the substrate 30 and the like. In the present example embodiment, the acceleration sensor 37 is provided on a position offset from the center of the controller 5 with respect to the X-axis direction. Thus, calculation of the movement of the controller 5 being rotated about the Z-axis may be facilitated. Further, the acceleration sensor 37 is provided anterior to the center of the controller 5 with respect to the longitudinal direction (Z-axis direction). Further, a wireless module 44 (see FIG. 6) and the antenna 45 allow the controller 5 to act as a wireless controller.

On the other hand, as shown in FIG. 6, at a front edge of a bottom main surface of the substrate 30, the imaging information calculation section 35 is provided. The imaging information calculation section 35 includes an infrared filter 38, a lens 39, an image pickup element 40 and an image processing circuit 41 located in order, respectively, from the front of the controller 5. These components 38 to 41 are attached on the bottom main surface of the substrate 30.

On the bottom main surface of the substrate 30, the microcomputer 42 and a vibrator 46 are provided. The vibrator 46 is, for example, a vibration motor or a solenoid, and is connected to the microcomputer 42 via lines formed on the substrate 30 or the like. The controller 5 is vibrated by actuation of the vibrator 46 based on a command from the microcomputer 42. Therefore, the vibration is conveyed to the user's hand holding the controller 5, and thus a so-called vibration-feedback game is realized. In the present example embodiment, the vibrator 46 is disposed slightly toward the front of the housing 31. That is, the vibrator 46 is positioned offset from the center toward the end of the controller 5, and therefore the vibration of the vibrator 46 can lead to enhancement of the vibration of the entire controller 5. Further, the connector 33 is provided at the rear edge of the bottom main surface of the substrate 30. In addition to the components shown in FIGS. 5 and 6, the controller 5 includes a quartz oscillator for generating a reference clock of the microcomputer 42, an amplifier for outputting a sound signal to the speaker 47, and the like.

FIGS. 3 to 6 only show examples of the shape of the controller 5, the shape of each operation button, the number and the positions of acceleration sensors and vibrators, and so on, and other shapes, numbers, and positions may be employed. Further, although in the present example embodiment the imaging direction of the image pickup means is the Z-axis positive direction, the imaging direction may be any direction. That is, the imagining information calculation section 35 (the light incident surface 35a through which a light is incident on the imaging information calculation section 35) of the controller 5 may not necessarily be provided on the front surface of the housing 31, but may be provided on any other surface on which a light can be received from the outside of the housing 31.

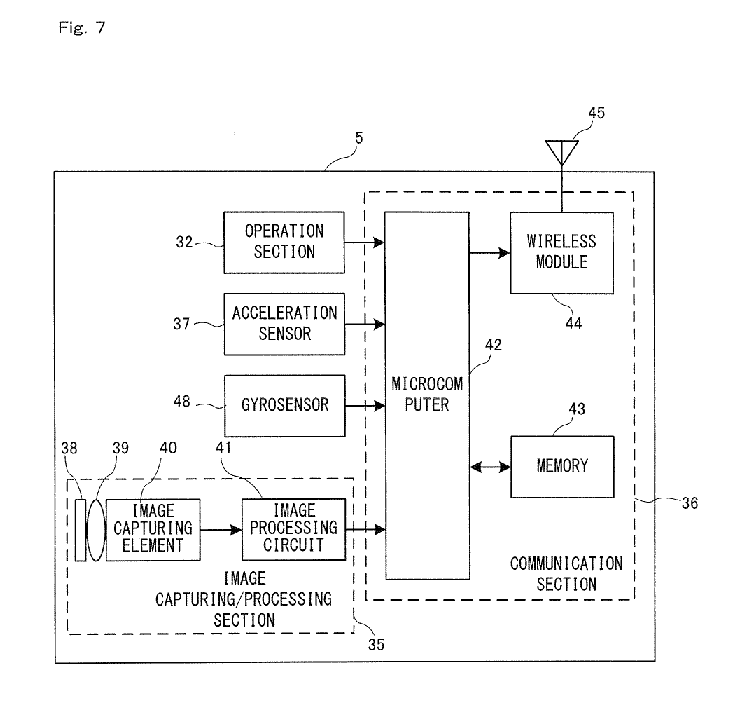

FIG. 7 is a block diagram illustrating a configuration of the controller 5. The controller 5 includes an operating section 32 (the operation buttons 32a to 32i), the imaging information calculation section 35, a communication section 36, the acceleration sensor 37, and a gyroscope 48. The controller 5 transmits, as operation data, data representing the content of an operation performed on the controller 5 itself, to the game apparatus 3. Note that hereinafter, in some cases, operation data transmitted by the controller 5 is referred to as “controller operation data”, and operation data transmitted by the terminal device 7 is referred to as “terminal operation data”.

The operating section 32 includes the operation buttons 32a to 32i described above, and outputs, to the microcomputer 42 of the communication section 36, operation button data indicating an input state (that is, whether or not each operation button 32a to 32i is pressed) of each operation button 32a to 32i.

The imaging information calculation section 35 is a system for analyzing image data taken by the image pickup means and calculating, for example, the centroid and the size of an area having a high brightness in the image data. The imaging information calculation section 35 has a maximum sampling period of, for example, about 200 frames/sec., and therefore can trace and analyze even a relatively fast motion of the controller 5.

The imaging information calculation section 35 includes the infrared filter 38, the lens 39, the image pickup element 40 and the image processing circuit 41. The infrared filter 38 transmits therethrough only infrared light included in the light incident on the front surface of the controller 5. The lens 39 collects the infrared light transmitted through the infrared filter 38 so as to be incident on the image pickup element 40. The image pickup element 40 is a solid-state imaging device such as, for example, a CMOS sensor or a CCD sensor, which receives the infrared light collected by the lens 39, and outputs an image signal. The marker section 55 of the terminal device 7 and the marker device 6, which are subjects to be imaged, include markers for outputting infrared light. Therefore, the infrared filter 38 enables the image pickup element 40 to receive only the infrared light transmitted through the infrared filter 38 and generate image data, so that an image of each subject to be imaged (the marker section 55 and/or the marker device 6) can be taken with enhanced accuracy. Hereinafter, the image taken by the image pickup element 40 is referred to as a pickup image. The image data generated by the image pickup element 40 is processed by the image processing circuit 41. The image processing circuit 41 calculates, in the pickup image, the positions of subjects to be imaged. The image processing circuit 41 outputs data representing coordinate points of the calculated positions, to the microcomputer 42 of the communication section 36. The data representing the coordinate points is transmitted as operation data to the game apparatus 3 by the microcomputer 42. Hereinafter, the coordinate points are referred to as “marker coordinate points”. The marker coordinate point changes depending on the attitude (angle of tilt) and/or the position of the controller 5 itself, and therefore the game apparatus 3 is allowed to calculate the attitude and the position of the controller 5 using the marker coordinate point.

In another example embodiment, the controller 5 may not necessarily include the image processing circuit 41, and the controller 5 may transmit the pickup image as it is to the game apparatus 3. At this time, the game apparatus 3 may have a circuit or a program, having the same function as the image processing circuit 41, for calculating the marker coordinate point.

The acceleration sensor 37 detects accelerations (including a gravitational acceleration) of the controller 5, that is, force (including gravity) applied to the controller 5. The acceleration sensor 37 detects a value of an acceleration (linear acceleration) applied to a detection section of the acceleration sensor 37 in the straight line direction along the sensing axis direction, among all accelerations applied to a detection section of the acceleration sensor 37. For example, a multiaxial acceleration sensor having two or more axes detects an acceleration of a component for each axis, as the acceleration applied to the detection section of the acceleration sensor. The acceleration sensor 37 is, for example, a capacitive MEMS (Micro-Electro Mechanical System) acceleration sensor. However, another type of acceleration sensor may be used.

In the present example embodiment, the acceleration sensor 37 detects a linear acceleration in each of three axis directions, i.e., the up/down direction (Y-axis direction shown in FIG. 3), the left/right direction (the X-axis direction shown in FIG. 3), and the forward/backward direction (the Z-axis direction shown in FIG. 3), relative to the controller 5. The acceleration sensor 37 detects acceleration in the straight line direction along each axis, and an output from the acceleration sensor 37 represents a value of the linear acceleration for each of the three axes. In other words, the detected acceleration is represented as a three-dimensional vector in an XYZ-coordinate system (controller coordinate system) defined relative to the controller 5.

Data (acceleration data) representing the acceleration detected by the acceleration sensor 37 is outputted to the communication section 36. The acceleration detected by the acceleration sensor 37 changes depending on the attitude (angle of tilt) and the movement of the controller 5, and therefore the game apparatus 3 is allowed to calculate the attitude and the movement of the controller 5 using the acquired acceleration data. In the present example embodiment, the game apparatus 3 calculates the attitude, angle of tilt, etc., of the controller 5 based on the acquired acceleration data.

When a computer such as a processor (e.g., the CPU 10) of the game apparatus 3 or a processor (e.g., the microcomputer 42) of the controller 5 processes an acceleration signal outputted from the acceleration sensor 37 (or similarly from an acceleration sensor 63 to be described later), additional information relating to the controller 5 can be inferred or calculated (determined), as one skilled in the art will readily understand from the description herein. For example, in the case where the computer performs processing on the premise that the controller 5 including the acceleration sensor 37 is in static state (that is, in the case where processing is performed on the premise that the acceleration to be detected by the acceleration sensor includes only the gravitational acceleration), when the controller 5 is actually in static state, it is possible to determine whether or not, or how much the controller 5 tilts relative to the direction of gravity, based on the acceleration having been detected. Specifically, when the state where the detection axis of the acceleration sensor 37 faces vertically downward is set as a reference, whether or not the controller 5 tilts relative to the reference can be determined based on whether or not 1 G (gravitational acceleration) is applied to the detection axis, and the degree to which the controller 5 tilts relative to the reference can be determined based on the magnitude of the gravitational acceleration. Further, the multiaxial acceleration sensor 37 processes the acceleration signals having been detected for the respective axes so as to more specifically determine the degree to which the controller 5 tilts relative to the direction of gravity. In this case, the processor may calculate, based on the output from the acceleration sensor 37, the angle at which the controller 5 tilts, or the direction in which the controller 5 tilts without calculating the angle of tilt. Thus, the acceleration sensor 37 is used in combination with the processor, making it possible to determine the angle of tilt or the attitude of the controller 5.

On the other hand, when it is premised that the controller 5 is in dynamic state (where the controller 5 is being moved), the acceleration sensor 37 detects the acceleration based on the movement of the controller 5, in addition to the gravitational acceleration. Therefore, when the gravitational acceleration component is eliminated from the detected acceleration through a predetermined process, it is possible to determine the direction in which the controller 5 moves. Even when it is premised that the controller 5 is in dynamic state, the acceleration component based on the movement of the acceleration sensor is eliminated from the detected acceleration through a predetermined process, whereby it is possible to determine the tilt of the controller 5 relative to the direction of gravity. In another example embodiment, the acceleration sensor 37 may include an embedded processor or another type of dedicated processor for performing any desired processing on an acceleration signal detected by the acceleration detection means incorporated therein before outputting to the microcomputer 42. For example, when the acceleration sensor 37 is intended to detect static acceleration (for example, gravitational acceleration), the embedded or dedicated processor could convert the acceleration signal to a corresponding angle of tilt (or another appropriate parameter).

The gyroscope 48 detects angular rates about three axes (in the present example embodiment, the X-, Y-, and Z-axes). In the present specification, the directions of rotation about the X-axis, the Y-axis, and the Z-axis relative to the imaging direction (the Z-axis positive direction) of the controller 5 are referred to as a pitch direction, a yaw direction, and a roll direction, respectively. So long as the gyroscope 48 can detect the angular rates about the three axes, any number thereof may be used, and also any combination of sensors may be included therein. That is, the two-axis gyroscope 55 detects angular rates in the pitch direction (the direction of rotation about the X-axis) and the roll direction (the direction of rotation about the Z-axis), and the one-axis gyroscope 56 detects an angular rate in the yaw direction (the direction of rotation about the Y-axis). For example, the gyroscope 48 may be a three-axis gyroscope or may include a combination of a two-axis gyroscope and a one-axis gyroscope to detect the angular rates about the three axes. Data representing the angular rates detected by the gyroscope 48 is outputted to the communication section 36. Alternatively, the gyroscope 48 may simply detect an angular rate about one axis or angular rates about two axes.

The communication section 36 includes the microcomputer 42, memory 43, the wireless module 44 and the antenna 45. The microcomputer 42 controls the wireless module 44 for wirelessly transmitting, to the game apparatus 3, data acquired by the microcomputer 42 while using the memory 43 as a storage area in the process.

Data outputted from the operating section 32, the imaging information calculation section 35, the acceleration sensor 37, and the gyroscope 48 to the microcomputer 42 is temporarily stored to the memory 43. The data is transmitted as operation data (controller operation data) to the game apparatus 3. Specifically, at the time of the transmission to the controller communication module 19 of the game apparatus 3, the microcomputer 42 outputs the operation data stored in the memory 43 to the wireless module 44. The wireless module 44 uses, for example, the Bluetooth (registered trademark) technology to modulate the operation data onto a carrier wave of a predetermined frequency, and radiates the low power radio wave signal from the antenna 45. That is, the operation data is modulated onto the low power radio wave signal by the wireless module 44 and transmitted from the controller 5. The controller communication module 19 of the game apparatus 3 receives the low power radio wave signal. The game apparatus 3 demodulates or decodes the received low power radio wave signal to acquire the operation data. The CPU 10 of the game apparatus 3 performs the game process using the operation data acquired from the controller 5. The wireless transmission from the communication section 36 to the controller communication module 19 is sequentially performed at a predetermined time interval. Since the game process is generally performed at a cycle of 1/60 sec. (corresponding to one frame time), data may be transmitted at a cycle of a shorter time period. The communication section 36 of the controller 5 outputs, to the controller communication module 19 of the game apparatus 3, the operation data at intervals of 1/200 seconds, for example.

As described above, the controller 5 can transmit marker coordinate data, acceleration data, angular rate data, and operation button data as operation data representing operations performed thereon. In addition, the game apparatus 3 executes the game process using the operation data as game inputs. Accordingly, by using the controller 5, the user can perform the game operation of moving the controller 5 itself, in addition to conventionally general game operations of pressing operation buttons. For example, it is possible to perform the operations of tilting the controller 5 to arbitrary attitudes, pointing the controller 5 to arbitrary positions on the screen, and moving the controller 5 itself.

Also, in the present example embodiment, the controller 5 is not provided with any display means for displaying game images, but the controller 5 may be provided with a display means for displaying an image or suchlike to indicate, for example, a remaining battery level.

### 4. Configuration of the Terminal Device 7

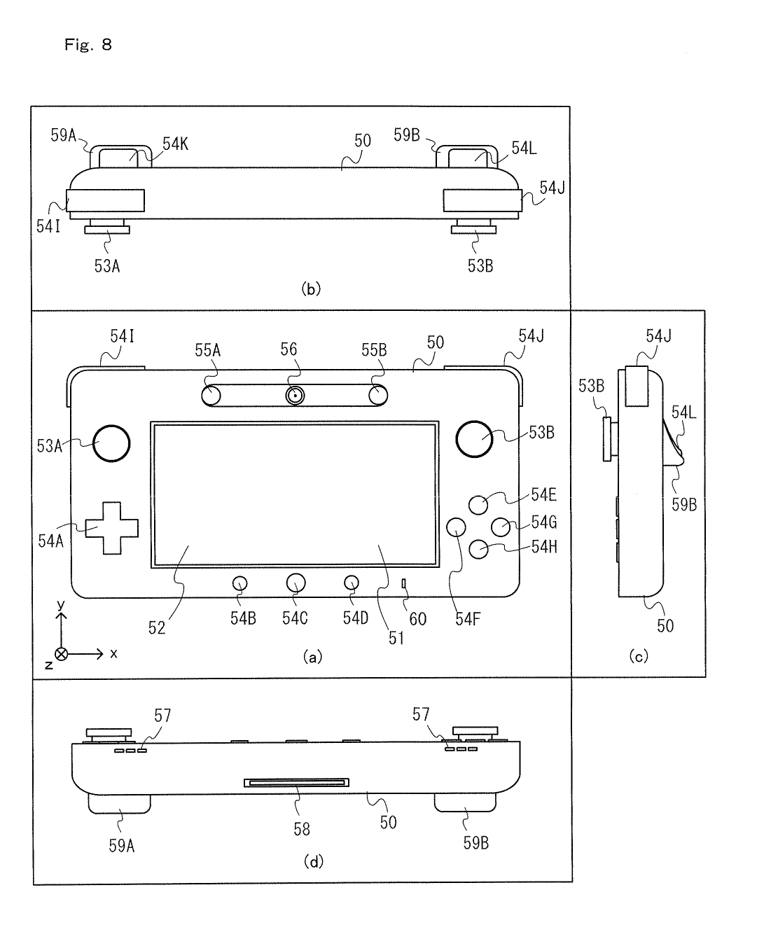

Next, referring to FIGS. 8 to 10, the configuration of the terminal device 7 will be described. FIG. 8 provides views illustrating an external configuration of the terminal device 7.

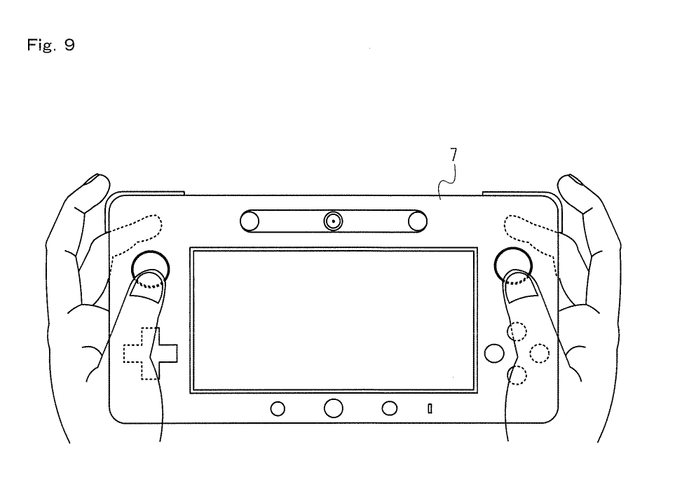

In FIG. 8, parts (a), (b), (c), and (d) are a front view, a top view, a right side view, and a bottom view, respectively, of the terminal device 7. FIG. 9 is a diagram illustrating the terminal device 7 being held by the user.

As shown in FIG. 8, the terminal device 7 has a housing 50 roughly shaped in the form of a horizontally rectangular plate. The housing 50 is sized to be held by the user. Thus, the user can hold and move the terminal device 7, and can change the position of the terminal device 7.

The terminal device 7 includes an LCD 51 on the front surface of the housing 50. The LCD 51 is provided approximately at the center of the surface of the housing 50. Therefore, the user can hold and move the terminal device while viewing the screen of the LCD 51 by holding the housing 50 by edges to the left and right of the LCD 51, as shown in FIG. 9. While FIG. 9 shows an example where the user holds the terminal device 7 horizontal (horizontally long) by holding the housing 50 by edges to the left and right of the LCD 51, the user can hold the terminal device 7 vertical (vertically long).

As shown in FIG. 8(a), the terminal device 7 includes a touch panel 52 on the screen of the LCD 51 as an operating means. In the present example embodiment, the touch panel 52 is a resistive touch panel. However, the touch panel is not limited to the resistive type, and may be of any type such as capacitive. The touch panel 52 may be single-touch or multi-touch. In the present example embodiment, a touch panel having the same resolution (detection precision) as the LCD 51 is used as the touch panel 52. However, the touch panel 52 and the LCD 51 do not have to be equal in resolution. While a stylus is usually used for providing input to the touch panel 52, input to the touch panel 52 can be provided not only by the stylus but also by the user's finger. Note that the housing 50 may be provided with an accommodation hole for accommodating the stylus used for performing operations on the touch panel 52. In this manner, the terminal device 7 includes the touch panel 52, and the user can operate the touch panel 52 while moving the terminal device 7. Specifically, the user can provide input directly to the screen of the LCD 51 (from the touch panel 52) while moving the screen.

As shown in FIG. 8, the terminal device 7 includes two analog sticks 53A and 53B and a plurality of buttons 54A to 54L, as operating means. The analog sticks 53A and 53B are devices capable of directing courses. Each of the analog sticks 53A and 53B is configured such that its stick portion to be operated with the user's finger is slidable or tiltable in an arbitrary direction (at an arbitrary angle in any of the up, down, left, right, and oblique directions) with respect to the surface of the housing 50. Moreover, the left analog stick 53A and the right analog stick 53B are provided to the left and the right, respectively, of the screen of the LCD 51. Accordingly, the user can provide an input for course direction using the analog stick with either the left or the right hand. In addition, as shown in FIG. 9, the analog sticks 53A and 53B are positioned so as to allow the user to manipulate them while holding the terminal device 7 at its left and right edges, and therefore the user can readily manipulate the analog sticks 53A and 53B while moving the terminal device 7 by hand.

The buttons 54A to 54L are operating means for providing predetermined input. As will be discussed below, the buttons 54A to 54L are positioned so as to allow the user to manipulate them while holding the terminal device 7 at its left and right edges (see FIG. 9). Therefore the user can readily manipulate the operating means while moving the terminal device 7 by hand.

As shown in FIG. 8(a), of all the operation buttons 54A to 54L, the cross button (direction input button) 54A and the buttons 54B to 54H are provided on the front surface of the housing 50. That is, these buttons 54A to 54G are positioned so as to allow the user to manipulate them with his/her thumbs (see FIG. 9).

The cross button 54A is provided to the left of the LCD 51 and below the left analog stick 53A. That is, the cross button 54A is positioned so as to allow the user to manipulate it with his/her left hand. The cross button 54A is a cross-shaped button which makes it possible to specify at least up, down, left and right directions. Also, the buttons 54B to 54D are provided below the LCD 51. These three buttons 54B to 54D are positioned so as to allow the user to manipulate them with either hand. Moreover, the four buttons 54E to 54H are provided to the right of the LCD 51 and below the right analog stick 53B. That is, the four buttons 54E to 54H are positioned so as to allow the user to manipulate them with the right hand. In addition, the four buttons 54E to 54H are positioned above, to the left of, to the right of, and below the central position among them. Therefore, the four buttons 54E to 54H of the terminal device 7 can be used to function as buttons for allowing the user to specify the up, down, left and right directions.

Furthermore, as shown in FIGS. 8(a), 8(b) and 8(c), the first L button 54I and the first R button 54J are provided at the upper (left and right) corners of the housing 50. Specifically, the first L button 54I is provided at the left edge of the top surface of the plate-like housing 50 so as to be exposed both from the top surface and the left-side surface. The first R button 54J is provided at the right edge of the top surface of the housing 50 so as to be exposed both from the top surface and the right-side surface. Thus, the first L button 54I is positioned so as to allow the user to manipulate it with the left index finger, and the first R button 54J is positioned so as to allow user to manipulate it with the right index finger (see FIG. 9).

Also, as shown in FIGS. 8(b) and 8(c), the second L button 54K and the second R button 54L are positioned at stands 59A and 59B, respectively, which are provided on the back surface of the plate-like housing 50 (i.e., the plane opposite to the surface where the LCD 51 is provided). The second L button 54K is provided at a comparatively high position on the right side of the back surface of the housing 50 (i.e., the left side as viewed from the front surface side), and the second R button 54L is provided at a comparatively high position on the left side of the back surface of the housing 50 (i.e., the right side as viewed from the front surface side). In other words, the second L button 54K is provided at a position approximately opposite to the left analog stick 53A provided on the front surface, and the second R button 54L is provided at a position approximately opposite to the right analog stick 53B provided on the front surface. Thus, the second L button 54K is positioned so as to allow the user to manipulate it with the left middle finger, and the second R button 54L is positioned so as to allow the user to manipulate it with the right middle finger (see FIG. 9). In addition, the second L button 54K and the second R button 54L are provided on the surfaces of the stands 59A and 59B that are directed obliquely upward, as shown in FIG. 8(c), and therefore, the second L button 54K and the second R button 54L have button faces directed obliquely upward. When the user holds the terminal device 7, the middle fingers will probably be able to move in the up/down direction, and therefore the button faces directed upward will allow the user to readily press the second L button 54K and the second R button 54L. Moreover, providing the stands on the back surface of the housing 50 allows the user to readily hold the housing 50, and furthermore, providing the buttons on the stands allows the user to readily manipulate the buttons while holding the housing 50.

Note that the terminal device 7 shown in FIG. 8 has the second L button 54K and the second R button 54L provided at the back surface, and therefore when the terminal device 7 is placed with the screen of the LCD 51 (the front surface of the housing 50) facing up, the screen might not be completely horizontal. Accordingly, in another example embodiment, three or more stands may be formed on the back surface of the housing 50. As a result, when the terminal device 7 is placed on the floor with the screen of the LCD 51 facing upward, all the stands contact the floor, so that the screen can be horizontal. Alternatively, the terminal device 7 may be placed horizontally by adding a detachable stand.

The buttons 54A to 54L are each appropriately assigned a function in accordance with the game program. For example, the cross button 54A and the buttons 54E to 54H may be used for direction-specifying operations, selection operations, etc., whereas the buttons 54B to 54E may be used for setting operations, cancellation operations, etc.

Although not shown in the figures, the terminal device 7 includes a power button for turning ON/OFF the terminal device 7. Moreover, the terminal device 7 may also include buttons for turning ON/OFF the screen of the LCD 51, performing a connection setting (pairing) with the game apparatus 3, and controlling the volume of speakers (speakers 67 shown in FIG. 10).

As shown in FIG. 8(a), the terminal device 7 has a marker section (a marker section 55 shown in FIG. 10), including markers 55A and 55B, provided on the front surface of the housing 50. The marker section 55 is provided in the upper portion of the LCD 51. The markers 55A and 55B are each formed by one or more infrared LEDs, as are the markers 6R and 6L of the marker device 6. The marker section 55 is used for the game apparatus 3 to calculate the movement, etc., of the controller 5, as is the marker device 6 described above. In addition, the game apparatus 3 can control the lighting of the infrared LEDs included in the marker section 55.

The terminal device 7 includes the camera 56 which is an image pickup means. The camera 56 includes an image pickup element (e.g., a CCD image sensor, a CMOS image sensor, or the like) having a predetermined resolution, and a lens. As shown in FIG. 8, in the present example embodiment, the camera 56 is provided on the front surface of the housing 50. Therefore, the camera 56 can pick up an image of the face of the user holding the terminal device 7, and can pick up an image of the user playing a game while viewing the LCD 51, for example.

Note that the terminal device 7 includes a microphone (a microphone 69 shown in FIG. 10) which is a sound input means. A microphone hole 60 is provided in the front surface of the housing 50. The microphone 69 is provided inside the housing 50 behind the microphone hole 60. The microphone detects sounds around the terminal device 7 such as the voice of the user.

The terminal device 7 includes speakers (speakers 67 shown in FIG. 10) which are sound output means. As shown in FIG. 8(d), speaker holes 57 are provided in the bottom surface of the housing 50. Sound emitted by the speakers 67 is outputted from the speaker holes 57. In the present example embodiment, the terminal device 7 includes two speakers, and the speaker holes 57 are provided at positions corresponding to the left and right speakers.

Also, the terminal device 7 includes an expansion connector 58 for connecting another device to the terminal device 7. In the present example embodiment, the expansion connector 58 is provided at the bottom surface of the housing 50, as shown in FIG. 8(d). Any additional device may be connected to the expansion connector 58, including, for example, a game-specific controller (a gun-shaped controller or suchlike) or an input device such as a keyboard. The expansion connector 58 may be omitted if there is no need to connect any additional devices to terminal device 7.

Note that as for the terminal device 7 shown in FIG. 8, the shapes of the operation buttons and the housing 50, the number and arrangement of components, etc., are merely illustrative, and other shapes, numbers, and arrangements may be employed.

Next, an internal configuration of the terminal device 7 will be described with reference to FIG. 10. FIG. 10 is a block diagram illustrating the internal configuration of the terminal device 7. As shown in FIG. 10, in addition to the components shown in FIG. 8, the terminal device 7 includes a touch panel controller 61, a magnetic sensor 62, the acceleration sensor 63, the gyroscope 64, a user interface controller (UI controller) 65, a codec LSI 66, the speakers 67, a sound IC 68, the microphone 69, a wireless module 70, an antenna 71, an infrared communication module 72, flash memory 73, a power supply IC 74, and a battery 75. These electronic components are mounted on an electronic circuit board and accommodated in the housing 50.

The UI controller 65 is a circuit for controlling the input/output of data to/from various input/output sections. The UI controller 65 is connected to the touch panel controller 61, an analog stick section 53 (including the analog sticks 53A and 53B), an operation button group 54 (including the operation buttons 54A to 54L), the marker section 55, the magnetic sensor 62, the acceleration sensor 63, the gyroscope 64. The UI controller 65 is connected to the codec LSI 66 and the expansion connector 58. The power supply IC 74 is connected to the UI controller 65, and power is supplied to various sections via the UI controller 65. The built-in battery 75 is connected to the power supply IC 74 to supply power. A charger 76 or a cable with which power can be obtained from an external power source can be connected to the power supply IC 74 via a charging connector, and the terminal device 7 can be charged with power supplied from an external power source using the charger 76 or the cable. Note that the terminal device 7 can be charged by being placed in an unillustrated cradle having a charging function.

The touch panel controller 61 is a circuit connected to the touch panel 52 for controlling the touch panel 52. The touch panel controller 61 generates touch position data in a predetermined format based on signals from the touch panel 52, and outputs it to the UI controller 65. The touch position data represents, for example, the coordinates of a position on the input surface of the touch panel 52 at which an input has been made. The touch panel controller 61 reads a signal from the touch panel 52 and generates touch position data once per a predetermined period of time. Various control instructions for the touch panel 52 are outputted from the UI controller 65 to the touch panel controller 61.

The analog stick section 53 outputs, to the UI controller 65, stick data representing the direction and the amount of sliding (or tilting) of the stick portion operated with the user's finger. The operation button group 54 outputs, to the UI controller 65, operation button data representing the input status of each of the operation buttons 54A to 54L (regarding whether it has been pressed).

The magnetic sensor 62 detects an azimuthal direction by sensing the magnitude and the direction of a magnetic field. Azimuthal direction data representing the detected azimuthal direction is outputted to the UI controller 65. Control instructions for the magnetic sensor 62 are outputted from the UI controller 65 to the magnetic sensor 62. While there are sensors using, for example, an MI (magnetic impedance) element, a fluxgate sensor, a Hall element, a GMR (giant magnetoresistance) element, a TMR (tunnel magnetoresistance) element, or an AMR (anisotropic magnetoresistance) element, the magnetic sensor 62 may be of any type so long as it is possible to detect the azimuthal direction. Strictly speaking, in a place where there is a magnetic field in addition to the geomagnetic field, the obtained azimuthal direction data does not represent the azimuthal direction. Nevertheless, if the terminal device 7 moves, the azimuthal direction data changes, and it is therefore possible to calculate the change in the attitude of the terminal device 7.

The acceleration sensor 63 is provided inside the housing 50 for detecting the magnitude of linear acceleration along each direction of three axes (the x-, y- and z-axes shown in FIG. 8(a)). Specifically, the acceleration sensor 63 detects the magnitude of linear acceleration along each axis, where the longitudinal direction of the housing 50 is taken as the x-axis, the width direction of the housing 50 as the y-axis, and a direction perpendicular to the front surface of the housing 50 as the z-axis. Acceleration data representing the detected acceleration is outputted to the UI controller 65. Also, control instructions for the acceleration sensor 63 are outputted from the UI controller 65 to the acceleration sensor 63. In the present example embodiment, the acceleration sensor 63 is assumed to be, for example, a capacitive MEMS acceleration sensor, but in another example embodiment, an acceleration sensor of another type may be employed. The acceleration sensor 63 may be an acceleration sensor for detection in one axial direction or two axial directions.

The gyroscope 64 is provided inside the housing 50 for detecting angular rates about the three axes, i.e., the x-, y-, and z-axes. Angular rate data representing the detected angular rates is outputted to the UI controller 65. Also, control instructions for the gyroscope 64 are outputted from the UI controller 65 to the gyroscope 64. Note that any number and combination of gyroscopes may be used for detecting angular rates about the three axes, and similar to the gyroscope 48, the gyroscope 64 may include a two-axis gyroscope and a one-axis gyroscope. Alternatively, the gyroscope 64 may be a gyroscope for detection in one axial direction or two axial directions.

The UI controller 65 outputs operation data to the codec LSI 66, including touch position data, stick data, operation button data, azimuthal direction data, acceleration data, and angular rate data received from various components described above. If another device is connected to the terminal device 7 via the expansion connector 58, data representing an operation performed on that device may be further included in the operation data.

The codec LSI 66 is a circuit for performing a compression process on data to be transmitted to the game apparatus 3, and a decompression process on data transmitted from the game apparatus 3. The LCD 51, the camera 56, the sound IC 68, the wireless module 70, the flash memory 73, and the infrared communication module 72 are connected to the codec LSI 66. The codec LSI 66 includes a CPU 77 and internal memory 78. While the terminal device 7 does not perform any game process itself, the terminal device 7 executes a minimal set of programs for its own management and communication purposes. Upon power-on, the CPU 77 executes a program loaded into the internal memory 78 from the flash memory 73, thereby starting up the terminal device 7. Also, some area of the internal memory 78 is used as VRAM for the LCD 51.

The camera 56 picks up an image in response to an instruction from the game apparatus 3, and outputs data for the pick-up image to the codec LSI 66. Also, control instructions for the camera 56, such as an image pickup instruction, are outputted from the codec LSI 66 to the camera 56. Note that the camera 56 can also record video. Specifically, the camera 56 can repeatedly pick up images and repeatedly output image data to the codec LSI 66.

The sound IC 68 is a circuit connected to the speakers 67 and the microphone 69 for controlling input/output of sound data to/from the speakers 67 and the microphone 69. Specifically, when sound data is received from the codec LSI 66, the sound IC 68 outputs to the speakers 67 a sound signal obtained by performing D/A conversion on the sound data so that sound is outputted from the speakers 67. The microphone 69 senses sound propagated to the terminal device 7 (e.g., the user's voice), and outputs a sound signal representing the sound to the sound IC 68. The sound IC 68 performs A/D conversion on the sound signal from the microphone 69 to output sound data in a predetermined format to the codec LSI 66.

The codec LSI 66 transmits, as terminal operation data, image data from the camera 56, sound data from the microphone 69 and operation data from the UI controller 65 to the game apparatus 3 via the wireless module 70. In the present example embodiment, the codec LSI 66 subjects the image data and the sound data to a compression process as the codec LSI 27 does. The terminal operation data, along with the compressed image data and sound data, is outputted to the wireless module 70 as transmission data. The antenna 71 is connected to the wireless module 70, and the wireless module 70 transmits the transmission data to the game apparatus 3 via the antenna 71. The wireless module 70 has a similar function to that of the terminal communication module 28 of the game apparatus 3. Specifically, the wireless module 70 has a function of connecting to a wireless LAN by a scheme in conformity with the IEEE 802.11n standard, for example. Data to be transmitted may or may not be encrypted depending on the situation.

As described above, the transmission data to be transmitted from the terminal device 7 to the game apparatus 3 includes operation data (terminal operation data), image data, and sound data. In the case where another device is connected to the terminal device 7 via the expansion connector 58, data received from that device may be further included in the transmission data. In addition, the infrared communication module 72 performs infrared communication with another device in accordance with, for example, the IRDA standard. Where appropriate, data received via infrared communication may be included in the transmission data to be transmitted to the game apparatus 3 by the codec LSI 66.

As described above, compressed image data and sound data are transmitted from the game apparatus 3 to the terminal device 7. These data items are received by the codec LSI 66 via the antenna 71 and the wireless module 70. The codec LSI 66 decompresses the received image data and sound data. The decompressed image data is outputted to the LCD 51, and images are displayed on the LCD 51. The decompressed sound data is outputted to the sound IC 68, and the sound IC 68 outputs sound from the speakers 67.

Also, in the case where control data is included in the data received from the game apparatus 3, the codec LSI 66 and the UI controller 65 give control instructions to various sections in accordance with the control data. As described above, the control data is data representing control instructions for the components of the terminal device 7 (in the present example embodiment, the camera 56, the touch panel controller 61, the marker section 55, sensors 62 to 64, and the infrared communication module 72). In the present example embodiment, the control instructions represented by the control data are conceivably instructions to activate or deactivate (suspend) the components. Specifically, any components that are not used in a game may be deactivated in order to reduce power consumption, and in such a case, data from the deactivated components is not included in the transmission data to be transmitted from the terminal device 7 to the game apparatus 3. Note that the marker section 55 is configured by infrared LEDs, and therefore is simply controlled for power supply to be ON/OFF.

While the terminal device 7 includes operating means such as the touch panel 52, the analog sticks 53 and the operation button group 54, as described above, in another example embodiment, other operating means may be included in place of or in addition to these operating means.

Also, while the terminal device 7 includes the magnetic sensor 62, the acceleration sensor 63 and the gyroscope 64 as sensors for calculating the movement of the terminal device 7 (including its position and attitude or changes in its position and attitude), in another example embodiment, only one or two of the sensors may be included. Furthermore, in another example embodiment, any other sensor may be included in place of or in addition to these sensors.

Also, while the terminal device 7 includes the camera 56 and the microphone 69, in another example embodiment, the terminal device 7 may or may not include the camera 56 and the microphone 69 or it may include only one of them.

Also, while the terminal device 7 includes the marker section 55 as a feature for calculating the positional relationship between the terminal device 7 and the controller 5 (e.g., the position and/or the attitude of the terminal device 7 as seen from the controller 5), in another example embodiment, it may not include the marker section 55. Furthermore, in another example embodiment, the terminal device 7 may include another means as the aforementioned feature for calculating the positional relationship. For example, in another example embodiment, the controller 5 may include a marker section, and the terminal device 7 may include an image pickup element. Moreover, in such a case, the marker device 6 may include an image pickup element in place of an infrared LED.

### 5. Outline of the Process in the Game System 1

Next, the game process to be executed in the game system 1 of the present example embodiment will be outlined. Here, in the game system 1, by using the controller 5, it is possible to perform operations (pointing operations) to specify positions on screens of two display devices, the television 2 and the terminal device 7.

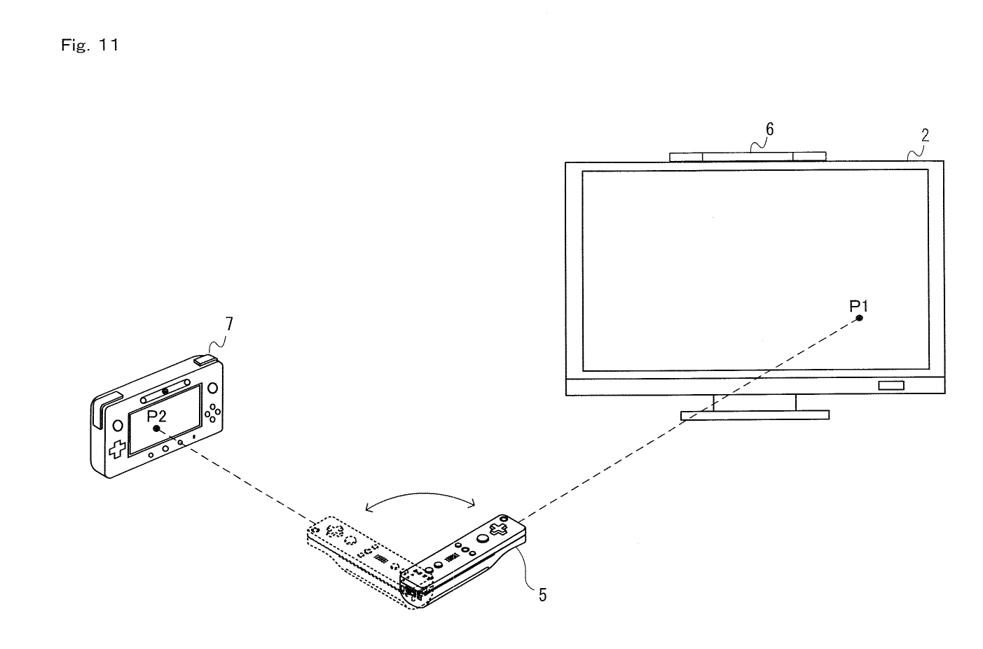

FIG. 11 is a diagram illustrating pointing operations in the present example embodiment. In FIG. 11, the television 2 and the terminal device 7 are placed in different directions as viewed from the player (the controller 5). Here, when the controller 5 is directed toward the television 2, position P₁ specified on the screen of the television 2 is calculated, so that the player can specify the position on the screen of the television 2. On the other hand, when the controller 5 is directed toward the terminal device 7, position P₂ specified on the screen of the terminal device 7 is calculated, so that the player can specify the position on the screen of the terminal device 7. Note that the wording “the controller 5 is directed toward the television 2 (the terminal device 7)” herein refers to the controller 5 being placed such that the television 2 (the terminal device 7) lies in its forward direction (the Z-axis positive direction). In this manner, in the game system 1, the player can perform pointing operations on two display devices, the television 2 and the terminal device 7. In the present example embodiment, the controller 5 can be used for performing pointing operations toward a wider range of directions.

To make it possible to perform pointing operations on two display devices as described above, the game system 1 determines which display device the controller 5 is directed toward, and then performs a process for calculating the position specified on the screen of the display device toward which the controller 5 is directed. Here, the “specified position” refers to a position on the screen of the display device (the television 2 or the terminal device 7) which is specified by the controller 5. The specified position is ideally a position where an imaginary line extending in a predetermined direction (here, the Z-axis positive direction) from the controller 5 crosses the screen. However, in actuality, the game apparatus 3 does not strictly calculate the crossing position, and the specified position changes in accordance with a change in the attitude (direction) of the controller 5. Accordingly, a position close to the crossing position may be calculated as a specified position.

Hereinafter, the method for calculating the specified position will be outlined. In the present example embodiment, a reference attitude is used for calculating the specified position. Therefore, the game apparatus 3 initially performs a process for setting the reference attitude. The reference attitude refers to an attitude of the controller 5 which is directed toward the display device, and is used for determining whether the controller 5 is directed toward the television 2 or the terminal device 7. In the present example embodiment, a reference attitude for the television 2, i.e., a reference attitude where the controller 5 is directed toward the television 2, is referred to as a “first reference attitude”, whereas a reference attitude for the terminal device 7, i.e., a reference attitude where the controller 5 is directed toward the terminal device 7, is referred to as a “second reference attitude”.

(Reference Attitude Setting Process)

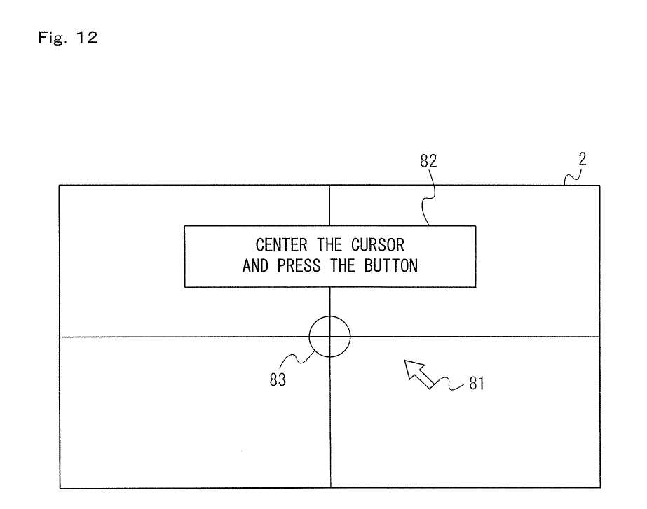

The game apparatus 3 initially sets a first reference attitude. The first reference attitude is set by storing the attitude of the controller 5 being actually directed toward the television 2 by the player. FIG. 12 is a diagram illustrating example images for use in setting the first reference attitude. When the first reference attitude is to be set, as shown in FIG. 12, a cursor 81, a dialog image 82, and a guidance image 83 are displayed on the television 2 as images for use in setting the first reference attitude.

The cursor 81 is a target of operation by the controller 5 and is displayed at the specified position. As will be described in detail later, the specified position for calculating the reference attitude is calculated based on the aforementioned marker coordinate data. Accordingly, when setting the first reference attitude, the marker device 6 is lit up, and the game apparatus 3 calculates the specified position based on an image of the marker device 6 picked up by an image pickup section (the image pickup element 40) of the controller 5. As a result, the position specified by the Z-axis of the controller 5 is calculated as the specified position.

The dialog image 82 is an image for prompting the player to direct the controller 5 toward the television 2, and provides a message such as “CENTER THE CURSOR AND PRESS THE BUTTON”. The guidance image 83 is an image representing an area into which the player should move the cursor 81, typically, an area including the center of the screen.

When calculating the first reference attitude, the player views the dialog image 82 and the guidance image 83, directs the controller 5 toward the guidance image 83, thereby placing the cursor 81 at the position of the guidance image 83, and performs a reference setting operation of pressing a predetermined button (e.g., the A button 32d). Here, the game apparatus 3 consecutively calculates the attitude of the controller 5, and stores an attitude at the time of the reference setting operation as a first reference attitude. As will be described in detail later, the calculation of the attitude of the controller 5 for setting the reference attitude is performed using the aforementioned angular rate data and acceleration data.

After setting the first reference attitude, the game apparatus 3 then sets the second reference attitude. As in the case of setting the first reference attitude, the second reference attitude is set by storing the attitude of the controller 5 which is actually directed toward the terminal device 7 by the player. Specifically, the game apparatus 3 displays the dialog image 82 and the guidance image 83 on the LCD 51 of the terminal device 7. In addition, the marker section 55 is lit up, and a specified position (on the screen of the LCD 51) is calculated based on an image of the marker section 55 picked up by the image pickup section (the image pickup element 40) of the controller 5, so that the cursor 81 is displayed at the specified position. Moreover, the attitude of the controller 5 is consecutively calculated and stores an attitude at the time of the reference setting operation as the second reference attitude.

In the present example embodiment, the reference attitude setting process is performed before the start of the game (specifically, before the game process is performed using the specified position as a game input). The specified position calculation process and the game control process using the specified position are performed after the reference attitudes (the first and second reference attitudes) are set.

(Specified Position Calculation Process)

When calculating the specified position, the game apparatus 3 initially determines whether the controller 5 is directed toward the television 2 or the terminal device 7. The determination is made by comparing the current attitude of the controller 5 with the reference attitudes. Concretely, the game apparatus 3 determines the controller 5 to be directed toward the display device corresponding to one of the reference attitudes that is closer to the current attitude. In this manner, the game apparatus 3 identifies the display device toward which the controller 5 is directed, based on the attitude of the controller 5 and the reference attitudes. In the following, the display device toward which the controller 5 is directed will be referred to as the “target display device”. As will be described in detail later, the attitude of the controller 5 that is used in calculating the specified position is calculated based on the aforementioned angular rate data and acceleration data. Thus, the attitude can be calculated regardless of the state of the controller 5 (even if the controller 5 is in such a state that an image of any marker unit cannot be picked up).

Once the target display device is identified, the game apparatus 3 calculates the specified position based on the current attitude and the reference attitude for the target display device. As will be described in detail later, the specified position is calculated to be a position in accordance with the amount and the direction of change in the current attitude relative to the reference attitude. Accordingly, the player can move the specified position in a direction and an amount corresponding to the change in the attitude of the controller 5.

As described above, in the present example embodiment, the specified position is calculated on the screen of the display device toward which the controller 5 is directed. Here, in the case where two marker units (the marker device 6 and the marker section 55) are not distinguishable from each other, it is not possible to determine the display device toward which the controller 5 is directed (i.e., it is not possible to identify the target display device), simply based on information about marker coordinates. In addition, if the controller 5 has not picked up any marker unit, the attitude of the controller 5 cannot be calculated. On the other hand, in the present example embodiment, information other than the marker coordinates (e.g., information about angular rates) is used to calculate the attitude of the controller 5 and the target display device is identified based on the calculated attitude. This allows the attitude of the controller 5 to be calculated regardless of the state of the controller 5, making it possible to identify the target display device. Thus, in the present example embodiment, it is possible to appropriately determine the display device toward which the controller 5 is directed and calculate the specified position on the screen of the appropriate display device.

Moreover, in the case where the two marker units are distinguishable from each other, the target display device can be identified by identifying whether the marker unit whose image has been picked up by the controller 5 is the marker device 6 or the marker section 55. However, it is generally difficult to accurately recognize and distinguish the pickup image of the marker unit. On the other hand, in the present example embodiment, such a recognition and distinguishing process is dispensable, and the target display device can be identified with high precision based on the attitude of the controller 5.

(Game Process Using the Specified Position)

Next, the game process in the present example embodiment will be outlined. In the present example embodiment, the game process is performed using the specified position as an input. Here, in the present example embodiment, positions on the screens of two display devices can be specified using the controller 5, and therefore novel game operations as shown below are possible.

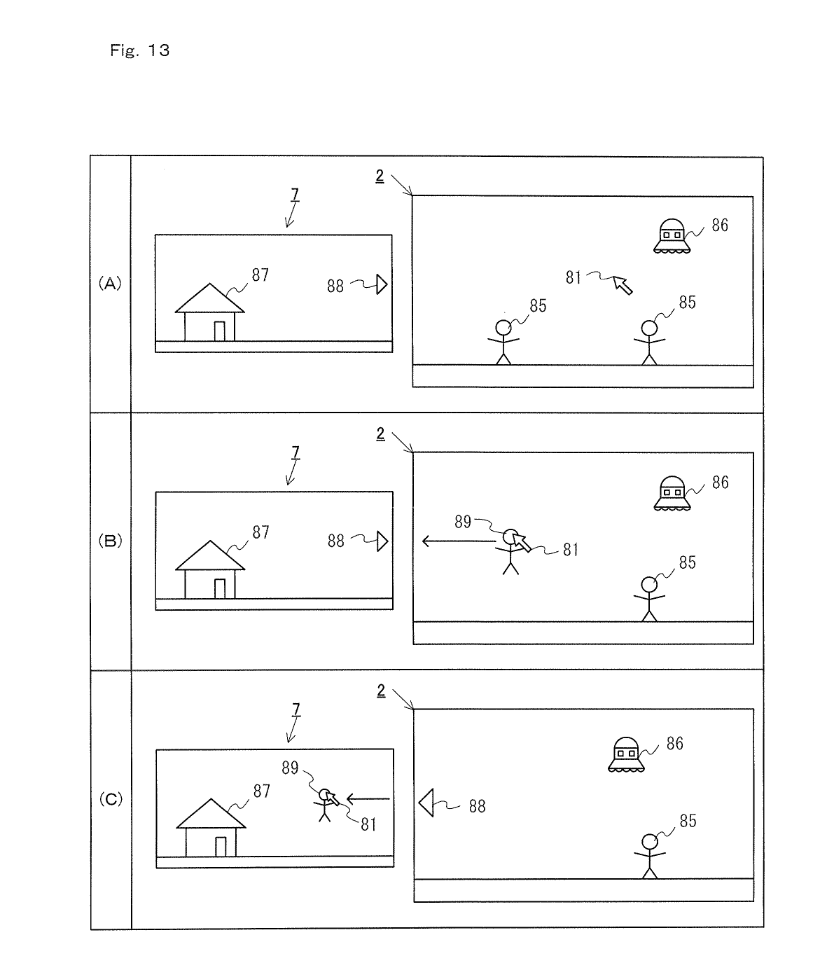

FIG. 13 is a diagram illustrating example game images in the present example embodiment. As shown in FIG. 13, a player object 85, which is a target to be operated by the player, and an enemy object 86, which represents a UFO, are displayed on the television 2. In addition, in the case where the controller 5 is directed toward the television 2, a cursor 81 is displayed at a specified position on the screen of the television 2, as shown in (A) and (B) of FIG. 13. Also, a house-shaped object (house object) 87 is displayed on the terminal device 7. The player object 85 appears on the screen of the television 2 where appropriate. Note that the player is able to move the player object 85 by manipulating the controller 5. On the other hand, the enemy object 86 has its action controlled by the game apparatus 3 to attempt to take the player object 85 away. In the present example embodiment, the game is played to move the player object 85 to the house object 87 for its rescue before the enemy object 86 takes the player object 85 away.

In this game, the player can move the player object 85 using the cursor 81. Concretely, when the player performs a predetermined selection operation with the cursor 81 placed at the position of the player object 85, the player can take hold of the player object 85 with the cursor 81. Specifically, when the selection operation is performed in the aforementioned state, the player object 85 is selected, and the selected player object (referred to as the “selected object”) 89 moves together with the cursor 81 (see (B) in FIG. 13). In addition, the player can lose hold of the selected object 89 by performing a predetermined cancellation operation. That is, when the cancellation operation is performed, the player object 85 is not caused to move together with the cursor 81. Moreover, in this game, the player performs a predetermined shooting operation with the specified position being set on the enemy object 86, thereby defeating (destroying) the enemy object 86.

Also, in the case where the player directs the controller 5 toward the terminal device 7 while holding the selected object 89 in a movable state ((B) in FIG. 13), the selected object 89 is displayed on the terminal device 7 (see (C) in FIG. 13). When the player directs the controller 5 toward the terminal device 7, the specified position is calculated on the screen of the terminal device 7, so that the cursor 81 is displayed on the terminal device 7, along with the selected object 89, which moves together with the cursor 81. Moreover, when a cancellation operation is performed while the cursor 81 and the selected object 89 are being displayed on the terminal device 7, the selected object 89 enters the house object 87 and therefore can be rescued. In this manner, the player plays the game of defeating the enemy object 86 on the screen of the television 2 and moving the player object 85 to the house object 87.

As described above, in the present example embodiment, the player directs the controller 5 toward an object displayed on the television 2, thereby selecting the object, and then changes the direction of the controller 5 to the terminal device 7, thereby moving the selected object to the terminal device 7. That is, in the present example embodiment, the player can readily perform an intuitive operation to move an object displayed on a display device to another display device.

Furthermore, in the present example embodiment, a direction image 88 for indicating the direction pointed by the controller 5 is displayed on a display device on which the cursor 81 is not displayed. Specifically, when the controller 5 is directed toward the television 2 ((A) and (B) in FIG. 13), a direction image 88 pointing rightward is displayed on the terminal device 7. Also, when the controller 5 is directed toward the terminal device 7 ((C) in FIG. 13), a direction image 88 pointing leftward is displayed on the television 2. Although not shown, in the case where the cursor 81 is shown on neither the television 2 nor the terminal device 7, a direction image 88 is displayed on both screens. For example, when the controller 5 is directed upward, a direction image 88 pointing upward is displayed on the screens of the television 2 and the terminal device 7. Displaying the direction image 88 allows the player to perform a pointing operation without losing sight of the position (direction) currently being specified by the controller 5.

### 6. Details of the Game Process

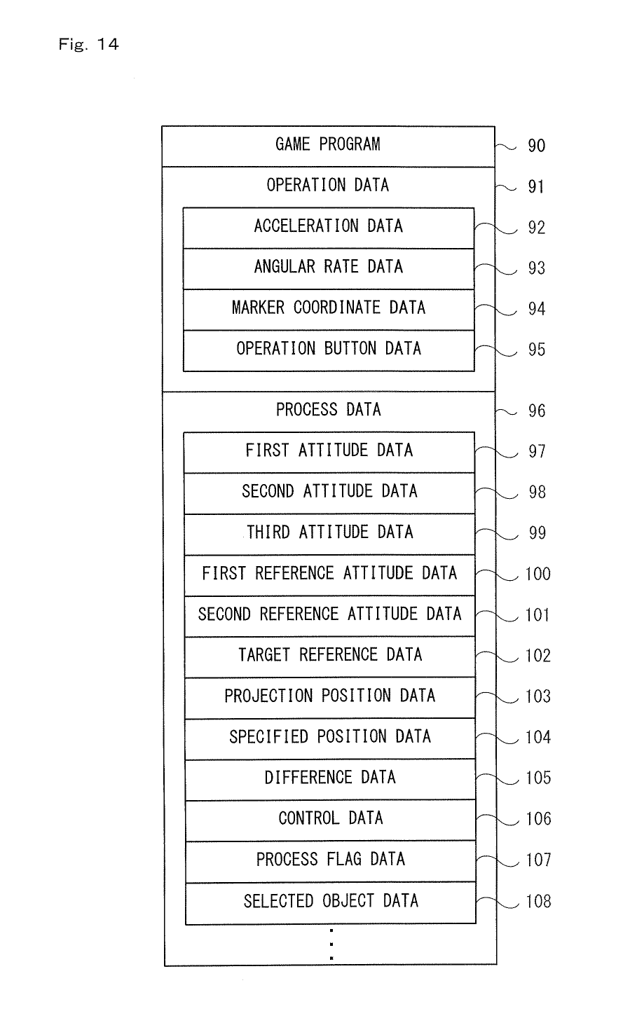

Next, the game process to be executed in the present game system will be described in detail. First, various types of data for use in the game process will be described. FIG. 14 is a diagram illustrating the data for use in the game process. In FIG. 14, main data stored in the main memory (the external main memory 12 or the internal main memory 11e) of the game apparatus 3 is shown. As shown in FIG. 14, the main memory of the game apparatus 3 has stored therein a game program 90, operation data 91, and process data 96. Note that in addition to the data shown in FIG. 14, the main memory has stored therein data to be used in the game such as image data for various objects appearing in the game and sound data.

The game program 90 is partially or entirely read from the optical disc 4 at an appropriate time after the power-on of the game apparatus 3, and then stored to the main memory. Note that the game program 90 may be acquired from the flash memory 17 or a device external to the game apparatus 3 (e.g., via the Internet), rather than from the optical disc 4. Also, a portion of the game program 90 (e.g., a program for calculating the attitude of the controller 5 and/or the attitude of the terminal device 7) may be prestored in the game apparatus 3.

The operation data 91 is data representing the user's operation on the controller 5 (the aforementioned controller operation data). The operation data 91 is transmitted by the controller 5 and then acquired by the game apparatus 3. The operation data 91 includes acceleration data 92, angular rate data 93, marker coordinate data 94, and operation button data 95. Note that the main memory may have stored therein the operation data up to a predetermined number of pieces counted from the latest piece (the last acquired piece).

The acceleration data 92 is data representing acceleration (acceleration vector) detected by the acceleration sensor 37. Here, the acceleration data 92 represents three-dimensional acceleration whose components are acceleration values associated with the directions of three axes, X-, Y-, and Z-axes, shown in FIG. 3, but in another embodiment, the data may represent acceleration associated with any one or more directions.

The angular rate data 93 is data representing angular rates detected by the gyroscope 48. Here, the angular rate data 93 represents angular rates about three axes, X-, Y-, and Z-axes, shown in FIG. 3, but in another embodiment, the data may represent an angular rate about each of any one or more axes.

The marker coordinate data 94 is data representing a coordinate point calculated by the image processing circuit 41 of the imaging information calculation section 35, i.e., the data represents the marker coordinate point. The marker coordinate point is expressed by a two-dimensional coordinate system for representing a position in a plane that corresponds to a pickup image, and the marker coordinate data 94 represents coordinate values in the two-dimensional coordinate system. Note that in the case where the image pickup element 40 picks up images of two markers 55A and 55B in the marker section 55, two marker coordinate points are calculated, and the marker coordinate data 94 represents the two marker coordinate points. On the other hand, in the case where either one of the markers 55A and 55B is not positioned within a range in which the image pickup element 40 can pick up their images, the image pickup element 40 picks up an image of only one of them and only one marker coordinate point is calculated. As a result, the marker coordinate data 94 represents one marker coordinate point. Furthermore, in the case where neither the marker 55A nor 55B is positioned within a range in which the image pickup element 40 can pick up their images, the image pickup element 40 picks up no images and therefore no marker coordinate point is calculated. In this manner, the marker coordinate data 94 may represent two marker coordinate points, one marker coordinate point, or no marker coordinate point.

Note that in place of the marker coordinate data, pickup image data itself may be transmitted from the controller 5 to the game apparatus 3. Specifically, the controller 5 may transmit marker coordinate data as imaging data related to an image picked up by an imaging device (the image pickup element 40) or may transmit image data itself. Upon reception of the pickup image data from the controller 5, the game apparatus 3 may calculate the marker coordinate point based on the pickup image data, and may store the calculated marker coordinate point to the main memory as marker coordinate data.

The acceleration data 92, the angular rate data 93, and the marker coordinate data 94 are data items corresponding to the attitude of the controller 5 (i.e., the values of the data items change in accordance with the attitude). As will be described in detail later, the attitude of the controller 5 can be calculated based on the data items 92 to 94. Note that in another example embodiment, in addition to (or in place of) the data items 92 to 94, other data corresponding to the attitude of the controller 5, which includes, for example, azimuthal direction data representing an azimuthal direction detected by the magnetic sensor, is used to calculate the attitude of the controller 5.

The operation button data 95 is data representing an input state of each of the operation buttons 32a to 32i provided on the controller 5.

Note that the operation data 91 may include only part of the data items 92 to 95 so long as the operation by the player using the controller 5 can be represented. Also, when the controller 5 includes other input means (e.g., a touch panel, an analog stick, etc.), the operation data 91 may include data representing operations on those other input means.

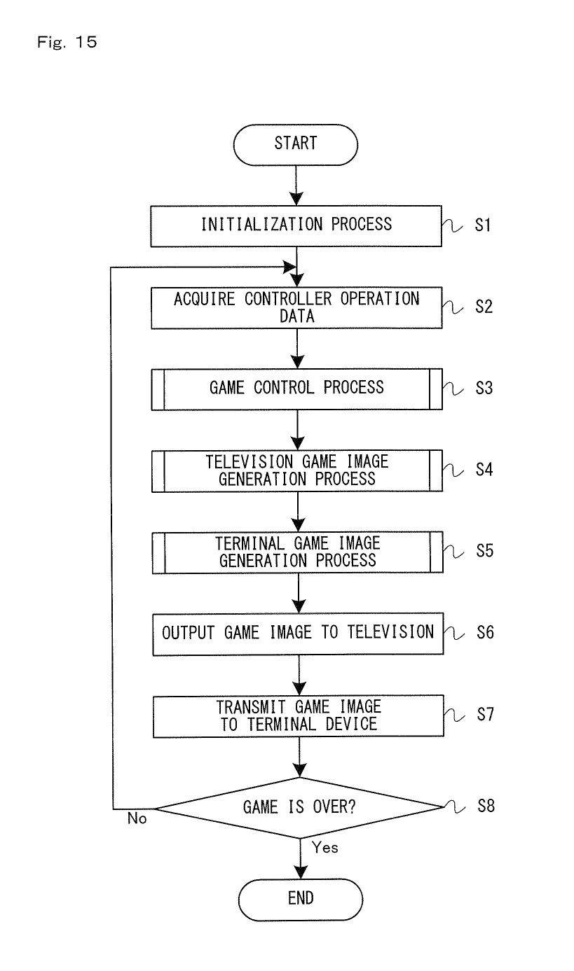

The process data 96 is data to be used in the game process to be described later (FIG. 15). The process data 96 includes first attitude data 97, second attitude data 98, third attitude data 99, first reference attitude data 100, second reference attitude data 101, target reference data 102, projection position data 103, specified position data 104, difference data 105, control data 106, process flag data 107, and selected object data 108. Note that in addition to the data shown in FIG. 14, the process data 96 includes various types of data to be used in the game process, e.g., data representing various parameters being set for various objects (e.g., parameters related to the player object and the enemy object).

The first attitude data 97 is data representing an attitude of the controller 5 which is calculated based on the angular rate data 93 (hereinafter, referred to as a “first attitude”). The second attitude data 98 is data representing an attitude of the controller 5 which is calculated based on the acceleration data 92 (hereinafter, referred to as a “second attitude”). The third attitude data 99 is data representing an attitude of the controller 5 which is calculated based on the marker coordinate data 94 (hereinafter, referred to as a “third attitude”). As will be described in detail later, in the present example embodiment, the final attitude of the controller 5 is calculated based on the three attitudes, which are calculated by different methods. The final attitude of the controller 5 is represented by a post-correction first attitude obtained by correcting the first attitude using the second attitude and the third attitude.

Here, in the present example embodiment, the first attitude of the controller 5 is expressed by 3×3 matrix M1 shown in the following expression (1).

$$M 1 = [ \begin{matrix}Xx & Yx & Zx \\ Xy & Yy & Zy \\ Xz & Yz & Zz\end{matrix} ] \qquad ( 1 )$$

Matrix M1 is a rotation matrix representing a rotation from a predetermined attitude to the attitude of the current controller 5. Note that the first attitude represented by matrix M1 is an attitude represented in a spatial coordinate system which is set in the space where the controller 5 is present, the attitude being obtained with respect to a difference from the aforementioned predetermined attitude in that space. Note that in the present example embodiment, to simplify calculation, the spatial coordinate system is set in a first reference setting process (step S12) to be described later, such that the first reference attitude is expressed by an identity matrix. Specifically, the predetermined attitude is the first reference attitude. Note that in the present example embodiment, the attitude of the controller 5 is expressed using the matrix, but in another example embodiment, the attitude of the controller 5 may be expressed by a three-dimensional vector or three angles.

The first reference attitude data 100 is data representing the aforementioned first reference attitude. Also, the second reference attitude data 101 is data representing the aforementioned second reference attitude. In this manner, the reference attitude for each display device is stored in the main memory. Note that in the present example embodiment, as with the first attitude, each of the reference attitudes is expressed by a 3×3 matrix. In addition, as described above, the first reference attitude is expressed by an identity matrix.

The target reference data 102 represents one of the reference attitudes that corresponds to a display device toward which the target display device, i.e., the controller 5, is directed (such a reference attitude being referred to as a “target reference attitude”). The target reference data 102 is data representing which display device the controller 5 is directed toward.

The projection position data 103 is data representing a projection position to be described later. As will be described in detail later, the projection position is calculated based on the attitude of the controller 5 and the reference attitude, and is used for calculating the specified position. Furthermore, the projection position is a position in a plane corresponding to the screen of the display device and provides information about the amount and the direction of change in the current attitude with respect to the reference attitude.

The specified position data 104 is data representing the aforementioned specified position. Concretely, the specified position data 104 represents two-dimensional coordinates indicating a position in a plane corresponding to the screen of the television 2 or the terminal device 7.

The difference data 105 is data representing the difference between the first reference attitude and the second reference attitude. In the present example embodiment, the game process is performed differently in accordance with the difference represented by the difference data 105. Specifically, in the present example embodiment, the difference between the first reference attitude and the second reference attitude is reflected in the content of the game (concretely, the difficulty of the game).

The control data 106 is data representing a control instruction for a component included in the terminal device 7. In the present example embodiment, the control data 106 includes an instruction to control lighting of the marker section 55. The control data 106 is transmitted from the game apparatus 3 to the terminal device 7 at an appropriate time.

The process flag data 107 indicates the value of a process flag for determining the progress of the game process.

Concretely, the process flag takes a value of “0” where no reference attitude is set, “1” where the first reference attitude is set but the second reference attitude is not set, or “2” where both reference attitudes are set.

The selected object data 108 indicates a selected object and its position. In addition, in the case where no object is selected, the selected object data 108 indicates such.

Next, the process to be performed by the game apparatus 3 will be described in detail with reference to FIGS. 15 to 26. FIG. 15 is a main flowchart showing a flow of the process to be performed by the game apparatus 3. When the game apparatus 3 is powered on, the CPU 10 of the game apparatus 3 executes a boot program stored in an unillustrated boot ROM, thereby initializing each unit, including the main memory. The game program stored in the optical disc 4 is loaded to the main memory, and the CPU 10 starts executing the game program. Note that the game apparatus 3 may be configured such that the game program is executed immediately after the power-on or such that an internal program for displaying a predetermined menu screen is initially executed after the power-on and then the game program is executed when the user provides an instruction to start the game. The flowchart shown in FIG. 15 illustrates a process to be performed when the processes described above are completed.

Note that processing in each step of the flowcharts shown in FIGS. 15 to 20 and 24 to 26 is merely illustrative, and if similar results can be achieved, the processing order of the steps may be changed. In addition, values of variables and thresholds to be used in determination steps are also merely illustrative, and other values may be used appropriately. Furthermore, while the present example embodiment is described on the premise that the CPU 10 performs processing in each step of the flowcharts, part of the steps in the flowcharts may be performed by a processor other than the CPU 10 or by specialized circuits.

First, in step S1, the CPU 10 performs an initialization process. The initialization process is, for example, a process of constructing a virtual game space, placing objects appearing in the game space at their initial positions, and setting initial values of various parameters to be used in the game process. Note that in the initialization process of the present example embodiment, data items representing predetermined initial values (e.g., identity matrices) of the reference attitudes are stored to the main memory as reference attitude data 100 and 101. In addition, data indicating “0” is stored to the main memory as process flag data 107. Following step S1, the process of step S2 is performed. Thereafter, a process loop including a series of processing in steps S2 to S8 is repeatedly performed once per a predetermined period of time (e.g., one frame period).

In step S2, the CPU 10 acquires operation data from the controller 5. Here, the controller 5 repeats transmitting data originally outputted from the acceleration sensor 37, the gyroscope 48, the imaging information calculation section 35 and the operating section 32, to the game apparatus 3 as operation data. The game apparatus 3 sequentially receives the data from the controller 5 and stores the received data to the main memory as operation data 91. In step S2, the CPU 10 reads the latest operation data 91 from the main memory. Following step S2, the process of step S3 is performed.

Note that in the present example embodiment, the terminal device 7 is not used as an operating device, and therefore the following description will be given on the premise that the CPU 10 does not acquire the terminal operation data from the terminal device 7. However, in another example embodiment, the CPU 10 in step S2 may acquire and store terminal operation data to the main memory, and may use the terminal operation data in a game control process to be described later.

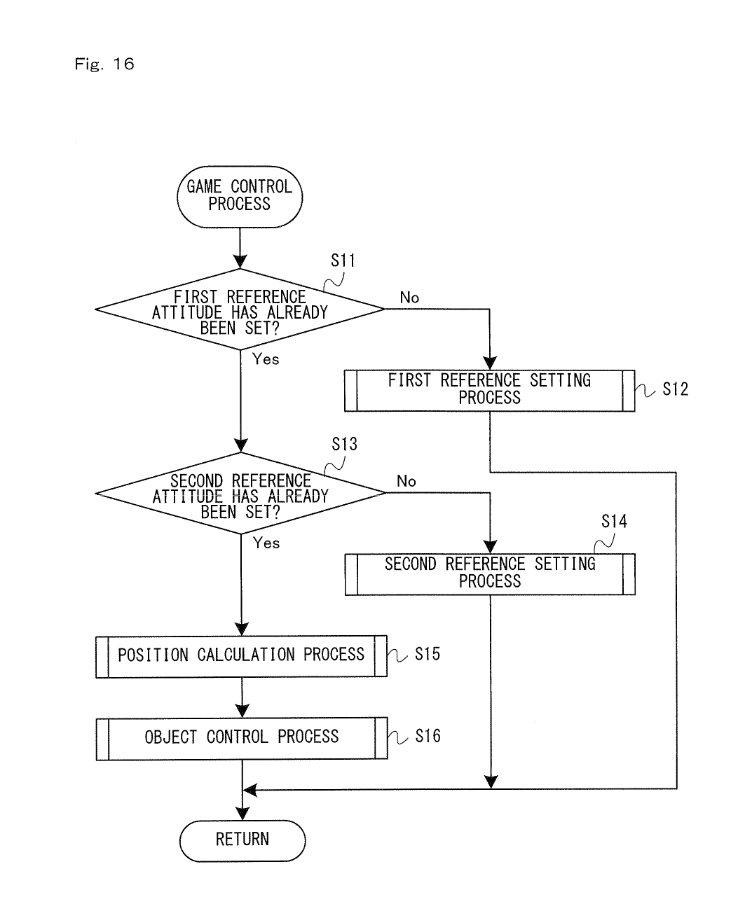

In step S3, the CPU 10 performs a game control process. The game control process is a process for causing the game to progress by performing, for example, the processing of moving objects in the game space in accordance with the players' game operations. Concretely, in the game control process of the present example embodiment, for example, reference attitudes are set, a specified position is calculated based on the operation data 91, and an object is caused to take action based on the specified position. Hereinafter, referring to FIG. 16, the game control process will be described in detail.

FIG. 16 is a flowchart illustrating a detailed flow of the game control process (step S3) shown in FIG. 15. In the game control process, the CPU 10 initially in step S11 determines whether the first reference attitude has already been set.

Concretely, the process flag data 107 is read from the main memory to determine whether the value of the process flag is other than “0” (i.e., “1” or “2”). When the determination result of step S11 is affirmative, the process of step S13 is performed. On the other hand, when the determination result of step S11 is negative, the process of step S12 is performed.

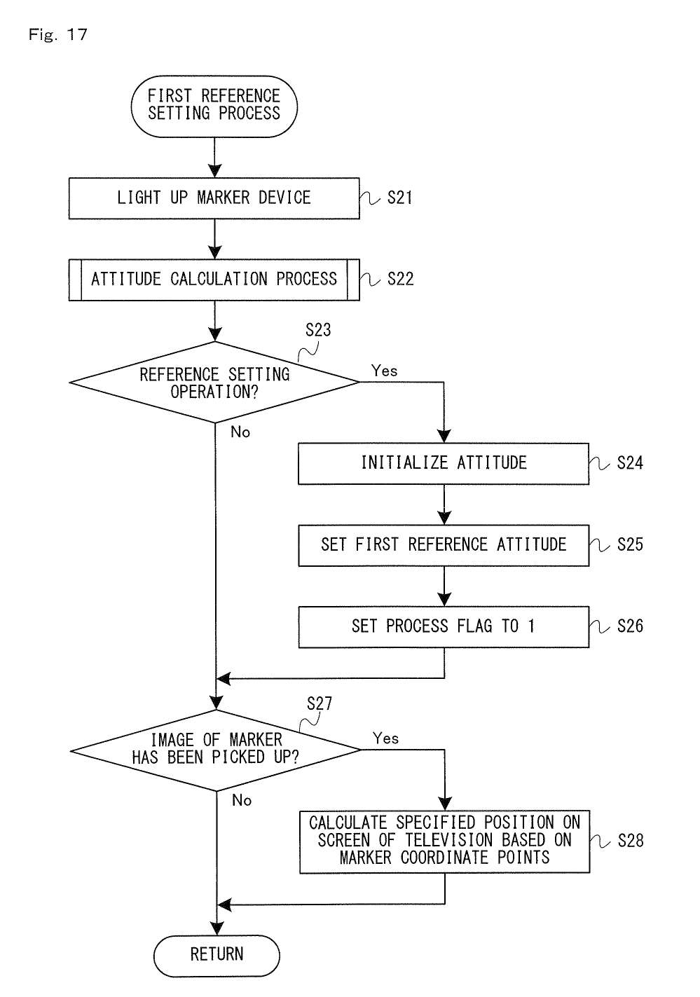

In step S12, the CPU 10 performs a first reference setting process to set the first reference attitude. In the present example embodiment, the first reference setting process is initially performed at the start of the game process shown in FIG. 15, thereby setting the first reference attitude. Hereinafter, referring to FIG. 17, the first reference setting process will be described in detail.

FIG. 17 is a flowchart illustrating a detailed flow of the first reference setting process (step S12) shown in FIG. 16.

In the first reference setting process, the CPU 10 initially in step S21 lights up the marker device 6, which is a marker unit corresponding to the television 2. Specifically, the CPU 10 transmits to the marker device 6 a control signal to light up the infrared LEDs included in the marker device 6. The transmission of the control signal may be simply power supply. In response, the marker device 6 lights up the infrared LEDs. Note that in the first reference setting process, the marker section 55 of the terminal device 7 is not lit up. The reason for this is that, if the marker section 55 is lit up, the marker section 55 might be erroneously detected as the marker device 6. Following step S21, the process of step S22 is performed.

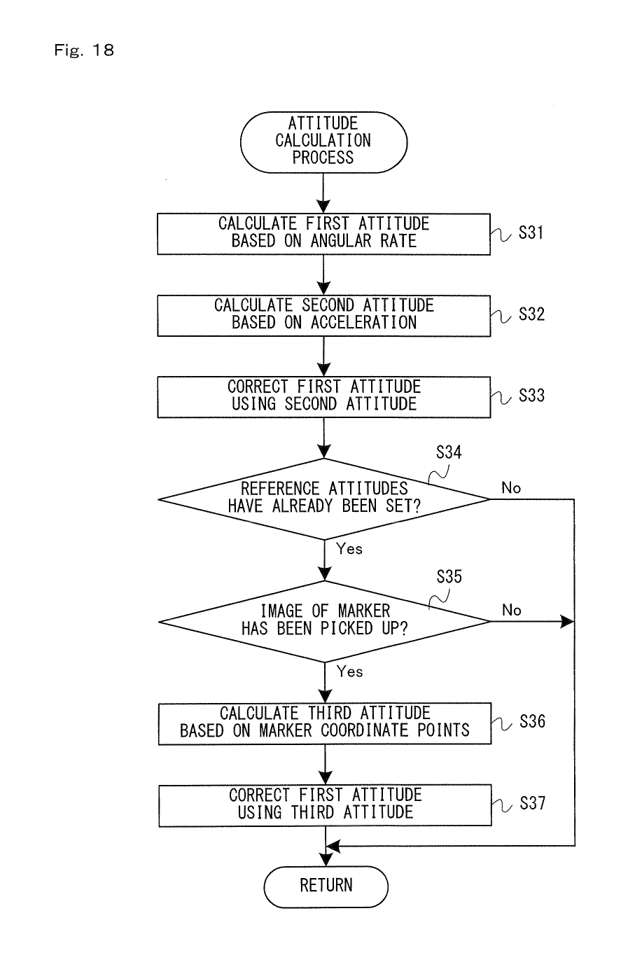

In step S22, the CPU 10 performs an attitude calculation process to calculate the attitude of the controller 5. The attitude of the controller 5 can be calculated by any method so long as it is calculated based on the operation data 91, and in the present example embodiment, the attitude of the controller 5 is calculated by correcting the first attitude, which is obtained based on an angular rate, using the second attitude and the third attitude, which are obtained based on acceleration and a marker coordinate point, respectively. Note that the program for performing the attitude calculation process may be prestored in the game apparatus 3 as a library independently of the game program 90. Hereinafter, referring to FIG. 18, the attitude calculation process will be described in detail.

FIG. 18 is a flowchart illustrating a detailed flow of the attitude calculation process (step S22) shown in FIG. 17. In the attitude calculation process, the CPU 10 initially in step S31 calculates the first attitude of the controller 5 based on the angular rate of the controller 5. The first attitude of the controller 5 can be calculated by any method, and in the present example embodiment, the first attitude is calculated using the last first attitude (the last calculated first attitude) and the current angular rate (the angular rate acquired by step S2 of the current process loop). Concretely, the CPU 10 calculates a new first attitude by rotating the last first attitude at the current angular rate for a unit time. Note that the last first attitude is represented by the first attitude data 97 stored in the main memory, and the current angular rate is indicated by the angular rate data 93 stored in the main memory. Accordingly, the CPU 10 reads the first attitude data 97 and the angular rate data 93 from the main memory, and calculates the first attitude of the controller 5. Data representing first attitude calculated in step S31 is stored to the main memory as new first attitude data 97. Following step S31, the process of step S32 is performed.

Note that in the case where the attitude is calculated based on the angular rate, it is desirable to set an initial attitude. Specifically, in the case where the attitude of the controller 5 is calculated based on the angular rate, the CPU 10 initially calculates an initial attitude of the controller 5. The initial attitude of the controller 5 may be calculated based on acceleration data. Alternatively, with the controller 5 being set in a specific attitude, the player may perform a predetermined operation, so that the specific attitude at the time of the predetermined operation is used as the initial attitude. Note that in the case where the attitude of the controller 5 is calculated as an absolute attitude with respect to a predetermined attitude in the space where the controller 5 is located, the initial attitude may be calculated, but in the case, for example, where the attitude of the controller 5 is calculated as a relative attitude with respect to the attitude of the controller 5 at a predetermined time such as the beginning of the game, the initial attitude is not calculated. In the present example embodiment, since the initial attitude is set again by setting the first reference attitude, an arbitrary attitude may be set as the initial attitude before the first reference attitude is set.

In step S32, the CPU 10 calculates a second attitude of the controller 5 based on acceleration on the controller 5. Concretely, the CPU 10 reads the acceleration data 92 from the main memory, and calculates the attitude of the controller 5 based on the acceleration data 92. Here, when the controller 5 is in almost static state, the acceleration applied to the controller 5 corresponds to gravitational acceleration. Accordingly, in this state, the direction (attitude) of the controller 5 with respect to the direction of detected gravitational acceleration (the direction of gravity) can be calculated based on the acceleration data 92. In this manner, in the situation where the acceleration sensor 37 detects the gravitational acceleration, the attitude of the controller 5 with respect to the direction of gravity can be calculated based on the acceleration data 92. Data representing the attitude thus calculated is stored to the main memory as second attitude data 98. Following step S32, the process of step S33 is performed.

In step S33, the CPU 10 corrects the first attitude, which is based on the angular rate, using the second attitude, which is based on acceleration. Concretely, the CPU 10 reads the first attitude data 97 and the second attitude data 98 from the main memory, and performs a correction to cause the first attitude to approach the second attitude at a predetermined rate. The predetermined rate may be a predetermined constant or may be set in accordance with, for example, detected acceleration. Note that the second attitude is an attitude represented with respect to the direction of gravity, and therefore in the case where the first attitude is an attitude represented with respect to another direction, one of the attitudes is converted to an attitude represented with respect to the other attitude before correction is performed. Here, to convert the second attitude to an attitude represented with respect to the first attitude, a vector representing the second attitude is rotated using the rotation matrix expressing the first attitude, which is obtained in the previous frame process (the processing in steps S2 to S8). In addition, the second attitude cannot be calculated for the direction of rotation about an axis in the direction of gravity, and therefore is not corrected for that direction of rotation.

Note that in the correction process of step S33, the rate of correction may be changed in accordance with the degree of reliability of the acceleration detected by the acceleration sensor 37 as representation of the direction of gravity. Here, whether the detected acceleration is reliable or not, i.e., whether the controller 5 is in a static state, can be estimated by whether the magnitude of the acceleration is close to the magnitude of gravitational acceleration or not. Accordingly, for example, the CPU 10 may increase the rate at which to cause the first attitude to approach the second attitude when the magnitude of the detected acceleration is close to the magnitude of gravitational acceleration or may decrease such a rate when the magnitude of the detected acceleration is distant from the magnitude of gravitational acceleration. Data representing the post-correction attitude thus obtained is stored to the main memory as new first attitude data 97. Following step S33, the process of step S34 is performed.

In step S34, the CPU 10 determines whether the reference attitudes have already been set. Concretely, the CPU 10 reads the process flag data 107 from the main memory, and determines whether the value of the process flag is “2”. When the determination result of step S34 is affirmative, the process of step S35 is performed. On the other hand, when the determination result of step S34 is negative, the processes of steps S35 to S37 are skipped, and the CPU 10 ends the attitude calculation process.

As described above, in the present example embodiment, the correction process using the third attitude based on the marker coordinate point (steps S35 to S37) is not performed during the reference setting process (step S12 or step S14 to be described later). Specifically, in the reference setting process, the attitude of the controller 5 is calculated based on the angular rate data 93 and the acceleration data 92. Note that in the first reference setting process, an attitude initialization process (step S24 to be described later) is performed when setting the first reference attitude, and thereafter, an attitude is calculated with respect to the first reference attitude. Accordingly, correction is not made using the third attitude to be calculated with respect to an attitude different from the first reference attitude, and therefore the processes of steps S35 to S37 are not performed in the first reference setting process. Note that in another example embodiment, when the initialization process is not performed, the CPU 10 may perform the correction process using the third attitude during the reference setting process.

In step S35, the CPU 10 determines whether an image of the marker unit has been picked up by the image pickup means (the image pickup element 40) of the controller 5. The determination of step S35 can be made by referencing the marker coordinate data 94 stored in the main memory. Here, an image of the marker unit is determined to have been picked up when the marker coordinate data 94 indicates two marker coordinate points, and no image is determined to have been picked up when the marker coordinate data 94 indicates only one or no marker coordinate point. When the determination result of step S35 is affirmative, the processes of steps S36 and S37 that follow are performed. On the other hand, when the determination result of step S35 is negative, the processes of steps S36 and S37 are skipped, and the CPU 10 ends the attitude calculation process. In this manner, when no image of the marker unit is picked up by the image pickup element 40, the attitude (third attitude) of the controller 5 cannot be calculated using data to be acquired from the image pickup element 40, and therefore, in this case, no correction using the third attitude is performed.

Note that in another example embodiment, when the controller 5 is assumed to be not placed below (on the floor) or above (on the ceiling) the player, the CPU 10 in step S35 may further determine whether the front direction (Z-axis positive direction) of the controller 5 is vertical. If it is determined to be vertical, then the CPU 10 determines that no image of the marker unit has been picked up by the image pickup means of the controller 5. Note that the determination as to whether the front direction of the controller 5 is vertical is made using the first attitude calculated in step S31, the second attitude calculated in step S32, or the first attitude corrected in step S33. As a result, even if the imaging information calculation section 35 erroneously recognizes something other than the marker unit as the marker unit and calculates marker coordinate points, the third attitude is not calculated based on these erroneous marker coordinate points, and therefore the attitude of the controller 5 can be calculated with higher precision.

In step S36, the CPU 10 calculates the third attitude of the controller 5 based on the marker coordinate points. The marker coordinate points indicate the positions of two markers (the markers 6L and 6R or the markers 55A and 55B) in a pickup image, and therefore, the attitude of the controller 5 can be calculated based on these positions. Hereinafter, the method for calculating the attitude of the controller 5 based on marker coordinate points will be described. Note that the roll, yaw, and pitch directions as mentioned below refer to the directions of rotation about the Z-, Y-, and X-axes, respectively, of the controller 5 in a state (reference state) in which the imaging direction (Z-axis positive direction) of the controller 5 points at the marker unit.

First, the attitude can be calculated for the roll direction (the direction of rotation about the Z-axis) based on the slope of a straight line extending between the positions of two marker coordinate points in a pickup image. Specifically, when calculating an attitude in the roll direction, the CPU 10 initially calculates a vector extending between two marker coordinate points. The direction of the vector changes in accordance with the rotation of the controller 5 in the roll direction, and therefore, the CPU 10 can calculate the attitude in the roll direction based on the vector. For example, the attitude for the roll direction may be calculated as a rotation matrix for rotating a vector for a predetermined attitude to the current vector or as an angle between the vector for a predetermined attitude and the current vector.

In addition, in the case where the position of the controller 5 is assumed to be approximately constant, the attitude of the controller 5 can be calculated for both the pitch direction (the direction of rotation about the X-axis) and the yaw direction (the direction of rotation about the Y-axis) based on the positions of marker coordinate points in a pickup image. Concretely, the CPU 10 initially calculates the position of a midpoint between two marker coordinate points. That is, in the present example embodiment, the position of the midpoint is used as the position of the marker unit in a pickup image. Next, the CPU 10 performs a correction to rotate the midpoint about the center of the pickup image by an angle of rotation for the roll direction of the controller 5 (in a direction opposite to the direction of rotation of the controller 5). In other words, the midpoint is rotated about the center of the pickup image such that the vector is directed horizontally.

Based on the post-correction midpoint position thus obtained, the attitude of the controller 5 can be calculated for both the yaw direction and the pitch direction. Specifically, in the reference state, the post-correction midpoint position coincides with the center of the pickup image. Furthermore, the post-correction midpoint position moves from the center of the pickup image a distance corresponding to the amount of change in the attitude of the controller 5 from the reference state in a direction opposite to the direction of the change in the attitude. Therefore, the direction and the amount (angle) of the change in the attitude of the controller 5 from the reference state are calculated based on the direction and the amount of change in the post-correction midpoint position with respect to the center of the pickup image. In addition, the yaw direction and the pitch direction of the controller 5 correspond to the horizontal direction and the vertical direction, respectively, of the pickup image, and therefore the attitudes for the yaw direction and the pitch direction can be calculated independently of each other.

Note that in the case of the game system 1, the player can take various positions (e.g., standing or sitting) to play the game or the player can place the marker unit in various positions (e.g., on top of or under the television 2), and therefore the assumption that the position of the controller 5 is approximately constant might not be valid for the vertical direction. That is, in the present example embodiment, the third attitude could not be calculated correctly for the pitch direction, and therefore the CPU 10 does not calculate the third attitude for the pitch direction.

In this manner, the CPU 10 in step S36 reads the marker coordinate data 94 from the main memory, and calculates the attitudes for the roll direction and the yaw direction based on two marker coordinate points. Note that in the case where each of the attitudes for the aforementioned directions is calculated as, for example, a rotation matrix, the third attitude can be obtained by integrating the rotation matrices corresponding to the directions. Data representing the calculated third attitude is stored to the main memory as third attitude data 99. Following step S36, the process of step S37 is performed.

Note that in the present example embodiment, the CPU 10 calculates the attitudes for the roll direction and the yaw direction based on marker coordinate points, and the same attitude as the first attitude is used for the pitch direction. That is, the attitude correction process using marker coordinate points is not performed for the pitch direction. However, in another example embodiment, the CPU 10 may calculate the attitude for the pitch direction based on marker coordinate points in the same manner as the attitude for the yaw direction, and an attitude correction process using marker coordinate points may be performed for the pitch direction.

In step S37, the CPU 10 corrects the first attitude, which is based on an angular rate, using the third attitude, which is based on marker coordinate points. Concretely, the CPU 10 reads the first attitude data 97 and the third attitude data 99 from the main memory, and performs a correction to cause the first attitude to approach the third attitude at a predetermined rate. The predetermined rate is, for example, a predetermined constant. In addition, the first attitude to be corrected is the first attitude subjected to the correction using the second attitude by the process of step S33. Data representing the post-correction attitude thus obtained is stored to the main memory as new first attitude data 97. The first attitude data 97 subjected to the correction process of step S37 is used in subsequent processes as the attitude of the final controller 5. Upon completion of step S37, the CPU 10 ends the attitude calculation process.

In the attitude calculation process, the CPU 10 corrects the first attitude of the controller 5, which is calculated based on the angular rate data 93, using the acceleration data 92 (and the marker coordinate data 94). Here, among other methods for calculating the attitude of the controller 5, the method using an angular rate makes it possible to calculate the attitude however the controller 5 is moving. On the other hand, the method using an angular rate calculates the attitude by cumulatively adding angular rates that are sequentially detected, and therefore there is a possibility of poor accuracy due to, for example, error accumulation or poor accuracy of the gyroscope 48 due to a so-called temperature drift problem. Also, the method using acceleration does not cause error accumulation, but when the controller 5 is being moved vigorously, the attitude cannot be calculated with accuracy (because the direction of gravity cannot be detected with precision). In addition, the method using marker coordinate points can calculate the attitude (particularly for the roll direction) with accuracy, but cannot calculate the attitude where an image of the marker unit cannot be picked up. On the other hand, in the present example embodiment, the aforementioned three characteristically different methods are used, and therefore the attitude of the controller 5 can be calculated with higher precision. Note that in another example embodiment, the attitude may be calculated using one or two of the three methods.

Returning to the description of FIG. 17, the process of step S23 is performed after the attitude calculation process. Specifically, in step S23, the CPU 10 determines whether the reference setting operation has been performed or not. The reference setting operation is an operation for instructing to set the attitude of the controller 5 at the time of manipulation as a reference attitude, and this operation is performed by pressing a predetermined button, e.g., the A button 32d. Concretely, the CPU 10 references the operation button data 95 being read from the main memory to determine whether the predetermined button has been pressed. When the determination result of step S23 is affirmative, the process of step S24 is performed. On the other hand, when the determination result of step S23 is negative, the processes of steps S24 to S26 are skipped, and the process of step S27 is performed.

In step S24, the CPU 10 initializes the attitude of the controller 5. Specifically, the spatial coordinate system for representing the attitude of the controller 5 is changed such that the attitude of the current controller 5 is represented as an identity matrix. Concretely, the CPU 10 changes the settings of the program (library) for performing the attitude calculation process (steps S22, S42, and S52) as described above. Accordingly, after the first reference attitude is set, the attitude of the controller 5 is calculated to be a value represented with respect to the first reference attitude (in such a coordinate system as to represent the first reference attitude as an identity matrix). Following step S24, the process of step S25 is performed.

In step S25, the CPU 10 sets the current attitude of the controller 5 as the first reference attitude. Specifically, the CPU 10 stores data representing the current attitude of the controller 5 to the main memory as first reference attitude data 100. In the present example embodiment, the attitude of the controller 5 is initialized by the process of step S24, and therefore the first reference attitude data 100 is data representing an identity matrix. Following step S25, the process of step S26 is performed.

In the present example embodiment, the coordinate system for representing the attitude of the controller 5 is changed as in steps S24 and S25, whereby the first reference attitude is always represented as an identity matrix. Here, in another example embodiment, the process of step S24 does not have to be performed. Specifically, the attitude of the controller 5 may be calculated in such a coordinate system where an attitude other than the first reference attitude is represented as an identity matrix. In this case, the attitude (first attitude data 97) calculated in step S22 is stored to the main memory as first reference attitude data 100 in step S25.

In step S26, the CPU 10 sets the value of the process flag to “1”. Specifically, the process flag data 107 is updated to indicate “1”. As a result, in the next process loop of steps S2 to S8 to be performed, a second reference setting process is performed. Following step S26, the process of step S27 is performed.

In step S27, the CPU 10 determines whether or not an image of the marker device 6 has been picked up by the image pickup means (image pickup element 40) of the controller 5. The process of step S27 is the same as that of step S35 described above. When the determination result of step S27 is affirmative, the process of step S28 is performed. On the other hand, when the determination result of step S27 is negative, the process of step S28 is skipped, and the CPU 10 ends the first reference setting process.

In step S28, the CPU 10 calculates a specified position on the screen of the television 2 based on marker coordinate points. Here, the direction of the marker device 6 (the television 2) as viewed from the position of the controller 5 can be known from the marker coordinate points, and therefore the position (the specified position) on the screen of the television 2 specified by the controller 5 can be calculated based on the marker coordinate points. While any method can be employed for calculating the specified position based on the marker coordinate points, for example, the specified position can be calculated using the post-correction midpoint position as used in step S37 above. Concretely, the specified position can be calculated based on the direction and the amount of change in the midpoint position from a predetermined position within the pickup image. More specifically, the specified position can be calculated as a position obtained by moving a point at the center of the pickup image a distance corresponding to the amount as mentioned above in a direction opposite to the direction of the change. Note that the predetermined position is a midpoint position at the time of the imaging direction of the controller 5 pointing at the center of the screen. Note that in addition to the method described above, a calculation method as described in, for example, Japanese Laid-Open Patent Publication No. 2007-241734, can be used for calculating the specified position based on the marker coordinate points.

Concretely, in the process of step S28, the CPU 10 reads the marker coordinate data 94 from the main memory, and calculates the specified position based on marker coordinate points. Data representing the calculated specified position is then stored to the main memory as specified position data 104. After step S28, the CPU 10 ends the first reference setting process.

By the first reference setting process described above, the attitude of the controller 5 is set as a reference attitude at the time of a predetermined reference setting operation being performed on an operating section (button) of the controller 5. Here, in another example embodiment, the CPU 10 may perform the processes for setting the first reference attitude (the processes of steps S24 to S26), provided that the determination result of step S23 is affirmative and/or the determination result of step S27 is affirmative. That is, when the controller 5 has picked up an image of a marker unit (or a cursor is displayed on the screen), the CPU 10 may set the attitude of the controller 5 as a reference attitude for a display device corresponding to the marker unit. As a result, in the case where the reference setting operation is performed when the controller 5 is oriented in a completely wrong direction, not toward the television 2, e.g., in the case where the player performs the reference setting operation by mistake, the first reference attitude is not set, which makes it possible to set the first reference attitude with higher precision.

Note that in the first reference setting process, the CPU 10 calculates the specified position at which to display the cursor 81 based on marker coordinate points, and unlike in a position calculation process (step S15) to be described later, the CPU 10 does not calculate the specified position based on the attitude of the controller 5 that is calculated based on acceleration and an angular rate. The reason for this is that, while the first reference setting process is being performed, the specified position could not be calculated with precision based on the attitude that is calculated based on acceleration and an angular rate. Specifically, before the first reference attitude is set, the attitude that is calculated based on acceleration and an angular rate might not be an attitude with respect to the television 2 (the marker device 6). In such a case, the positional relationship between the marker device 6 and the controller 5 cannot be known from the attitude that is calculated based on acceleration and an angular rate, which makes it difficult to calculate the specified position with precision. In addition, the first reference setting process aims to set an attitude directed toward the television 2 (more precisely, the guidance image 83 on the television 2) as the first reference attitude, and therefore it is sufficient for the specified position to be calculated only when the controller 5 is directed toward the television 2. Therefore, the specified position is not calculated when the controller 5 is in such an attitude as not to be able to pick up an image of the marker device 6, and it is less necessary to calculate a broad range of attitudes of the controller 5 using acceleration and angular rates. In view of the foregoing, in the first reference setting process of the present example embodiment, the specified position is calculated using marker coordinate points. Note that in another example embodiment, when an attitude with respect to the television 2 (the marker device 6) can be known from the attitude that is calculated based on acceleration and an angular rate, the specified position may be calculated using acceleration and an angular rate.

In the case where the process of step S28 is performed, a cursor 81 is rendered at the specified position in a television game image generation process (step S4) to be described later, so that the cursor 81 is displayed on the television 2. Accordingly, in the present example embodiment, while the first reference setting process is being performed, a position specified by the controller 5 is displayed on the television 2 (see FIG. 12). As a result, the player can readily perform an operation to direct the controller 5 toward a guidance image 83, and therefore the game apparatus 3 can precisely set the attitude of the controller 5 directed toward the television 2 as the first reference attitude. Upon completion of the first reference setting process described above, the CPU 10 ends the game control process (see FIG. 16).

On the other hand, in step S13 shown in FIG. 16, it is determined whether the second reference attitude has already been set or not. Concretely, the process flag data 107 is read from the main memory to determine whether the value of the process flag is “2”. When the determination result of step S13 is affirmative, the process of step S15 is performed. On the other hand, when the determination result of step S13 is negative, the process of step S14 is performed.

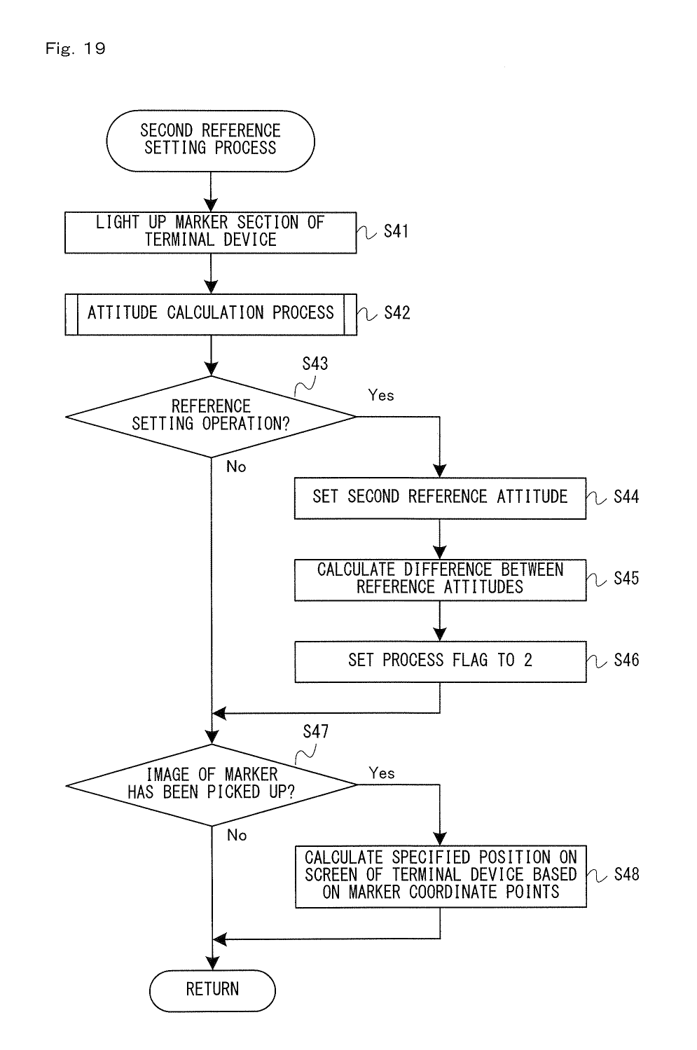

In step S14, the CPU 10 performs the second reference setting process to set a second reference attitude for the terminal device 7. In the present example embodiment, once the game process shown in FIG. 15 starts, the first reference setting process is initially performed, and then the second reference setting process is performed after the first reference attitude is set. Hereinafter, referring to FIG. 19, the second reference setting process will be described in detail.

FIG. 19 is a flowchart illustrating a detailed flow of the second reference setting process (step S14) shown in FIG. 16. In the second reference setting process, the CPU 10 initially in step S41 lights up the marker section 55, which is a marker unit corresponding to the terminal device 7. Specifically, the CPU 10 generates control data representing an instruction to light up the marker section 55 and stores the generated control data to the main memory. The control data is transmitted to the terminal device 7 in step S7 to be described later. The control data is received by the wireless module 70 of the terminal device 7 and then transferred to the UI controller 65 via the codec LSI 66, and the UI controller 65 instructs the marker section 55 to light up. As a result the infrared LEDs of the marker section 55 are lit up. Note that in the second reference setting process, the marker device 6, which is a marker unit corresponding to the television 2, is not lit up. The reason for this is that, if the marker device 6 is lit up, the marker device 6 might be erroneously detected as the marker section 55. Note that the lights of the marker device 6 and the marker section 55 can be turned off by a process similar to that for lighting up. Following step S41, the process of step S42 is performed.

In step S42, the CPU 10 performs an attitude calculation process to calculate the attitude of the controller 5. The attitude calculation process of step S42 is the same as that of step S22 described above. Note that in the second reference setting process, as in the first reference setting process, a correction process (steps S35 to S37 shown in FIG. 18) using the third attitude based on marker coordinate points is not performed. Here, the third attitude is an attitude with respect to the marker section 55, but the attitude to be calculated in the second reference setting process is an attitude with respect to the first reference attitude (which represents a rotation from the first reference attitude to the current attitude). In addition, when the second reference setting process is performed, the positional relationship between the television 2 (the marker device 6) and the terminal device 7 (the marker section 55) is unknown, and therefore it is not possible to know the attitude with respect to the first reference attitude (a rotation from the first reference attitude to the current attitude) based on the third attitude, which is an attitude with respect to the marker section 55. Therefore, in the second reference setting process, the correction process using the third attitude is not performed. Following step S42, the process of step S43 is performed.

In step S43, the CPU 10 determines whether the reference setting operation has been performed or not. The determination process of step S43 is the same as that of step S23 described above. When the determination result of step S43 is affirmative, the process of step S44 is performed. On the other hand, when the determination result of step S43 is negative, the processes of steps S44 to S46 are skipped, and the process of step S47 is performed.

In step S44, the CPU 10 sets the current attitude of the controller 5 as a second reference attitude. Note that the current attitude is the attitude calculated in step S42 and represented by the first attitude data 97. Specifically, the CPU 10 reads the first attitude data 97 from the main memory and then stores it back to the main memory as the first reference attitude data 100. Following step S44, the process of step S45 is performed.

In step S45, the CPU 10 calculates the difference between the first reference attitude and the second reference attitude. In the present example embodiment, the CPU 10 calculates the inner product of vectors, each representing a predetermined axis (e.g., the Z-axis) of a reference attitude, as the difference. Note that the CPU 10 may calculate any information so long as the difference is represented, and for example, an angle of rotation from the first reference attitude to the second reference attitude may be calculated as the difference. Data representing the calculated difference is stored to the main memory as difference data 105. Following step S45, the process of step S46 is performed.

In step S46, the CPU 10 sets the value of the process flag to “2”. Specifically, the process flag data 107 is updated so as to indicate “2”. As a result, in the next process loop of steps S2 to S8 to be performed, a position calculation process (step S15) and an object control process (S16) are performed. Following step S46, the process of step S47 is performed.

In step S47, the CPU 10 determines whether or not an image of the marker section 55 has been picked up by the image pickup means (image pickup element 40) of the controller 5. The process of step S47 is the same as those of steps S35 and S27 described above. When the determination result of step S47 is affirmative, the process of step S48 is performed. On the other hand, when the determination result of step S47 is negative, the process of step S48 is skipped, and the CPU 10 ends the second reference setting process.

In step S48, the CPU 10 calculates a specified position on the screen of the marker section 55 based on marker coordinate points. Concretely, the CPU 10 reads the marker coordinate data 94 from the main memory, and calculates the specified position based on the marker coordinate points. Data representing the calculated specified position is then stored to the main memory as specified position data 104. Note that the method for calculating the specified position based on the marker coordinate points may be the same as in step S28. After step S48, the CPU 10 ends the second reference setting process.

In the second reference setting process, for the same reason as in the first reference setting process, the specified position is calculated based on the marker coordinate points, as in step S48. Note that in another example embodiment, the specified position may be calculated using acceleration and an angular rate, as has been mentioned in conjunction with the first reference setting process.

In the case where the process of step S48 is performed, a cursor 81 is rendered at the specified position in a terminal game image generation process (step S5) to be described later, so that the cursor 81 is displayed on the terminal device 7. Accordingly, in the present example embodiment, while the second reference setting process is being performed, a position specified by the controller 5 is displayed on the terminal device 7. As a result, the player can readily perform an operation to direct the controller 5 toward a guidance image 83, and therefore the game apparatus 3 can precisely set the attitude of the controller 5 directed toward the terminal device 7 as the second reference attitude. Upon completion of the second reference setting process described above, the CPU 10 ends the game control process (see FIG. 16).

Note that in the second reference setting process, as in the first reference setting process, the CPU 10 may perform the processes for setting the second reference attitude (steps S44 to S46), provided that the determination result of step S43 is affirmative and/or the determination result of step S47 is affirmative.

By the processes of steps S12 and S14 shown in FIG. 16 and described above, the reference attitudes are set. As a result, both the attitude of the controller 5 directed toward the television 2 and the attitude of the controller 5 directed toward the terminal device 7 are set, and therefore it is possible to determine whether the controller 5 is directed toward the television 2 or the terminal device 7. In the present example embodiment, after the reference attitudes are set, the position calculation process and the object control process, which will be described later, are performed, and the game is started.

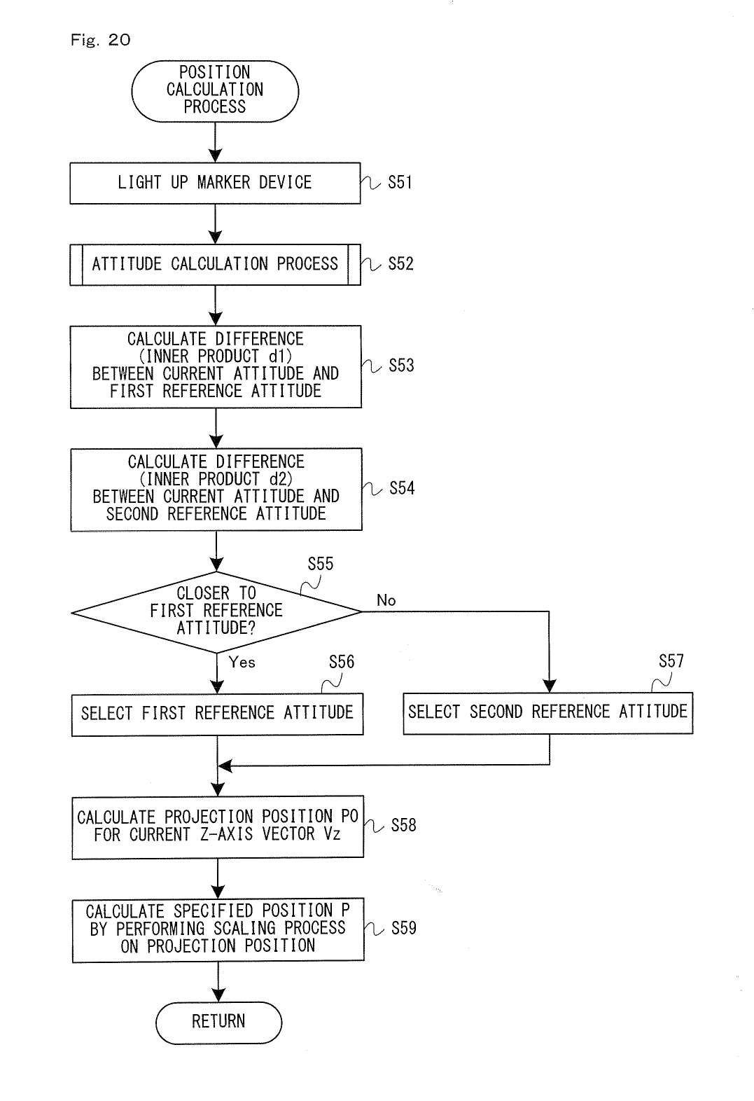

In step S15, the CPU 10 performs the position calculation process. The position calculation process is a process in which it is determined whether the controller 5 is directed toward the television 2 or the terminal device 7, and a specified position on the screen of the display device toward which the controller 5 is directed is calculated. Hereinafter, referring to FIG. 20, the position calculation process will be described in detail.

FIG. 20 is a flowchart illustrating a detailed flow of the position calculation process (step S15) shown in FIG. 16. In the position calculation process, the CPU 10 initially in step S51 lights up the marker device 6, which is a marker unit corresponding to the television 2. The process of step S51 is the same as that of step S21 described above. Note that in the position calculation process, as in the first reference setting process, the marker section 55 is not lit up to prevent the marker unit from being erroneously detected. Following step S51, the process of step S52 is performed.

In step S52, the CPU 10 performs an attitude calculation process to calculate the attitude of the controller 5. The attitude calculation process of step S52 is the same as that of step S22 described above. However, in the position calculation process, the process flag is set at “2”, and therefore, a correction process using the third attitude based on marker coordinate points (step S35 to S37 shown in FIG. 18) is performed in the attitude calculation process. Therefore, in the position calculation process, the correction process using the third attitude makes it possible to calculate the attitude of the controller 5 with higher precision. Following step S52, the process of step S53 is performed.

In step S53, the CPU 10 calculates the difference between the current attitude of the controller 5 and the first reference attitude. While any information may be calculated as information representing the difference, in the present example embodiment, the inner product of the Z-axis vector of the current attitude and the Z-axis vector of the first reference attitude is calculated as the difference. Here, the Z-axis vector of an attitude is a unit vector indicating the direction of the Z-axis where the controller 5 takes that attitude. The Z-axis vector of an attitude is a component of a three-dimensional vector which is represented by three values in the third column of a rotation matrix (see expression (1)) representing that attitude.

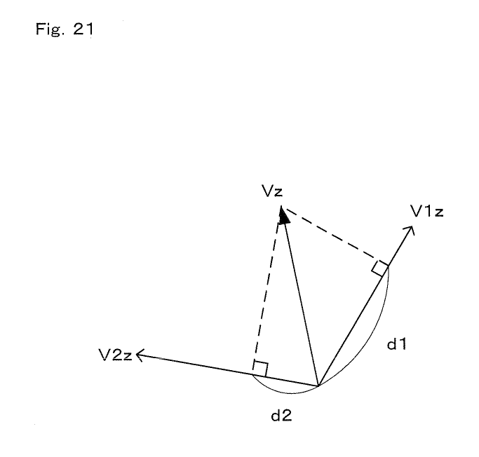

FIG. 21 is a diagram illustrating the Z-axis vectors of the current attitude and the reference attitudes. In FIG. 21, vector Vz is the Z-axis vector of the current attitude, vector V1z is the Z-axis vector of the first reference attitude, and vector V2z is the Z-axis vector of the second reference attitude. In step S53 above, the CPU 10 reads the first attitude data 97 and the first reference attitude data 100 from the main memory, and calculates the inner product of the Z-axis vector Vz of the current attitude and the Z-axis vector V1z of the first reference attitude (length d1 shown in FIG. 21). Data representing the calculated inner product is stored to the main memory. Following step S53, the process of step S54 is performed.

In step S54, the CPU 10 calculates the difference between the current attitude of the controller 5 and the second reference attitude. The difference is calculated in the same manner as in step S53. Specifically, the CPU 10 reads the first attitude data 97 and the second reference attitude data 101 from the main memory, and calculates the inner product of the Z-axis vector Vz of the current attitude and the Z-axis vector V2z of the second reference attitude (length d2 shown in FIG. 21). Data representing the calculated inner product is stored to the main memory. Following step S54, the process of step S55 is performed.

In step S55, the CPU 10 determines whether or not the current attitude of the controller 5 is closer to the first reference attitude than to the second reference attitude. Here, the inner products calculated in steps S53 and S54 represent the degrees of closeness between the current attitude of the controller 5 and the reference attitudes. Specifically, the closer the current attitude is to the reference attitudes, the higher the values of the inner products are, and the farther the current attitude is from the reference attitudes, the lower the values of the inner products are. Accordingly, by using the inner products, it is possible to determine the reference attitude closer to the current attitude. Concretely, the CPU 10 reads data representing the values of the inner products d1 and d2 stored in the main memory, and determines whether the value of the inner product d1 is greater than the value of the inner product d2. By the determination process of step S55, it is possible to determine whether the controller 5 is directed toward the television 2 or the terminal device 7. When the determination result of step S55 is affirmative, the process of step S56 is performed. On the other hand, when the determination result of step S55 is negative, the process of step S57 is performed.

Note that in steps S53 to S55, the determination as to which reference attitude is closer to the current attitude is made using the inner products of the Z-axis vectors of the attitudes as the differences between the current attitude and the reference attitudes. Here, in another example embodiment, such a determination may be made by any method, and for example, the determination may be made using the amounts of rotation from the current attitude to the reference attitudes as the differences. That is, the current attitude may be determined to be closer to the reference attitude with a smaller amount of rotation.

In step S56, the CPU 10 selects the first reference attitude as the reference attitude (the target reference attitude) corresponding to the target display device, i.e., the display device toward which the controller 5 is directed. Concretely, data representing the first reference attitude is stored to the main memory as target reference data 102. As a result, the display device (the target display device) toward which the controller 5 is directed is determined to be the television 2. Moreover, in steps S58 and S59 to be described later, a specified position is calculated using the first reference attitude. Following step S56, the process of step S58 is performed.

On the other hand, in step S57, the CPU 10 selects the second reference attitude as the target reference attitude. Concretely, data representing the second reference attitude is stored to the main memory as target reference data 102. As a result, the target display device is determined to be the terminal device 7. Moreover, in steps S58 and S59 to be described later, a specified position is calculated using the second reference attitude. Following step S57, the process of step S58 is performed.

In steps S55 to S57 above, the CPU 10 determines which reference attitude is closer to the current attitude of the controller 5, and therefore, either of the reference attitudes is identified as the target display device without fail. Here, in another example embodiment, the CPU 10 does not identify any display device depending on the attitude of the controller 5. For example, in steps S55 to S57 above, for each reference attitude, the CPU 10 may determine whether the difference between the reference attitude and the current attitude is within a predetermined range, and the reference attitude that is determined to be within the predetermined range may be selected as the target reference attitude. This makes it possible to precisely determine the display device toward which the controller 5 is directed, as is possible in the present example embodiment.

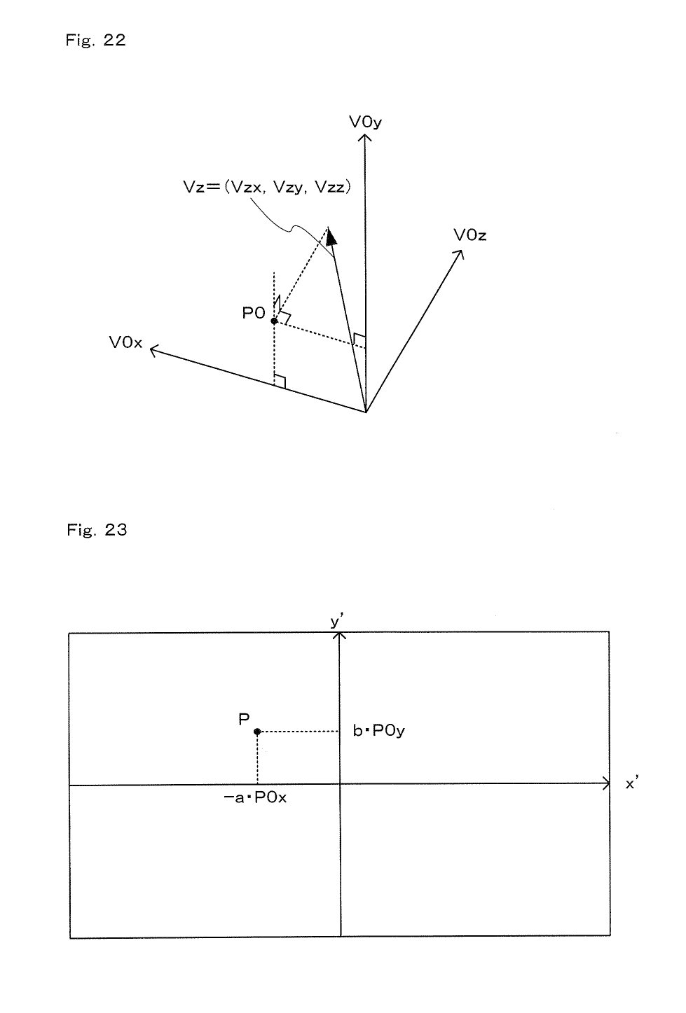

In step S58, the CPU 10 calculates a projection position for the Z-axis vector of the current attitude. The projection position is information calculated based on the current attitude and the target reference attitude and representing the amount and the direction of change in the current attitude with respect to the target reference attitude. Hereinafter, referring to FIG. 22, the method for calculating the projection position will be described in detail.

FIG. 22 is a diagram illustrating a method for calculating a projection position. In FIG. 22, vectors V0x, V0y, and V0z represent the X-, Y-, and Z-axis vectors, respectively, of a target reference attitude. As shown in FIG. 22, the projection position P0 is the position of the target reference attitude in an XY plane (a plane parallel to the X-axis vector and the Y-axis vector), which is obtained by projecting the end point of the Z-axis vector Vz of the current attitude onto the XY plane. Accordingly, the X-axis component of the projection position P0 (a component in the X-axis direction of the target reference attitude) can be calculated as the value of the inner product of the Z-axis vector Vz of the current attitude and the X-axis vector of the target reference attitude. In addition, the Y-axis component of the projection position P0 (a component in the Y-axis direction of the target reference attitude) can be calculated as the value of the inner product of the Z-axis vector Vz of the current attitude and the Y-axis vector of the target reference attitude. Concretely, the CPU 10 calculates the projection position P0 in accordance with the following expression (2).

P0=(Vz·V0x,Vz·V0y) (2)

The projection position P0 is represented by a two-dimensional coordinate system for representing positions in the XY plane, the system having two axes, the X-axis vector V0x and the Y-axis vector V0y of the target reference attitude, whose starting points are at the origin. Here, the direction from the origin of the two-dimensional coordinate system toward the projection position P0 represents the direction of rotation from the target reference attitude to the current attitude (the direction of change). In addition, the distance from the origin of the two-dimensional coordinate system to the projection position P0 represents the amount of rotation from the target reference attitude to the current attitude (the amount of change). Accordingly, the projection position P0 can be said to be information representing the direction and the amount of change in the current attitude with respect to the target reference attitude.

Note that in the case where the target reference attitude is the first reference attitude, the X-axis vector and the Y-axis vector of the target reference attitude match the X′- and Y′-axes, respectively, of a spatial coordinate system since the first reference attitude is an identity matrix (here, the spatial coordinate system is represented as the X′Y′ Z′ coordinate system). Accordingly, the calculation by expression (2) can be readily performed by extracting the X′-axis component Vzx and the Y′-axis component Vzy of the Z-axis vector Vz of the current attitude.

Concretely, in the process of step S58, the CPU 10 initially reads the target reference data 102 from the main memory to identify the target reference attitude, and then reads the reference attitude data 100 or 101, which represents the target reference attitude, from the main memory, along with the first attitude data 97. Moreover, the CPU 10 calculates the projection position P0 by performing computation of expression (2) using the current attitude and the target reference attitude. Data representing the calculated projection position P0 is stored to the main memory as projection position data 103. Following step S58, the process of step S59 is performed.

In step S59, the CPU 10 calculates a specified position based on the projection position. The specified position is calculated by performing a predetermined scaling process on the projection position. FIG. 23 is a diagram illustrating a method for calculating a specified position. The plane shown in FIG. 23 is a plane corresponding to the screen of a display device. The plane here is represented by an x′y′ coordinate system with the rightward direction being set as the x′-axis positive direction and the upward direction as the y′-axis positive direction. As shown in FIG. 23, the specified position P=(Px,Py) can be calculated in accordance with the following expression (3).

Px=−a·P0x

Py=b·P0y (3)

In expression (3), variables P0x and P0y represent the X′- and Y′-axis components of the projection position. Constants a and b are predetermined values. Note that the reason for the sign being reversed in expression (3) for calculating the x′-axis component Px of the specified position P is that the X′-axis and the x′-axis are opposite in direction.

Constant a is a value representing the degree of change in the specified position in the horizontal direction of the screen with respect to the change in the attitude of the controller 5. Specifically, when constant a is small, the specified position does not change substantially even if the attitude of the controller 5 is changed significantly, but when constant a is large, the specified position changes substantially even if the attitude of the controller 5 is changed only slightly. Furthermore, constant b is a value representing the degree of change in the specified position in the vertical direction of the screen with respect to the change in the attitude of the controller 5. Constants a and b are set to appropriate values at appropriate times in accordance with the contents of game operations with the controller 5 and the player's instructions. Constants a and b may be the same value or different values. In the present example embodiment, constant a for the horizontal direction and constant b for the vertical direction can be set independently of each other, and therefore the degree of change in the specified position with respect to the attitude of the controller 5 can be adjusted individually for the vertical and the horizontal direction of the screen.

Concretely, in the process of step S59, the CPU 10 initially reads the projection position data 103 from the main memory and performs computation of expression (3) using the projection position P0, thereby calculating the specified position P. Data representing the calculated specified position is stored to the main memory as specified position data 104. After step S59, the CPU 10 ends the position calculation process.

By the processes of steps S58 and S59, the projection position is calculated based on the current attitude of the controller 5 and the target reference attitude (step S58), and the specified position is calculated by performing a scaling process on the projection position (step S59). Here, the specified position can be calculated by any method so long as it changes in accordance with the current attitude, but as in the present example embodiment, the specified position may be calculated to be a position corresponding to the amount and the direction of change in the current attitude with respect to the target reference attitude. As a result, the player can adjust the direction of movement of the specified position in the same direction as the change in the attitude of the controller 5, and can also adjust the amount of movement of the specified position in the same amount of change in the attitude of the controller 5, making it possible to readily and intuitively manipulate the specified position.

Note that for the reasons such as the television 2 and the terminal device 7 being different in the size of the screen and/or the aspect ratio, in some cases, the pointing operations for the television 2 and the terminal device 7 are set to provide different feelings of operation (e.g., different degrees of change in the specified position with respect to the change in the attitude of the controller 5). For example, when the degree of change in the specified position is excessively high for the screen, it might be difficult to provide detailed instructions. Also, when the degree of change in the specified position is excessively low for the screen, the specified position might move from one screen to the other rather than to the outside, making it impossible to specify areas close to the edges of the screen. As described above, there might be some cases where the degree of change in the specified position is adjusted in accordance with the size and/or the aspect ratio of the screen. Accordingly, in step S59, the specified position to be calculated may have different coordinate values in accordance with whether the target reference attitude is the first reference attitude or the second reference attitude (i.e., in accordance with the target display device). For example, constants a and b may be changed in accordance with whether the target reference attitude is the first reference attitude or the second reference attitude. Moreover, when the difference in the reference attitude between the television 2 and the terminal device 7 is insignificant, the specified position might also move directly from one screen to the other. Therefore, the CPU 10 may cause the specified position to have different coordinate values in accordance with the positional relationship between the display devices. That is, in step S59, constant a and b may be adjusted in accordance with the difference between the reference attitudes.

By the position calculation process described above, the display device (the target display device) toward which the controller 5 is directed is identified based on the current attitude and the reference attitudes (steps S55 to S57). Then, the specified position is calculated in accordance with the amount and the direction of change in the current attitude with respect to the reference attitude for the target display device (steps S58 and S59). Thus, it is possible to identify the target display device with precision and achieve user-friendly pointing operations.

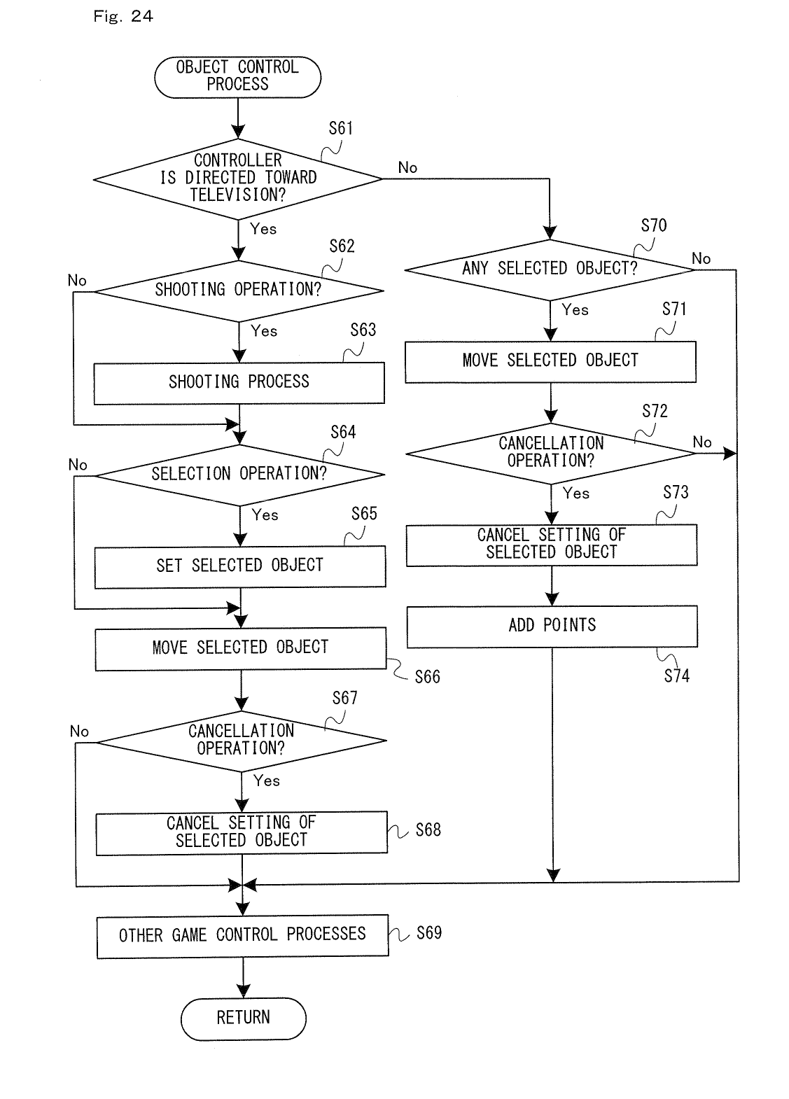

Returning to the description of FIG. 16, the process of step S16 is performed after the position calculation process (step S15). Specifically, in step S16, the CPU 10 performs an object control process. The object control process is a process for controlling the action of an object or suchlike appearing in the game space using, for example, the specified position as an input. Hereinafter, referring to FIG. 24, the object control process will be described in detail.

FIG. 24 is a flowchart illustrating a detailed flow of the object control process (step S16) shown in FIG. 16. In the object control process, the CPU 10 initially in step S61 determines whether the target display device is the television 2 or not, i.e., whether the controller 5 is directed toward the television 2 or not. Concretely, the CPU 10 reads the target reference data 102 from the main memory, and determines whether the target reference data 102 represents the first reference attitude or not. When the determination result of step S61 is affirmative, the processes of steps S62 to S68 are performed. The processes of steps S62 to S68 constitute a game control process to be performed in accordance with the pointing operation on the screen of the television 2 when the controller 5 is directed toward the television 2. On the other hand, when the determination result of step S61 is negative, the processes of steps S70 to S74 to be described later are performed. The processes of steps S70 to S74 constitute a game control process to be performed in accordance with the pointing operation on the screen of the terminal device 7 when the controller 5 is directed toward the terminal device 7.

In step S62, the CPU 10 determines whether a shooting operation has been performed or not. The shooting operation is an operation to shoot an enemy object 86, which is performed, for example, by pressing a predetermined button (here, the B button 32i). Concretely, the CPU 10 reads and references the operation button data 95 from the main memory to determine whether the predetermined button has been pressed or not. When the determination result of step S62 is affirmative, the process of step S63 is performed. On the other hand, when the determination result of step S62 is negative, the process of step S63 is skipped, and the process of step S64 is performed.

In step S63, the CPU 10 performs a shooting process in accordance with the shooting operation. Concretely, the CPU 10 reads the specified position data 104 from the main memory, and determines whether or not an enemy object 86 is present at the specified position on the screen of the television 2 (whether the enemy object 86 has been shot or not). When the enemy object 86 is present at the specified position, the enemy object 86 is caused to act in accordance with that situation (e.g., to explode and disappear or to move away). Following step S63, the process of step S64 is performed.

In step S64, the CPU 10 determines whether a selection operation has been performed or not. The selection operation is performed to select one player object 85. In the present example embodiment, the selection operation is an operation of starting the pressing of a predetermined button (here, the A button 32d), and a cancellation operation to be described later is an operation of ending the pressing of the predetermined button. Specifically, in the present example embodiment, the player object 85 is selected while the A button 32d is being pressed, and when the pressing of the A button 32d ends, the player object 85 is deselected. Concretely, the CPU 10 reads and references the operation button data 95 from the main memory to determine whether the pressing of the predetermined button has started or not. When the determination result of step S64 is affirmative, the process of step S65 is performed. On the other hand, when the determination result of step S64 is negative, the process of step S65 is skipped, and the process of step S66 is performed.

In step S65, the CPU 10 sets a selected object. Specifically, the CPU 10 reads the specified position data 104 from the main memory, and stores data representing the player object 85 displayed at the specified position as selected object data 108. Note that when the player object 85 is not displayed at the specified position (i.e., when the selection operation is performed with the specified position being a position in which no player object 85 is present), no selected object is set. Following step S65, the process of step S66 is performed.

In step S66, the CPU 10 moves the selected object. Concretely, the CPU 10 reads the specified position data 104 from the main memory, and places the selected object at the specified position on the screen of the television 2. As a result, when the player moves the specified position on the screen of the television 2, the selected object moves along with the specified position. Note that when no object is selected, the process of step S66 is skipped. Following step S65, the process of step S67 is performed.

In step S67, the CPU 10 determines whether a cancellation operation has been performed or not. The cancellation operation is an operation for deselecting a selected object, and in the present example embodiment, it is performed by ending the pressing of the predetermined button (the A button 32d). Concretely, the CPU 10 reads and references the operation button data 95 from the main memory to determine whether the pressing of the predetermined button has ended or not. When the determination result of step S67 is affirmative, the process of step S68 is performed. On the other hand, when the determination result of step S67 is negative, the process of step S68 is skipped, and the process of step S69 is performed.

In step S68, the CPU 10 cancels the setting of the selected object. Concretely, the CPU 10 erases the selected object data 108 stored in the main memory. As a result, the player object 85 for which the setting of the selected object has been cancelled does not move along with the specified position. Following step S68, the process of step S69 is performed.

In step S69, the CPU 10 performs other game control processes. The other game processes are intended to mean processes to be performed other than the processes of steps S61 to S68, and the processes of steps S70 to S74 to be described later, and examples of the other game processes include processes for controlling actions of enemy objects 86 and adding another player object 85. Note that the processes for controlling actions of enemy objects 86 are processes of moving enemy objects 86 and causing the enemy objects 86 to take the player object 85 away in accordance with action algorithms defined in the game program 90. The process for adding another player object 85 is a process of arranging a new player object 85 at an appropriate position on the screen of the television 2. In addition to the above processes, a process for causing the game to progress is appropriately performed in step S69. After step S69, the CPU 10 ends the object control process.

As described above, when the controller 5 is directed toward the television 2, the processes of steps S62 to S69 are performed. Thus, by performing a pointing operation using the controller 5, the player can shoot the enemy object 86 (step S63), select and move the player object 85 (steps S65 and S66), or deselect the player object 85 (step S68).

On the other hand, in step S70, the CPU 10 determines whether there is any selected object or not. Concretely, the CPU 10 determines whether the selected object data 108 is stored in the main memory or not. When the determination result of step S70 is affirmative, the process of step S71 is performed. On the other hand, when the determination result of step S70 is negative, the processes of steps S71 to S74 are skipped, and the process of step S69 is performed.

In step S71, the CPU 10 moves the selected object. Concretely, the CPU 10 reads the specified position data 104 from the main memory, and arranges the selected object at a specified position on the screen of the terminal device 7. As a result, when the player moves the specified position on the screen of the terminal device 7, the selected object moves along with the specified position. Following step S71, the process of step S72 is performed.

In step S72, the CPU 10 determines whether a cancellation operation has been performed or not. The determination process of step S72 is the same as that of step S67 described above. When the determination result of step S72 is affirmative, the process of step S73 is performed. On the other hand, when the determination result of step S72 is negative, the processes of steps S73 and S74 are skipped, and the process of step S69 is performed.

In step S73, the CPU 10 cancels the setting of the selected object. Concretely, as in step S68, the CPU 10 erases the selected object data 108 stored in the main memory. Note that when the process of step S73 is performed, the player object 85 that has been deselected is controlled to enter the house 87 in step S69. As a result, the player object 85 is successfully rescued, so that some points are scored. Following step S73, the process of step S74 is performed.

In step S74, the CPU 10 adds the points. Here, in the game of the present example embodiment, points are scored by a series of operations starting with the controller 5 being directed toward the television 2 to select the player object 85 and ending with the controller 5 being directed toward the terminal device 7 to perform the cancellation operation. Accordingly, the greater the amount of rotation of the controller 5 from the state of being directed toward the television 2 to the state of being directed toward the terminal device 7, the more time is consumed for the series of operations, hence the more difficult the game becomes. That is, it can be said that, in the present game, the positional relationship between the television 2 and the terminal device 7 affects the difficulty of the game. Therefore, in the present example embodiment, the number of points to be scored changes in accordance with the positional relationship between the television 2 and the terminal device 7.

In the present example embodiment, the difference between the reference attitudes (the difference data 105) is used to represent the positional relationship. Concretely, the CPU 10 reads the difference data 105 from the main memory, and determines the number of points to be added in accordance with the magnitude of the inner product value indicated by the difference data 105. As described above in conjunction with step S45, the inner product value is obtained as an inner product value of vectors representing predetermined axes (e.g., the Z-axes) of the reference attitudes. Accordingly, the lower the inner product value, the greater the difference between the reference attitudes, hence the more difficult the game becomes, and therefore the CPU 10 determines the number of points to be added so as to increase as the inner product value decreases. Thereafter, data representing the score obtained by adding the determined number of points to the current score is stored to the main memory as new data representing the score. Following step S74, the process of step S69 is performed, and thereafter, the CPU 10 ends the object control process.

As described above, when the controller 5 is directed toward the terminal device 7, the processes of steps S70 to S74 are performed along with step S69. Accordingly, by performing a pointing operation using the controller 5, the player can move the selected object (step S71), or score points by canceling the setting of the selected object (steps S73 and S74).

The object control process as described above allows the player to select the player object 85 by performing a selection operation with the controller 5 directed toward the player object 85 displayed on the television 2. Thereafter, by changing the direction of the controller 5 to the terminal device 7 while keeping the player object 85 selected (Yes in step S70), it is possible to display the player object 85 on the terminal device 7. In this manner, by simply directing the controller 5 toward the terminal device 7 after performing a selection operation with the controller 5 being directed toward the television 2, the player can move the player object 85 from the television 2 to the terminal device 7. That is, in the present example embodiment, the player can readily and intuitively perform an operation for moving an object displayed on the television 2 to the terminal device 7.

Furthermore, in the object control process, the content of the game (the difficulty of the game) changes in accordance with the positional relationship between the television 2 and the terminal device 7, and therefore, the player can change the content of the game by placing the terminal device 7, which is a transportable display device, at an arbitrary position, so that the game system 1 can render the game highly enjoyable.

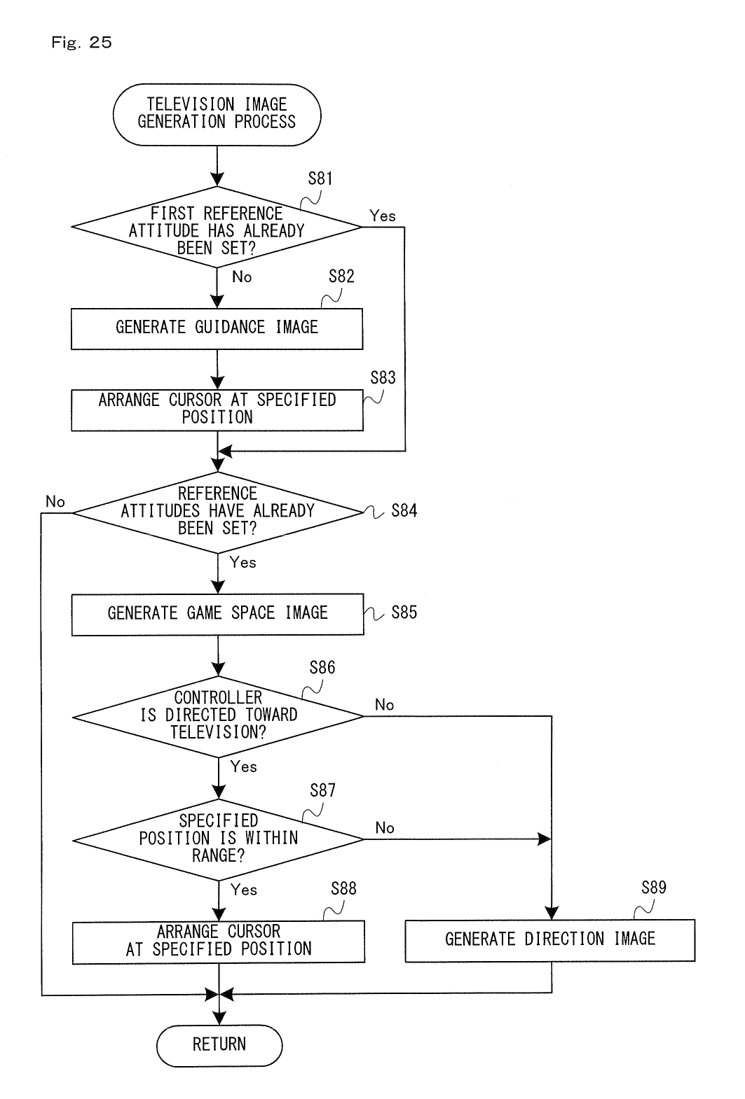

Upon completion of the object control process, the CPU 10 ends the game control process (see FIG. 16). After the game control process, the process of step S4 is performed (see FIG. 15). In step S4, the CPU 10 and the GPU 11b collaborate to perform a television game image generation process. This generation process is a process for generating television game images to be displayed on the television 2. Hereinafter, referring to FIG. 25, the television game image generation process will be described in detail.

FIG. 25 is a flowchart illustrating a detailed flow of the television game image generation process (step S4) shown in FIG. 15. In the television game image generation process, the CPU 10 initially in step S81 determines whether the first reference attitude has already been set or not. The determination process of step S81 is the same as that of step S11 described above. When the determination result of step S81 is affirmative, the processes of steps S82 and S83 are skipped, and the process of step S84 is performed. On the other hand, when the determination result of step S81 is negative, the process of step S82 is performed.

In step S82, the CPU 10 and the GPU 11b collaborate to generate a dialog image 82 and a guidance image 83. Specifically, the CPU 10 and the GPU 11b collaborate to read data for generating the dialog image 82 and the guidance image 83 from the VRAM 11d, and generate the dialog image 82 and the guidance image 83. The generated television game images are stored to the VRAM 11d. Following step S82, the process of step S83 is performed.

In step S83, an image of the cursor 81 is arranged at a specified position on the images generated in step S82. Specifically, the CPU 10 and the GPU 11b collaborate to read the specified position data 104 from the main memory and data for generating the image of the cursor 81 from the VRAM 11d, and generate (render) the image of the cursor 81 so as to overlap with the dialog image 82 and the guidance image 83 at the specified position. Note that in the case where the process of step S28 is not performed, so that the specified position is not calculated, the process of step S83 is skipped. The television game images generated in steps S82 and S83 are stored to the VRAM 11d. Following step S83, the process of step S84 is performed.

In step S84, the CPU 10 determines whether the reference attitudes have already been set or not. The determination process of step S84 is the same as that of step S34 described above. The determination result of step S84 is affirmative, the process of step S85 is performed. On the other hand, when the determination result of step S84 is negative, the CPU 10 ends the television game image generation process.

In step S85, the CPU 10 and the GPU 11b collaborate to generate a game space image to be displayed on the television 2. Specifically, the CPU 10 and the GPU 11b collaborate to read data for generating the game space image from the VRAM 11d, and generate the game space image including a player object 85 and an enemy object 86. Note that any image generation method may be employed, and for example, a three-dimensional computer-generated image may be provided by calculating a game space as viewed from virtual cameras arranged in a virtual game space, or a two-dimensional image may be generated (without using the virtual cameras). The generated television game images are stored to the VRAM 11d. Following step S85, the process of step S86 is performed.

In step S86, the CPU 10 determines whether the controller 5 is directed toward the television 2 or not. The determination process of step S86 is the same as that of step S61 described above. When the determination result of step S86 is affirmative, the process of step S87 is performed. On the other hand, when the determination result of step S86 is negative, the process of step S89 is performed.

In step S87, the CPU 10 determines whether or not the specified position is within a range corresponding to the screen of the television 2. Here, the specified position is calculated as a position in a plane corresponding to the screen of the display device, but the specified position is not always within the range corresponding to the screen in the plane. Note that “the range corresponding to the screen” is a predetermined range in the shape of a prescribed rectangle having its center at the origin of the x′y′ coordinate system (see FIG. 23). When the specified position calculated in step 15 lies outside the range, the controller 5 points outside the screen of the television 2. That is, the determination process of step S87 is a process for determining whether or not the controller 5 points within the screen of the television 2.

Concretely, the CPU 10 reads the specified position data 104 from the main memory, and determines whether the specified position is within the range or not. When the determination result of step S87 is affirmative, the process of step S88 is performed. On the other hand, when the determination result of step S87 is negative, the process of step S89 is performed.

In step S88, an image of the cursor 81 is arranged at the specified position in the game space image generated in step S85. Specifically, the CPU 10 and the GPU 11b collaborate to read the specified position data 104 from the main memory and data for generating the image of the cursor 81 from the VRAM 11d, and generate (render) the image of the cursor 81 at the specified position over the game space image. The generated television game images generated in steps S85 and S88 are stored to the VRAM 11d. After step S88, the CPU 10 ends the television game image generation process.

On the other hand, in step S89, the direction image 88 as mentioned above is generated (rendered) over the game space image generated in step S85. Specifically, data for generating the direction image 88 is read from the VRAM 11d, and the direction image 88 is generated (rendered) at a predetermined position over the game space image. The television game images generated in steps S85 and S89 are stored to the VRAM 11d. After step S89, the CPU 10 ends the television game image generation process.

Note that the direction image 88 may be provided in any shape, size, position, etc., to indicate the direction in which the specified position deviates from the screen. In the present example embodiment, a triangular image indicating the deviation direction of the specified position is displayed at the edge of the screen (see FIG. 13), but in another example embodiment, for example, an arrow indicating the deviation direction of the specified position may be displayed at the center of the screen. In addition, the direction indicated by the direction image 88 (the direction in which the specified position deviates from the screen) is calculated based on the current attitude of the controller 5 and the reference attitude, concretely, based on the direction of rotation from the reference attitude to the current attitude. Moreover, the direction image 88 does not always indicate that direction of rotation in detail, and for example, the direction of rotation may be indicated by either one of the four directions: up, down, right, and left, or the eight directions: up, down, right, left, upper right, lower right, upper left, and lower left.

As described above, in the television game image generation process, when the first reference attitude is set (Yes in step S81), an image is generated with the cursor 81 being placed over the dialog image 82 and the guidance image 83 (steps S82 and S83). On the other hand, during the game (Yes in step S84), an image representing the game space is generated (step S85). In addition, during the game, when the controller 5 specifies a position on the screen of the television 2, the cursor 81 is arranged on the image representing the game space (step S88). Alternatively, when the controller 5 is directed toward the terminal device 7 (No in step S86), or when the controller 5 points outside the screen of the television 2 (No in step S87), the direction image 88 is arranged in the image representing the game space (step S89).

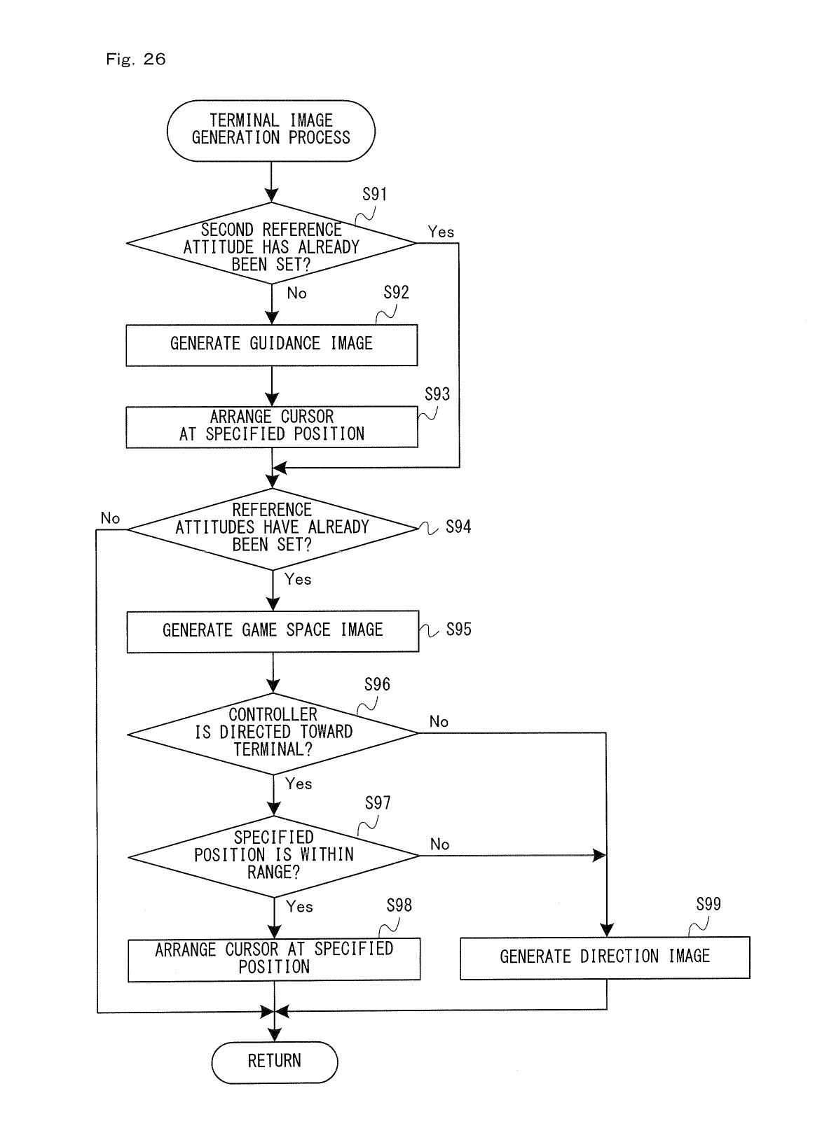

Returning to the description of FIG. 15, the process of step S5 is performed following the television game image generation process (step S4). In step S5, the CPU 10 and the GPU 11b collaborate to perform a terminal game image generation process. This generation process is a process for generating a terminal game image to be displayed on the terminal device 7. Hereinafter, referring to FIG. 26, the terminal game image generation process will be described in detail.

FIG. 26 is a flowchart illustrating a detailed flow of the terminal game image generation process (step S5) shown in FIG. 15. In the terminal game image generation process, the CPU 10 initially in step S91 determines whether the second reference attitude has already been set or not. Concretely, the determination process of step S91 is the same as that of step S34 described above. When the determination result of step S91 is affirmative, the processes of steps S92 and S93 are skipped, and the process of step S94 is performed. On the other hand, when the determination result of step S91 is negative, the process of step S92 is performed.

In step S92, the CPU 10 and the GPU 11b collaborate to generate a dialog image 82 and a guidance image 83. The process of step S92 is the same as that of step S82, except that the images are generated in different sizes because the images are displayed on a different device. The terminal game images generated in step S92 are stored to the VRAM 11d. Following step S92, the process of step S93 is performed.

In step S93, an image of the cursor 81 is arranged at the specified position over the images generated in step S92. The process of step S93 is the same as that of step S83 described above. Specifically, the CPU 10 and the GPU 11b collaborate to generate (render) the image of the cursor 81 at the specified position so as to overlap with the dialog image 82 and the guidance image 83. The terminal game images generated in steps S92 and S93 are stored to the VRAM 11d. Note that when the process of step S48 described above is not performed, and the specified position is not calculated, the process of step S93 is skipped. Following step S93, the process of step S94 is performed.

In step S94, the CPU 10 determines whether the reference attitudes have already been set or not. The determination process of step S94 is the same as those of steps S34 and S84. When the determination result of step S94 is affirmative, the process of step S95 is performed. On the other hand, when the determination result of step S94 is negative, the CPU 10 ends the terminal game image generation process.

In step S95, the CPU 10 and the GPU 11b collaborate to generate a game space image to be displayed on the television 2. Specifically, the CPU 10 and the GPU 11b collaborate to read data for generating the game space image from the VRAM 11d, and generate the game space image including a house object 87. Note that as in the case of step S85, any image generation method may be employed. Furthermore, the image generation method used in step S95 may be the same as or different from that used in step S85. The terminal game image generated in step S95 is stored to the VRAM 11d. Following step S95, the process of step S96 is performed.

In step S96, the CPU 10 determines whether the controller 5 is directed toward the terminal device 7 or not. Concretely, the CPU 10 reads the target reference data 102 from the main memory, and determines whether the target reference data 102 represents the second reference attitude or not. When the determination result of step S96 is affirmative, the process of step S97 is performed. On the other hand, when the determination result of step S96 is negative, the process of step S99 is performed.

In step S97, the CPU 10 determines whether or not the specified position lies within a range corresponding to the screen of the terminal device 7. When determination process of step S97 is a process for determining whether or not the controller 5 points inside the screen of the terminal device 7. Concretely, the determination process of step S97 can be performed in the same manner as determination process of step S87 described above. Specifically, the CPU 10 reads the specified position data 104 from the main memory, and determines whether the specified position lies within the aforementioned range or not. When the determination result of step S97 is affirmative, the process of step S98 is performed. On the other hand, when the determination result of step S97 is negative, the process of step S99 is performed.

In step S98, an image of the cursor 81 is arranged at the specified position on the game space image generated in step S95. The process of step S98 is the same as the process of step S88. Specifically, the CPU 10 and the GPU 11b collaborate to generate (render) the image of the cursor 81 at the specified position over the game space image. The terminal game images generated in steps S95 and S98 are stored to the VRAM 11d. After step S98, the CPU 10 ends the terminal game image generation process.

On the other hand, in step S99, the aforementioned direction image 88 is generated (rendered) over the game space image generated in step S95. The process of step S99 is the same as the process of step S89. Specifically, the CPU 10 and the GPU 11b collaborate to generate (render) the direction image 88 at a predetermined position over the game space image. Note that the method for calculating the direction represented by the direction image 88 and the position at which the direction image 88 may be the same as in step S89. The terminal game image generated in steps S95 and S99 is stored to the VRAM 11d. After step S99, the CPU 10 ends the terminal game image generation process.

As described above, in the case of the terminal game image generation process, when the second reference attitude is set (Yes in step S91), an image of the cursor 81 is generated so as to be arranged over the dialog image 82 and the guidance image 83 (steps S92 and S93). On the other hand, during the game (Yes in step S94), an image representing the game space is generated (step S95). In addition, during the game, when the controller 5 specifies a position on the screen of the terminal device 7, the cursor 81 is arranged on the image representing the game space (step S98). Moreover, when the controller 5 is directed toward the television 2 (No in step S96) or when the controller 5 specifies a position outside the screen of the terminal device 7 (No in step S97), the direction image 88 is arranged on the image representing the game space (step S99).

Returning the description of FIG. 15, the process of step S6 is performed after the terminal game image generation process (step S5). Specifically, in step S6, the CPU 10 outputs a game image to the television 2. Concretely, the CPU 10 transfers data for a television game image stored in the VRAM 11d to the AV-IC 15. In response to this, the AV-IC 15 outputs the data for the television game image to the television 2 via the AV connector 16. As a result, the television game image is displayed on the television 2. Note that when the second reference attitude is set, no television game image is generation in step S4, and therefore in step S6, the game image may or may not be outputted. In addition, in step S6, game sound data, along with game image data, may be outputted to the television 2, so that game sound may be outputted from the speakers 2a of the television 2. Following step S6, the process of step S7 is performed.

In step S7, the CPU 10 transmits the game image to the terminal device 7. Concretely, the image data for the terminal game image stored in the VRAM 11d is transferred to the codec LSI 27 by the CPU 10, and subjected to a predetermined compression process by the codec LSI 27. Furthermore, the terminal communication module 28 transmits the image data subjected to the compression process to the terminal device 7 via the antenna 29. The image data transmitted by the game apparatus 3 is received by the wireless module 70 of the terminal device 7, and subjected to a predetermined decompression process by the codec LSI 66. The image data subjected to the decompression process is outputted to the LCD 51. As a result, the terminal game image is displayed on the LCD 51. Note that when the first reference attitude is set, no terminal game image is generated in step S5, and therefore the game image may or may not be outputted in step S7. In addition, in step S7, game sound data, along with game image data, may be outputted to the terminal device 7, so that game sound may be outputted from the speakers 67 of the terminal device 7. Moreover, when the game apparatus 3 generates control data 106 (step S41), the control data 106, along with the image data, is transmitted to the terminal device 7 in step S7. Following step S7, the process of step S8 is performed.

In step S8, the CPU 10 determines whether or not to end the game. The determination of step S8 is made based on, for example, whether or not the game is over or the player has provided an instruction to cancel the game. When the determination result of step S8 is negative, the process of step S2 is performed again. On the other hand, when the determination result of step S8 is affirmative, the CPU 10 ends the game process shown in FIG. 15. Thereafter, a series of processes of steps S2 to S8 are repeated until a determination to end the game is made in step S8.

As described above, in the present example embodiment, the game apparatus 3 calculates the attitude of the controller 5 (step S52), and identifies one of two display devices toward which the controller 5 is directed based on the attitude of the controller 5 (steps S55 to S57). Then, a specified position corresponding to the attitude of the controller 5 is calculated as a position on the screen of the identified display device (steps S58 and S59). As a result, it is possible to determine the display device toward which the controller 5 is directed, and calculate a specified position as a position on the screen of the display device toward which the controller 5 is directed. Thus, in the present example embodiment, pointing operations can be performed on two display devices using the controller 5, and the controller 5 can be used and oriented in a wider range of directions.

### 7. Variant

The above example embodiment is merely illustrative, and in another example embodiment, a game system (input system) can be carried out with, for example, a configuration as will be described below.

(Variant Related to the Settings of the Reference Attitudes)

In the above example embodiment, the reference attitudes are set by the player actually directing the controller 5 toward the display devices, and storing the attitudes of the controller 5 directed toward the display devices. Here, in another example embodiment, any method can be employed for setting the reference attitudes, so long as the reference attitudes represent the attitudes of the controller 5 directed toward the display devices. For example, in another example embodiment, when the arrangement of the display devices is known, or when positions at which to arrange the display devices are determined, the reference attitudes may be preset.

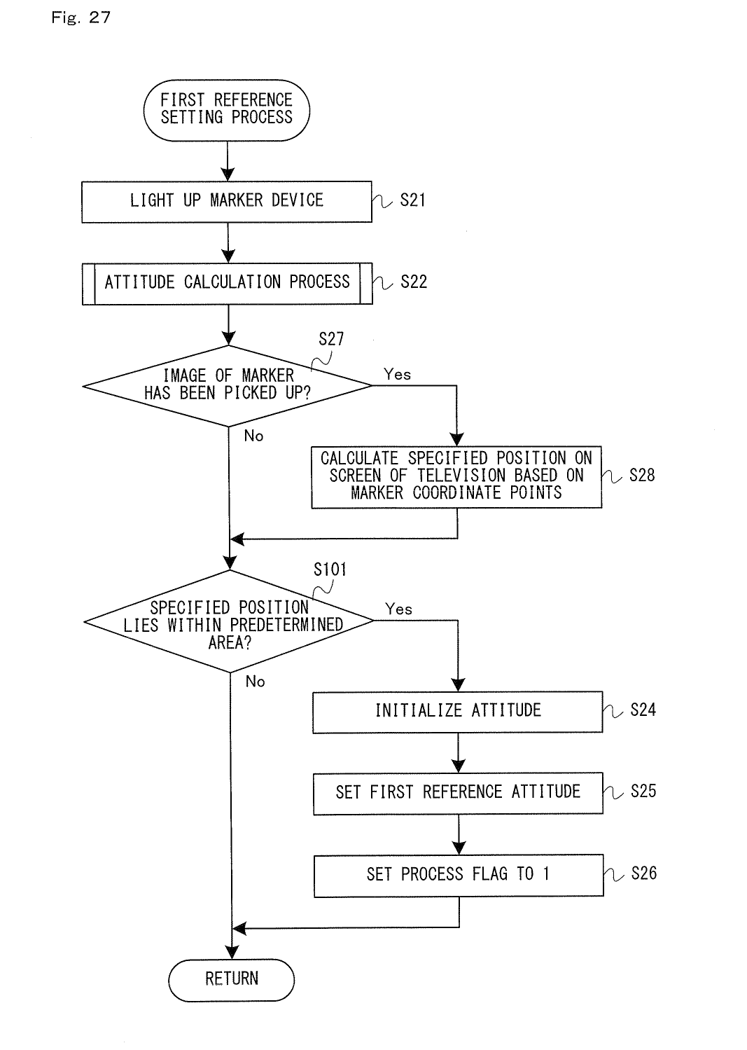

Also, in another example embodiment, the game apparatus 3 may set the attitude of the controller 5 as the reference attitude of a display device when a position (specified position) specified by the controller 5 lies within a predetermined area on the screen of the display device. FIG. 27 is a flowchart illustrating a detailed flow of a first reference setting process in a variant of the present example embodiment. Note that in FIG. 27, steps in which the same processes as in FIG. 17 are performed will be assigned the same step numbers as in FIG. 17, and any detailed descriptions thereof will be omitted.

In the variant shown in FIG. 27, as in the above example embodiment, once the first reference setting process starts, the processes of steps S21 and S22 are initially performed. In the present variant, the process of step S27 is performed next. Then, when the determination result of step S27 is affirmative, the process of step S28 is performed, and the process of step S101 is performed after the process of step S28. On the other hand, when the determination result of step S27 is negative, the process of step S28 is skipped, and the process of step S101 is performed.

In step S101, the CPU 10 determines whether or not the specified position calculated in step S28 lies within a predetermined area on the screen of the display device. The predetermined area may be set arbitrarily so long as it is a prescribed area on the screen. Note that the predetermined area may include the center position of the screen, more concretely, it may be an area centering around the center position of the screen (e.g., a circular area as represented by the guidance image 83 in FIG. 12). Concretely, the CPU 10 reads the specified position data 104 from the main memory, and determines whether the specified position lies within the predetermined area or not.

When the determination result of step S101 is affirmative, the processes of steps S24 to S26 are performed. As a result, the current attitude of the controller 5 is set as a first reference attitude. After step S26, or when the determination result of step S101 is negative, the CPU 10 ends the first reference setting process.

In the variant shown in FIG. 27, the reference attitude is automatically set when the controller 5 is directed toward the display device for which the reference attitude is to be set, without the player performing the reference setting operation. Thus, the reference attitude can be set with a more simplified operation. Note that in another example embodiment, the attitude of the controller 5 may be set in the second reference setting process, as in the first reference setting process shown in FIG. 27, as the reference attitude for a display device when a position specified by the controller 5 lies within a predetermined area on the screen of the display device.

Furthermore, in another example embodiment, the reference attitude may be calculated based on data from the terminal device 7. Concretely, the player initially arranges the terminal device 7 approximately at the same position (initial position) as the television 2, and thereafter the player moves the terminal device 7 to an arbitrary position. At this time, the game apparatus 3 calculates a position after the movement from the initial position based on terminal operation data and/or data for images picked up by the camera 56. Specifically, based on acceleration data, angular rate data, and azimuthal direction data included in the terminal operation data and/or the data for the pickup images, the movement or the attitude of the terminal device 7 can be calculated (estimated), and therefore, based on such data as mentioned above, the game apparatus 3 can calculate the position and/or the attitude after the movement. Moreover, the game apparatus 3 can set the reference attitude based on the initial position as well as the position and/or the attitude after the movement.

Furthermore, in the above example embodiment, the reference setting processes are performed only before the start of the game, but in another example embodiment, the reference setting processes may be performed at arbitrary times. For example, the reference setting processes may be performed in response to the player's instructions or in response to predetermined conditions being met during the game. Alternatively, the game apparatus 3 may determine whether the terminal device 7 has moved or not based on the terminal operation data and/or data for images picked up by the camera 56, and may perform the reference setting processes (or at least the second reference setting process) if the terminal device 7 is determined to have moved.

(Variant Related to the Method for Calculating the Attitude of the Controller 5)

In the above example embodiment, the attitude of the controller 5 is calculated using detection results of inertial sensors (the acceleration sensor 63 and the gyroscope 64) included in the controller 5. Here, in another example embodiment, any method may be employed for calculating the attitude of the controller 5. For example, in another example embodiment, the attitude of the controller 5 may be calculated using a detection result of another sensor (the magnetic sensor 62) included in the controller 5. Alternatively, for example, when the game system 1 includes a camera for picking up an image of the controller 5, in addition to the camera provided with the controller 5, the game apparatus 3 may calculate the attitude of the controller 5 using an image of the controller 5 picked up by that camera.

(Variant Related to the Attitudes to be Used for Determining the Target Display Device)

In the above example embodiment, the process for determining which display device the controller 5 is directed toward is performed using attitudes in a three-dimensional space as the attitude of the controller 5 and the reference attitudes. Here, in another example embodiment, the determination process may be performed using attitudes in a two-dimensional plane as the attitude of the controller 5 and the reference attitudes. As a result, it is possible to simplify and speedup the determination process. Note that even when attitudes in a two-dimensional plane are used in the determination process, the CPU 10 still uses attitudes in a three-dimensional space to calculate a specified position in the process for calculating the specified position (the position calculation process of step S15).

Furthermore, in the case where attitudes in a two-dimensional plane are used, it is not possible to know the difference between two reference attitudes in a direction perpendicular to the plane, and in the position calculation process, a specified position is calculated considering the two reference attitudes to be the same attitude in the direction perpendicular to the plane. Accordingly, as for the direction perpendicular to the plane, there might be a deviation between a position actually specified by the controller 5 and a specified position calculated by the position calculation process. On the other hand, by using attitudes in a three-dimensional space as in the above example embodiment, the specified position can be calculated with higher precision, resulting in improved user-friendliness of the pointing operation.

(Variant Related to the Marker Units)

In the above example embodiment, the CPU 10 prevents erroneous detection of a marker unit by lighting up two marker units (the marker device 6 and the marker section 55) while appropriately switching between them. Specifically, the CPU 10 lights up only the marker unit (the marker device 6) corresponding to the television 2 to set the first reference attitude and only the marker unit (the marker section 55) corresponding to the terminal device 7 to set the second reference attitude. Here, in another example embodiment, the CPU 10 may light up both of the two marker units. For example, in the case where two display devices (marker units) are arranged far from each other, conceivably, there are low chances of the controller 5 picking up an image of a wrong marker unit or simultaneously picking up images of the two marker units, and therefore, the two marker units may be lit up at the same time.

Furthermore, in the position calculation process (step S15) of the above example embodiment, the marker device 6 is lit up but the marker section 55 is not lit up. Here, in the position calculation process of another example embodiment, only the marker section 55 may be lit up. Alternatively, the CPU 10 may light up the marker device 6 and the marker section 55 while switch between them depending on the situation. For example, the CPU 10 may light up the marker device 6 when the controller 5 is determined to be directed toward the television 2 (Yes in step S55), and light up the marker section 55 when the controller 5 is determined to be directed toward the terminal device 7 (No in step S55). Note that in the above example embodiment, when the marker section 55 is lit up in the position calculation process, the attitude of the controller 5 is calculated with respect to the marker section 55 in the attitude calculation process (step S36) based on marker coordinate points. Accordingly, in the correction process (step S37) based on marker coordinate points, the CPU 10 converts the attitude of the controller 5 with respect to the marker section 55 into an attitude with respect to the marker device 6, and performs a correction using the attitude obtained by the conversion. Thus, it is possible to light up the marker unit that corresponds to the display device toward which the controller 5 is directed, and therefore it is possible to increase the opportunity to perform a correction process based on markers, making it possible to calculate the attitude of the controller 5 with precision.

Here, if during the game, a certain period of time passes without the controller 5 picking up an image of a marker unit so that the correction process (step S37) based on marker coordinate points cannot be performed, the attitude of the controller 5 might not be calculated with precision due to accumulated errors by the gyroscope. Accordingly, the correction process based on marker coordinate points may be performed once per certain period of time. Therefore, in the position calculation process, the marker unit to be lit up or switching between marker units to be lit up may be determined considering, for example, the content of the game. For example, in the above example embodiment, the player conceivably directs the controller 5 toward the television 2 within a predetermined time period during the game, and therefore, the marker device 6 may be kept lit up. On the other hand, if the player can be assumed to manipulate the controller 5 for a long period of time while directing it toward the terminal device 7, the marker section 55 may be kept lit up. Moreover, if the player can be assumed to manipulate the controller 5 for a long period of time while directing it toward either or the other display device, switching may be performed so as to light up the marker unit that corresponds to the display device toward which the controller 5 is directed.

### Other Examples of Applying the Input System

The above example embodiment has been described taking the game system 1 as an example of the input system allowing pointing operations on two display devices. Here, in another example embodiment, the input system is not limited to use in games and may be applied to any arbitrary information processing system for performing pointing operations on display devices for displaying arbitrary images.

Furthermore, any game can be played with the game system 1 so long as pointing operations on two display devices are performed as game operations. For example, in another example embodiment, a driving game in which shooting operations are performed while driving a car can be realized by the game system 1. Concretely, display devices are arranged in front and on the side of the player, and the game apparatus 3 displays an image of a game space as viewed forward from the position of the car on the display device in front of the player and an image of the game space as viewed laterally from the position of the car on the display device on the side of the player. As a result, the player can perform unprecedented game operations such as driving the car by pointing at the display device in front while performing a shooting operation by pointing at the display device on the side.

Furthermore, in the game system 1, an item may be displayed on, for example, the terminal device 7 held in the player's hand. This makes it possible for the player to perform a game operation to use the item displayed on the terminal device 7 in a game space displayed on the television 2 by moving the item from the terminal device 7 to the television 2 with the same operation as the operation to move an object in the above example embodiment.

(Variant Related to the Arrangement of the Display Devices)

In the game system 1 of the above example embodiment, the terminal device 7 is transportable, so that the player can arrange the terminal device 7 at an arbitrary position. For example, the terminal device 7 can be arranged on the side of the player as in the driving game described above. Alternatively, the terminal device 7 can be arranged behind the player or can be arranged below (on the floor) or above (on the ceiling) the player. Thus, in the game system 1, various games can be played by placing the terminal device 7 in various positions.

(Variant in which the Difference Between the Reference Attitudes is Reflected in the Game Process)

In the above example embodiment, a case where the number of points to be scored changes in accordance with the difference between the reference attitudes has been described as an example of the game process being performed differently in accordance with the difference between the reference attitudes. Here, the game process may be performed differently in accordance with the difference between the reference attitudes. For example, in the above example embodiment, the game apparatus 3 may change the difficulty (concretely, the numbers, speed, etc., of player objects 85 and enemy objects 86) in accordance with the difference between the reference attitudes. Moreover, it is conceivable that, for example, in another example embodiment, the positional relationship between virtual cameras changes in accordance with the difference between the reference attitudes. Specifically, the game apparatus 3 sets a first virtual camera for generating a television game image in a direction corresponding to the direction from the controller 5 toward the television 2 (the first reference attitude), and a second virtual camera for generating a terminal game image in a direction corresponding to the direction from the controller 5 toward the terminal device 7 (the second reference attitude). For example, in the case where the television 2 is arranged in front of the player (the controller 5), and the terminal device 7 is arranged behind the player, the first virtual camera is set in a direction forward from the position of a player character in a virtual game space, and the second virtual camera is set in a direction backward from the player character. In this manner, by setting the virtual cameras in directions corresponding to the reference attitudes, and causing the game spaces displayed on the display devices to change in accordance with the reference attitudes, it becomes possible to render the game more realistic.

(Variant Related to the Configuration of the Input System)

The above example embodiment has been described taking as an example the game system 1 including the two display devices, the game apparatus 3, and the controller 5. Here, the number of display devices included in the game system may be three or more. In such a case, the reference attitude is set for each display device. Note that when the number of display devices is three or more, the CPU 10 may perform the first reference setting process (step S12) of the above example embodiment to set the reference attitude for the first display device. In addition, to set the reference attitudes for the second and third display devices, the CPU 10 may perform the second reference setting process (step S14) of the above example embodiment for each of the display devices. Moreover, the reference attitude may be predetermined for any display device whose position is predetermined. In this case, for any other display device, the reference attitude may be set by the second reference setting process.

Furthermore, in the above example embodiment, the game system 1 is configured to include the terminal device 7, which is a transportable display device, and the television 2, which is a stationary display device, but display devices to be included in an input system may be both transportable or stationary. For example, the input system may be configured to use two televisions or terminal devices as display devices.

Furthermore, in another example embodiment, a plurality of controllers may be included. In this case, the reference attitudes for the display devices may be set for each controller. Specifically, when a plurality of controllers 5 are included, the CPU 10 performs the reference setting processes (steps S12 and S14) for each controller, thereby setting a pair of reference attitudes for each controller. Note that, for example, when the controllers can be assumed to be approximately at the same position, the same reference attitude may be set for each controller.

Furthermore, in another example embodiment, a plurality of game apparatuses may be included. In this case, a series of game processes to be performed in the game system 1 may be performed by one specific game apparatus or may be shared between the game apparatuses. In addition, display devices and controllers may communicate with the same one specific game apparatus or their respective different game apparatuses.

(Variant Related to the Information Processing Apparatus for Performing the Game Process)

In the above example embodiment, a series of game processes to be performed in the game system 1 are performed by the game apparatus 3, but the series of game processes may be performed in part by another apparatus. For example, in another example embodiment, a part (e.g., the terminal game image generation process) of the series of game processes may be performed by the terminal device 7. Moreover, in another example embodiment, a series of game processes in a game system including a plurality of information processing apparatus capable of communicating with each other may be shared between the information processing apparatuses.

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-designed ASICs (application specific integrated circuits) and/or logic circuitry. In the case of a distributed processor architecture or arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

As described above, the present example embodiment can be applied to, for example, a game system or apparatus for the purpose of, for example, allowing an operating device for specifying a position on the screen of a display device to be used and oriented in a wider range of directions.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An input system for calculating a specified position on a screen of a display device, the position being specified by an operating device, the system comprising:
an attitude calculation section for calculating an attitude of the operating device;
an identification section for identifying one of a plurality of display devices toward which the operating device is directed, based on the attitude of the operating device; and
a first specified position calculation section for calculating a specified position in accordance with the attitude of the operating device as a position on a screen of the display device identified by the identification section.

2. The input system according to claim 1, wherein,
the operating device includes an inertial sensor, and
the attitude calculation section calculates the attitude of the operating device based on an output from the inertial sensor.

3. The input system according to claim 1, further comprising a reference attitude storage section for storing a reference attitude for each display device, the reference attitude representing an attitude of the operating device being directed toward the display device, wherein,
the identification section identifies the display device toward which the operating device is directed, based on the attitude calculated by the attitude calculation section and the reference attitudes.

4. The input system according to claim 3, further comprising a reference setting section for, when the operating device is in a predetermined state, setting the attitude of the operating device in the reference attitude storage section as the reference attitude.

5. The input system according to claim 4, wherein,
the operating device includes an image pickup section,
the input system further comprises marker sections each being provided for a corresponding one of the display devices, and
when the image pickup section has picked up an image of one of the marker sections, the reference setting section sets the attitude of the operating device as a reference attitude for the display device corresponding to that marker section.

6. The input system according to claim 5, further comprising:
a second specified position calculation section for calculating the specified position based on a position of the marker section in the image picked up by the image pickup section; and
a predetermined image display control section for displaying a predetermined image at the specified position calculated by the second specified position calculation section, wherein,
the reference setting section sets as the reference attitude the attitude of the operating device calculated by the attitude calculation section when the predetermined image is displayed.

7. The input system according to claim 4, wherein,
the operating device includes an operating section operable by a user, and
the reference setting section sets as the reference attitude the attitude of the operating device when a predetermined operation is performed on the operating section.

8. The input system according to claim 6, wherein, when the specified position calculated by the second specified position calculation section lies within a predetermined area on the screen of the display device, the reference setting section sets the attitude of the operating device as the reference attitude for the display device.

9. The input system according to claim 5, wherein,
the marker sections include light-emitting members, and
the input system further comprises a lighting control section for only lighting up the marker section corresponding to a first one of the display devices when the reference setting section sets the reference attitude for the first display device, or only lighting up the marker section corresponding to a second one of the display devices when the reference setting section sets the reference attitude for the second display device.

10. The input system according to claim 5, wherein the attitude calculation section calculates the attitude of the operating device based on the position of the marker section in the image picked up by the image pickup section.

11. The input system according to claim 5, further comprising:
an information processing apparatus;
one of the display devices that is transportable; and
one of the marker sections that is capable of emitting infrared light and corresponds to the other predetermined display device provided independently of the transportable display device, wherein,
the information processing apparatus includes:
a first image generation section for sequentially generating first images based on a predetermined information process;
a second image generation section for sequentially generating second images based on a predetermined information process;
an image compression section for generating compressed image data by sequentially compressing the second images;
a data transmission section for sequentially transmitting the compressed image data to the transportable display device in a wireless manner; and
an image output section for sequentially outputting the first images to the predetermined display device, and
the transportable display device includes:
an infrared emission section capable of emitting infrared light and functioning as the marker section for the transportable display device;
an image reception section for sequentially receiving the compressed image data from the information processing apparatus;
an image decompression section for sequentially decompressing the compressed image data to obtain the second images; and
a display section for sequentially displaying the second images obtained by decompression.

12. The input system according to claim 3, wherein the first specified position calculation section calculates the specified position in accordance with an amount and a direction of change in a current attitude with respect to the reference attitude for the display device toward which the operating device is directed.

13. The input system according to claim 1, further comprising a direction image display control section for displaying a direction image at least on the display device unidentified by the identification section, wherein the direction image represents a direction in which the operating device is oriented.

14. A game system comprising:
an input system of claim 1; and
a game process section for performing a game process using a specified position calculated by the first specified position calculation section as an input.

15. The game system according to claim 14, further comprising:
a reference attitude storage section for storing a reference attitude for each display device, the reference attitude representing an attitude of the operating device being directed toward the display device; and
a reference setting section for, when the operating device is in a predetermined state, setting the attitude of the operating device in the reference attitude storage section as the reference attitude, wherein,
the identification section identifies the display device toward which the operating device is directed, based on the attitude calculated by the attitude calculation section and the reference attitudes, and
the game process section performs the game process differently in accordance with a difference between the reference attitudes.

16. The game system according to claim 14, wherein the game process section includes:
a first game image display control section for causing a predetermined one of the display devices to display an image of a game space;
a selection section for, upon a user's predetermined instruction, selecting a game object displayed at the specified position calculated by the first specified position calculation section;
an object movement section for moving the selected game object simultaneously with movement of the specified position; and
a second game image display control section for, when the identification section identifies another display device with the game object being kept selected, displaying the game object at a specified position on a screen of that display device.

17. A specified position calculation method to be performed by at least one information processing apparatus included in an input system for calculating a specified position on a screen of a display device, the position being specified by an operating device, the method comprising:
an attitude calculation step for calculating an attitude of the operating device;
an identification step for identifying one of a plurality of display devices toward which the operating device is directed, based on the attitude of the operating device; and
a first specified position calculation step for calculating a specified position in accordance with the attitude of the operating device as a position on a screen of the display device identified in the identification step.

18. The specified position calculation method according to claim 17, wherein,
the operating device includes an inertial sensor, and
in the attitude calculation step, the attitude of the operating device is calculated based on an output from the inertial sensor.

19. The specified position calculation method according to claim 17, wherein,
storage means accessible by the at least one information processing apparatus has a reference attitude stored therein for each display device, the reference attitude representing an attitude of the operating device being directed toward the display device, and
in the identification step, the at least one information processing apparatus identifies the display device toward which the operating device is directed, based on the attitude calculated in the attitude calculation step and the reference attitudes.

20. The specified position calculation method according to claim 19, further comprising a reference setting step for, when the operating device is in a predetermined state, setting the attitude of the operating device in the storage means as the reference attitude.

21. The specified position calculation method according to claim 20, wherein,
the operating device includes an image pickup section,
the input system further includes marker sections each being provided for a corresponding one of the display devices, and
when the image pickup section has picked up an image of one of the marker sections, the at least one information processing apparatus sets the attitude of the operating device as a reference attitude for the display device corresponding to the marker section in the reference setting step.

22. The specified position calculation method according to claim 21, further comprising:
a second specified position calculation step for calculating the specified position based on a position of the marker section in the image picked up by the image pickup section; and
a predetermined image display control step for displaying a predetermined image at the specified position calculated in the second specified position calculation step, wherein,
in the reference setting step, the at least one information processing apparatus sets as the reference attitude the attitude of the operating device calculated in the attitude calculation step when the predetermined image is displayed.

23. The specified position calculation method according to claim 20, wherein,
the operating device includes an operating section operable by a user, and
in the reference setting step, the at least one information processing apparatus sets as the reference attitude the attitude of the operating device when a predetermined operation is performed on the operating section.

24. The specified position calculation method according to claim 22, wherein, when the specified position calculated in the second specified position calculation step lies within a predetermined area on the screen of the display device, the at least one information processing apparatus sets the attitude of the operating device as the reference attitude for the display device in the reference setting step.

25. The specified position calculation method according to claim 21, wherein,
the marker sections include light-emitting members, and
the method further comprises a lighting control step for only lighting up the marker section corresponding to a first one of the display devices when the reference attitude for the first display device is set in the reference setting step, or only lighting up the marker section corresponding to a second one of the display devices when the reference attitude for the second display device is set in the reference setting step.

26. The specified position calculation method according to claim 21, wherein in the attitude calculation step, the at least one information processing apparatus calculates the attitude of the operating device to be set as the reference attitude, based on an output from the inertial sensor included in the operating device, and in the first specified position calculation step, the at least one information processing apparatus calculates the attitude of the operating device to be used for calculating the specified position, based on an output from the inertial sensor and a position of the marker section in the image picked up by the image pickup section.

27. The specified position calculation method according to claim 17, wherein in the first specified position calculation step, the at least one information processing apparatus calculates the specified position in accordance with an amount and a direction of change in a current attitude with respect to the reference attitude for the display device toward which the operating device is directed.

28. The specified position calculation method according to claim 17, further comprising a direction image display control step for displaying a direction image on any display device other than the display device identified in the identification step, wherein the direction image represents a direction in which the operating device is oriented.

29. A game process method to be performed by at least one game apparatus, comprising:
a step for calculating a specified position by a specified position calculation method of claim 17, and
a game process step for performing a game process using the calculated specified position as an input.

30. The game process method according to claim 29, further comprising a reference setting step for, when the operating device is in a predetermined state, setting the attitude of the operating device as a reference attitude representing an attitude of the operating device being directed toward the display device, wherein,
in the identification step, the at least one information processing apparatus compares the attitude calculated in the attitude calculation step with the reference attitudes, thereby identifying the display device being directed toward the operating device, and
in the game process step, the at least one information processing apparatus performs the game process differently in accordance with a difference between the reference attitudes.

31. The game process method according to claim 29, wherein the game process step includes:
a first display control step for causing a predetermined one of the display devices to display an image of a game space;
a selection step for, upon a user's predetermined instruction, selecting a game object displayed at the specified position calculated in the first specified position calculation step;
an object movement step for moving the selected game object simultaneously with movement of the specified position; and
a second game image display control step for, when another display device is identified in the identification step with the game object being kept selected, displaying the game object at a specified position on a screen of that display device.

32. An information processing apparatus for calculating a specified position on a screen of a display device, the position being specified by an operating device, the apparatus comprising:
an attitude calculation section for calculating an attitude of the operating device;
an identification section for identifying one of a plurality of display devices toward which the operating device is directed, based on the attitude of the operating device; and
a first specified position calculation section for calculating a specified position in accordance with the attitude of the operating device as a position on a screen of the display device identified by the identification section.

33. The information processing apparatus according to claim 32, wherein,
the operating device includes an inertial sensor, and
the attitude calculation section calculates the attitude of the operating device based on an output from the inertial sensor.

34. The information processing apparatus according to claim 32, further comprising:
a reference attitude storage section for storing a reference attitude for each display device, the reference attitude representing an attitude of the operating device being directed toward the display device; and
a reference setting section for, when the operating device is in a predetermined state, setting the attitude of the operating device in the reference attitude storage section as the reference attitude, wherein, the identification section identifies the display device toward which the operating device is directed, based on the attitude calculated by the attitude calculation section and the reference attitudes.

35. The information processing apparatus according to claim 34, wherein,
the operating device includes an image pickup section, and
when the image pickup section has picked up an image of one of a plurality of marker sections each being provided for a corresponding one of the display devices, the reference setting section sets the attitude of the operating device as a reference attitude for the display device corresponding to the marker section.

36. The information processing apparatus according to claim 35, further comprising:
a second specified position calculation section for calculating the specified position based on a position of the marker section in the image picked up by the image pickup section; and
a predetermined image display control section for displaying a predetermined image at the specified position calculated by the second specified position calculation section, wherein,
the reference setting section sets as the reference attitude the attitude of the operating device calculated by the attitude calculation section when the predetermined image is displayed.

37. A computer-readable storage medium having stored therein a information processing program to be performed by a computer of an information processing apparatus for calculating a specified position on a screen of a display device, the position being specified by an operating device, the medium causing the computer to function as:
attitude calculation means for calculating an attitude of the operating device;
identification means for identifying one of a plurality of display devices toward which the operating device is directed, based on the attitude of the operating device; and
first specified position calculation means for calculating a specified position in accordance with the attitude of the operating device as a position on a screen of the display device identified by the identification means.

38. The storage medium according to claim 37, wherein,
the operating device includes an inertial sensor, and
the attitude calculation means calculates the attitude of the operating device based on an output from the inertial sensor.

39. The storage medium according to claim 37, wherein,
the information processing program further causes the computer to function as reference setting means for causing storage means accessible by the information processing apparatus to store an attitude of the operating device in a predetermined state as a reference attitude representing an attitude of the operating device being directed toward the display device, and
the identification means identifies the display device toward which the operating device is directed, based on the attitude calculated by the attitude calculation means and the reference attitudes.

40. The storage medium according to claim 39, wherein,
the operating device includes an image pickup section, and
when the image pickup section has picked up an image of one of a plurality of marker sections each being provided for a corresponding one of the display devices, the reference setting means sets the attitude of the operating device as a reference attitude for the display device corresponding to the marker section.

41. The storage medium according to claim 40, wherein,
the information processing program further causes the computer to function as:
second specified position calculation means for calculating the specified position based on a position of the marker section in the image picked up by the image pickup means; and
predetermined image display control means for displaying a predetermined image at the specified position calculated by the second specified position calculation means, wherein,
the reference setting means sets as the reference attitude the attitude of the operating device calculated by the attitude calculation means when the predetermined image is displayed.
